(19) United States
(12) Patent Application Publication
(10) Pub. No.: US 2022/0366459 A1
(43) Pub. Date: Nov. 17, 2022

(54) SYSTEM AND METHOD FOR A PROFESSIONAL SERVICES MARKETPLACE

(71) Applicant: Fortune Vieyra, Houston, TX (US)

(72) Inventor: Fortune Vieyra, Houston, TX (US)

(21) Appl. No.: 17/549,598

(22) Filed: Dec. 13, 2021

Related U.S. Application Data
(60) Provisional application No. 63/187,517, filed on May 12, 2021.

(51) Int. Cl. G06Q 30/02; H04L 65/4038; H04L 65/403; H04L 65/1066

(52) U.S. Cl. CPC G06Q 30/0281; H04L 65/4038; H04L 65/4046; H04L 65/1066

(57) ABSTRACT

A system and method for a marketplace is provided wherein one or more requestors and providers engage in pre-paid, scheduled meetings on a computing device. The system and method may comprise presenting via the display of a computing device a marketplace that facilitates providing professional services between providers and requestors. The marketplace enables providers to provide professional services by listing services, marketing services and engaging in meetings. In addition, the marketplace of the system and method enables requestors to request professional services by searching for services, procuring services and engaging in meetings.

### FIELD OF INVENTION

Examples described herein pertain generally to the fields of online marketplaces, professional services and meetings and more particularly, by way of non-limiting example only, marketplaces where services are provided through pre-paid, scheduled meetings.

### BACKGROUND

In the era of technology and information, consumers and businesses use online services to exchange information, goods and services at a rapid pace. For businesses, the traditional methods for attracting customers have taken a shift as more people are relying on marketplaces to exchange goods and services. The value of a marketplace is that it brings people together for commerce, knowledge, and resource exchange. Many businesses are still relying on traditional methods of retaining customers within a technology driven economy and this leads to costly, time consuming practices. Businesses that rely on advertising as a means of attracting an audience by way of appearing on top of a search result page completely miss the opportunity of direct communication with prospective customers. The path to acquiring a customer within an advertising model is long and expensive (for example, a prospect must click on an ad, visit a website, complete a lead form and wait for a sales representative to call).

Marketplaces reduce the cost, resources and time required to acquire customers, by at least an order of magnitude if not more. Marketplaces provide a means for direct person-to-person interaction by removing additional steps that are required in traditional online advertising (for example, a person can simply initiate a conversation with a prospect in two steps, search and send a message). Marketplaces can be useful micro economies that support the need of a few hundred people or large powerful economies where millions of people exchange goods and services (for example, Amazon® or Fiverr®) daily. Wherever there is a common need among people (for example, eating with DoorDash® or driving with Uber®) a marketplace may provide the structure and environment for people to exchange.

Over the past decades, online marketplaces have focused on freelance service providers engaging in the production of digital goods (for example graphic design, website design) for requestors such as Fiverr® or UpWork®, on event providers engage in facilitating and managing events (for example concerts, meetups, classes) for participants such as Eventbrite® @YelloSchedule, and Calendly®, or on virtual meeting providers who facilitate and manage virtual meetings (for example webinars, video conference) for participants such as Zoom® or Cisco® Webex Meetings.

### SUMMARY

A system and method for a professional services marketplace is provided. One or more requestors and providers may engage in meetings on a computing device. Presenting, on the display of the computing device, a marketplace that facilitate providing professional services between providers and requestors. The marketplace includes, requestors to request professional services from providers, a marketplace where services are provided through meetings to enable providers to provide professional services, and a meeting service to facilitate meetings. Providers are enabled to provide professional services by listing services, marketing services and engaging in meetings. Requestors are enabled to request professional services by searching for services, completing service requests and engaging in meetings. The service requests include request details (for example request type, meeting date, meeting timeframe, service price, terms of service, etc.) that are completed by a requestor to allow a meeting between providers and requestors, and a payment processing service to facilitate payment processing. The marketplace includes meeting software to enable meetings allowing providers to provide professional services and requestors to request professional services in the marketplace. The marketplace includes a meeting software to facilitate meetings. The marketplace includes a communication-oriented services that enable placing information shared by a producer, in real-time, as the measure of value within the marketplace (for example, virtual consultations, advisory services, professional training, lectures, seminars, etc.) without the need to place electronic output in the form of goods as measure of value by producers of the marketplace.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is a block diagram illustrating a simple device flow;

FIG. 2 is a block diagram illustrating an example of a simple requestor flow;

FIG. 3 is a flow diagram illustrating an example method for an email flow on a computing device;

FIG. 4 is a schematic representation of a simple user flow;

FIG. 5 is a flow diagram illustrating an example method for multi-device application flow for devices and applications;

FIG. 6 is an example system and process flow illustrating a multi-network flow;

FIG. 7 is a block diagram that represent a set of common modules to enable the requestor to complete a service lifecycle;

FIG. 8 a block diagram that demonstrations a service provider's service setup flow;

FIG. 9 is a block diagram that illustrates multi-entity virtual meetings upon which examples described herein may be implemented;

FIG. 10 is a block diagram that illustrates a service requestor procurement flow;

FIG. 11 is a block diagram that illustrates a general service requestor onboard process upon which examples described herein may be implemented;

FIG. 12 is a block diagram that illustrates a potential service requestor flow upon which examples described herein may be implemented;

FIG. 13 is a block diagram that illustrates navigation and data flow for web and mobile apps;

FIG. 14 is a block diagram that illustrates a general service provider onboard flow upon which examples described herein may be implemented;

FIG. 15 is a block diagram that illustrates a web conference process;

FIG. 16 is a block diagram that illustrates a service provider dashboard upon which examples described herein may be implemented;

FIG. 17 is a block diagram that illustrates a cloud and peer-to-peer network flow;

FIG. 18 is a block diagram that illustrates a service flow from search to procurement of services upon which examples described herein may be implemented;

FIG. 19 is a block diagram that illustrates the actions and components of a services flow with documents upon which examples described herein may be implemented;

FIG. 20 is a block diagram that illustrates the actions and components of a quick checkout of services upon which examples described herein may be implemented;

FIG. 21 is a block diagram that illustrates service requestor action steps;

FIG. 22 is a block diagram that illustrates service requestor procurement upon which examples described herein may be implemented;

FIG. 23 is a block diagram that illustrates a service provider procurement dynamic;

FIG. 24 is a block diagram that illustrates a cloud and distributed network upon which examples described herein may be implemented;

FIG. 25 is a block diagram that illustrates an auto-reply message service for requestors and providers upon which examples described herein may be implemented;

FIG. 26 is a block diagram that illustrates a service paradigm upon which examples described herein may be implemented;

FIG. 27 is a block diagram that illustrates a multi-device platform flow upon which examples described herein may be implemented;

FIG. 28 is a block diagram that illustrates a multi-node network process upon which examples described herein may be implemented;

FIG. 29 is a block diagram that illustrates a multi-module user flow upon which examples described herein may be implemented;

FIG. 30 is a block diagram that illustrates an extended user flow upon which examples described herein may be implemented;

FIG. 31 is a block diagram that illustrates a member classification upon which examples described herein may be implemented;

FIG. 32 is a block diagram that illustrates a video conference flow upon which examples described herein may be implemented;

FIG. 33 is a block diagram that illustrates a multi-tenant conference flow upon which examples described herein may be implemented;

FIG. 34 is a block diagram that illustrates a requestor search flow upon which examples described herein may be implemented;

FIG. 35 is a block diagram that illustrates a requestor pages network data flow upon which examples described herein may be implemented;

FIG. 36 is a block diagram that illustrates a device and network data low upon which examples described herein may be implemented;

FIG. 37 is a block diagram that illustrates a pre-conference requestor flow upon which examples described herein may be implemented;

FIG. 38 is a block diagram that illustrates a requestor user interface flow upon which examples described herein may be implemented;

FIG. 39 is a block diagram that illustrates an extended service flow upon which examples described herein may be implemented;

FIG. 40 is a block diagram that illustrates a virtual conference view upon which examples described herein may be implemented; and

FIG. 41 is a block diagram that illustrates a virtual conference view extendable module upon which examples described herein may be implemented;

### DETAILED DESCRIPTION

A marketplace for professional services between providers and requestors that focus on communication-oriented services (for example consultations, training, tutoring) provided in the form of virtual meetings without the production of virtual goods (for example creating digital art, completing a virtual task, producing video content, and others) is missing.

A system and method for a professional services marketplace is provided. One or more requestors and providers may engage in meetings on a computing device. Presenting, on the display of the computing device, a marketplace that facilitate providing professional services between providers and requestors. The marketplace includes, requestors to request professional services from providers, a marketplace where services are provided through meetings to enable providers to provide professional services, and a meeting service to facilitate meetings. Providers are enabled to provide professional services by listing services, marketing services and engaging in meetings. Requestors are enabled to request professional services by searching for services, completing service requests and engaging in meetings. The service requests include request details (for example request type, meeting date, meeting timeframe, service price, terms of service, etc.) that are completed by a requestor to allow a meeting between providers and requestors, and a payment processing service to facilitate payment processing. The marketplace includes meeting software to enable meetings allowing providers to provide professional services and requestors to request professional services in the marketplace. The marketplace includes a meeting software to facilitate meetings. The marketplace includes a communication-oriented services that enable placing information shared by a producer, in real-time, as the measure of value within the marketplace (for example, virtual consultations, advisory services, professional training, lectures, seminars, etc.) without the need to place electronic output in the form of goods as measure of value by producers of the marketplace.

One or more illustrative examples incorporating the invention disclosed herein are presented below. Applicant has created a revolutionary and novel system and method for a professional services marketplace where providers receive payment for services rendered, requestors request for and procure services, and both providers and requestors engage in real-time virtual meetings.

The description that follows includes systems, methods, techniques, instruction sequences, and software products that embody illustrative examples of the disclosure. In the following description, for the purposes of explanation, numerous specific details are set forth in order to provide an understanding of the various examples of the inventive subject matter. It will be evident, however, to those skilled in the art, that examples of the inventive subject matter may be practiced without these specific details. In general, well-known instruction instances, protocols, structures, and techniques are not necessarily shown in detail.

In some examples, a non-transitory processor-readable storage medium includes code to cause a processor of a host device to receive a communication associated with a transaction from at least one electronic device included in a set of electronic devices. The host device includes at least the non-transitory processor-readable storage medium, the processor, and a database. The communication being received at the initial time from a communication mode associated with a transaction may vary in time, size, length, or other measurable descriptors. The code that enable the processor to send a response to the communication from an electronic device. The code to cause the processor to receive one or more communications associated with the transaction from the at least one electronic device. The communication displayable in a persistent record of the transaction regardless of the set of electronic devices transmission, processing, storage and encoding of the communication.

In the following description, certain details are set forth such as specific quantities, sizes, etc. so as to provide a thorough understanding of the present examples disclosed herein. However, it will be evident to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

Referring to the drawings in general, it will be understood that the illustrations are for the purpose of describing particular examples of the disclosure and are not intended to be limiting thereto. Drawings are not necessarily to scale and arrangements of specific units in the drawings can vary.

Several examples of systems and methods for a professional services marketplace are described below. In these descriptions, numerous specific details, such as components and system configurations, may be set forth in order to provide a more thorough understanding of the present invention. It will be appreciated, however, by one skilled in the art, that the invention may be practiced without such specific details. Additionally, some well-known techniques, specific concepts, practices, and the like have not been shown in detail, to avoid unnecessarily obscuring the present invention.

In the following description, references to “one example,” “an example,” “example,” “various examples,” etc., indicate that the example(s) of the invention so described may include particular features, structures, or characteristics, but more than one example may, and not every example necessarily does, include the particular features, structures, or characteristics. Further, some examples may have some, all, or none of the features described for other examples.

As used in the specification and claims, unless otherwise specified, the use of the ordinal adjectives “first,” “second,” “third,” “fourth,” etc. to describe an element merely indicates that a particular instance of an element or different instances of like elements are being referred to, and is not intended to imply that the elements so described must be in a particular sequence, either temporally, spatially, in ranking, or in any other manner.

As used in the specification and claims, unless otherwise specified, the use of the term “page,” “application,” “component,” “module,” “service,”, “item,” etc. to describe an element merely indicates that a particular type of element or different types of like elements are being referred to, and is not intended to imply that the elements so described must be limited to particular type, either temporally, spatially, functionally, categorically, in utility, or in any other manner.

For convenience and clarity, various components may be described using particular names (for example, SOFTWARE, APPLICATION, DEVICE, PROGRAM, SYSTEM, SERVICE), however, examples of the invention are not limited to those particular components as defined or used in any particular architecture.

Other components and component names (for example, website, software, application, program, system, server, database, service, module, widget) may be used within various examples of the present invention.

Certain terms are used in the following description and claims to refer to particular system components. As one skilled in the art will appreciate, different persons may refer to a component by different names. This document does not intend to distinguish between components that differ in name but not function. The drawing figures are not necessarily to scale. Certain features of the invention may be shown exaggerated in scale or in somewhat schematic form, and some details of conventional elements may not be shown, all in the interest of clarity and conciseness.

Although several examples of the present invention will be described in detail herein, the invention is not limited hereto. It will be appreciated by those having ordinary skill in the art that various modifications can be made without materially departing from the novel and advantageous teachings of the invention. Accordingly, the examples disclosed herein are by way of example and it is to be understood that the scope of the invention is not to be limited by way of example.

Examples in accordance with the present invention are disclosed in the accompanying claims, particularly directed to methods, systems, storage media, computer program products, communication devices and any feature mentioned in a claim category, e.g., method, Other claim categories, such as systems, may also be claimed. Dependencies or references in the appended claims are merely selected for formal reasons. However, any subject matter obtained by deliberate reference to any preceding claim (especially in a multiple dependent form) may be claimed, and thus, regardless of the dependency selected in the appended claims, any combination of the claims and their features may be disclosed and claimed. The claimed subject matter includes not only the combination of features recited in the appended claims, but also any other combination of features in the claims, each feature recited in the claims being It may be combined with any other feature or combination of any other features in the claims. Moreover, any examples and features described or illustrated herein are in the separate claims and/or any combination with any examples or features described or illustrated herein, or It may be claimed in any combination with any feature of the appended claims.

A website, application, program, system, virtual server or database (“SOFTWARE”) typically contains memory (“MEMORY”), a client (for example, web browser, operating system, mobile application, brain machine interface), a computing device (for example, a physical server, desktop computer, mobile device, smart phone, wearable device, Internet of Things device, network enabled device) also called (“HARDWARE”) and connectivity between devices (for example, Wifi, Local Area Network, Wide Area Network, Satellite Area Network, GPS, Bluetooth) also called a (“NETWORK”). The marketplace uses a plurality of memory, software, hardware and network resources in varying combinations, environments, configurations and settings. In some examples, the marketplace can be descriptive of a website while in other examples the marketplace can describe an application (for example, a mobile application) or program (for example, a desktop program) that runs on an operating system, in a virtual environment, and other digitally enabled environments.

In the conceptual form, the marketplace represents a place for buyers and sellers of services to exchange. In the physical form, the marketplace represents the combination of memory, software, hardware and networking resources that enable users to exchange information. Examples extend both conceptual and physical representation of a marketplace for professional services with illustrations and descriptors. The systems and methods for a marketplace include but are not limited to concepts of commerce, communication, exchange, networking, and connecting over one or more network, hardware, software and memory components, devices, applications and softwares.

Examples described herein provide examples of a marketplace for enabling providers (for example, business consultants, licensed professionals, advisors or educators) to provide professional services using a computing device. In particular, some examples herein enable a computing devices (for example, a laptop, mobile device, desktop computer, a network enabled portable device) to be used in connection with an internet enabled application (for example, web browser, mobile application, brain computing interface), using a simplified user interface representation. Functionality (for example, software packages, web components, modules, processors, data, digital media) and other information, can be organized and provided to the user in an efficient and user-friendly manner.

In one example, a computing device can operate an application where requestors and providers engage in virtual meetings. The application can provide user interface features that give requestors of the application relevant information that enable requestors to request professional services from providers. For example, the professional services marketplace can provide a mechanism for searching for services, procuring service items, scheduling meetings and engaging in virtual meetings, as well as listing services, marketing services and selling services. In another example, a computing device can operate an application where users (for example, requestors, providers, guests, agents, bots) of the professional services marketplace can perform a plurality of actions (for example, creating, updating, deleting, searching, filtering, sorting, browsing, procuring, scheduling, messaging, configuring, attending, referring, recommending, reviewing, rating and tipping) on a plurality of interests (for example, a user, service, account, setting, component, module, page).

According to some examples, the communication-oriented services made available to the requestors by the providers can be optimized by one or more actions. For example, communication oriented services (for example consultations, training, tutoring) through virtual meetings can be provided to requestors based on a duration (for example, date and time), a classification (for example, tag, category, industry, segment), a filter (for example, type, location, locale) or an event (for example, click, toggle, slide, drag, drop, tilt, lift, rotate). Thus, the communication oriented services made available to the requestors, as well as the providers can be optimized by one or more actions (for example, filter, search or select) in the professional services marketplace.

In some examples, different user interface features can be provided, at least in part by an application or program that is stored and operated on a user's computing device. The application can be configured to communicate with a computing device that connects to a network (for example, Local Area Network or “LAN”, Wide Area Network, Metropolitan Area Network). For example, a service requestor can request professional services, and the professional services marketplace can determine the service request. Wherein the service request is presented on a user interface (for example, a website or mobile application) that contain service request features (for example request type, meeting date, meeting timeframe, service price, terms of service, and others) that are displayed on the graphical user interface or “GUI” of a computing device to the requestor. The graphical user interface that is displaying the service request is a component of a hardware (for example, a phone) and software that may be dependent on one or more other software, application (for example, a mobile application), firmware, operating system, component, module or hardware of the computing device. The computing device that connects to a network may access other computing devices (for example, servers, computers, smart phones, and others) through telemetry (for example, over Wifi, satellite, Bluetooth, and others), through a hard line (for example, a Local Area Network), or any combination of wired and wireless connectivity.

A computing device is also descriptive of hardware and software that do not contain a GUI (for example, a home assistant device) and may instead be enabled through a microphone and speaker configuration where a person can speak a command and receive an auditory response. A computing device is also descriptive of hardware and software that may be stationary (for example, a desktop, server, IoT appliance, and others) or mobile (for example, laptop, tablet, smart phone, headset, virtual reality wear, smart watch, smart vehicle, air craft, drone and others). A computing device is also descriptive of a wearable (for example, a brain computing interface, smart watch, nano-device, smart wearable, and others) and non-wearable (for example, a industrial IoT appliance, robot, and others) digitally enabled device, system or appliance.

A computing device is also descriptive of hardware and software that are network enabled (for example, a device that has access to the internet or a private network), bio-digital enabled (for example, a device that uses bio-digital networking capabilities such as a brain machine interface or “BMI”), AI enabled (for example, a device that uses or contain artificial intelligence) and alternatively powered (for example, solar power enabled, hybrid power enabled, and others). A computing device is also descriptive of hardware and software that make use of certain internet network arrangements (for example, client server, peer-to-peer, decentralized, federated, consensus based networks) and storage arrangements (for example, centralized cloud storage, decentralized storage, offline storage, bio-digital storage, database, device cache, application cache, memory cache, and other storage systems).

According to an example, the payment processing can be determined so that user interface features for a virtual meeting between providers and requestors can be presented, on the display of the computing device, based on request details (for example request type, meeting date, meeting timeframe, service price, terms of service, etc.) that are completed by a requestor.

As described herein, a “requestor” “buyer” “buyer agent” “client” “consumer” or“customer” refer to individuals or entities that request professional services. As an example, requestors can request professional services (for example, business consultations, advisory, coaching, training, etc) by searching, browsing or being directed to a service item (for example, a page that contain details about a service that is offered by a service provider), procuring the service item, scheduling a date and time and attending a virtual conference. A buyer is a type of requestor who purchases a service item from a seller (for example, a service provider) by completing the procurement process of a service item (for example, entering billing details and clicking through to purchase a service item). A client or customer is a type of requestor who may repeat procurement of a service item. The names describing a requestor may be used interchangeably and are relevant for the purposes of distinguishing a member of the professional services marketplace who have an intent to purchase, be sold, be advertised, be solicited, be retained, or one who is a consumer of digital information. A consumer is one who may purchase or become the purchaser or beneficiary of services offered in the professional services marketplace.

As described herein, a “provider” “seller” “host” “producer” or a “service agent” refer to individuals or entities (for example, business consultants, licensed professionals, advisors or educators) that provide professional services. As an example, providers can provide professional services (for example, virtual consultations, advisory services, professional training, lectures, seminars, etc.) using the virtual meeting software for facilitating communication oriented services (for example, live webinar, video consultations, live streaming, etc.). A provider can offer the sell of a service and can additionally employ a service agent (for example, another user who has access to the provider's account) to perform specific services on the behalf of the provider. Both the service agent and provider are users or members of the professional services marketplace that provide professional services. A host is another type of provider who offers professional services that may be event oriented (for example, hosting a webinar, virtual conference, etc). The names describing a provider may be used interchangeably and are relevant for the purposes of distinguishing a member of the professional services marketplace who have an intent to sell, offer, advertise, solicit, retain, or one who is a producer of digital information. A producer is one who may retain funds or become the receiver or beneficiary of funds by providing services or soliciting (for example, directly or indirectly offering a thing) in the professional services marketplace.

As described herein, a “member” “user” “agent” or “entity” is descriptive of any individual or entity that uses the professional services marketplace. A member can be a service requestor, service provider, registered individual, bot, human, non-human, or system that accesses and uses the professional services marketplace. A user can be descriptive of a type of member who uses services, features, components, modules, applications, and corresponding networks, protocols, devices, hardware and software for the purposes of accessing and using the professional services marketplace. A user can also be descriptive of unregistered users (for example, a guest who browses the public pages of the website), a bot (for example, a search engine crawler) or an account owner, manager, moderator, editor, director, or creator.

As described herein, a “group” “collection” “organization” “company” “team” and pluralities consisting of “agents” “buyers” “sellers” “users” “members” “clients” “providers” “requestors” or “entities” refer to two or more individuals, two or more bots, or combinations of individuals and bots that utilize the professional services marketplace. For example, a group can be a company who provides consulting services and who owns an account that are linked to other accounts. A collection can be two or more users who belong to a specific classification (for example, category, topic, industry, sector, domain, niche, and others) and who can perform homogenous actions (for example, purchase similar professional services), heterogenous actions (for example, purchase different professional services) or a combination thereof on the professional services marketplace.

As described herein, a “bot” “intelligent agent” “AI bot” “AI agent” is descriptive of computer systems, software, application, component or module that uses the professional services marketplace. A bot can represent software that is enabled, embedded, included, imported, activated or provisioned in the professional services marketplace. For example, an artificial intelligent or “AI” bot can be used to expedite communication between one and many users of the professional services marketplace by automatically responding to inbox messages through features that detect, translate, interpret and process inbox messages on behalf of a user. In another example, an AI agent can be used during a virtual meeting to moderate comments, administrate attendees, poll or survey attendees, translate conversations, advertise, up-sell, cross-sell, promote, and perform other actions.

In addition, as described herein, “computing device” refers to computing devices that can correspond to a remote device, work station, computer, general purpose computer, Internet appliance, hand held device, wireless device, portable device, wearable device (for example, smart watch), smart home device (for example, smart appliance), cellular or mobile phone, Personal Digital Assistant (PDA), smartphone, tablet, ultrabook, netbook, laptop, desktop computers (for example, a Personal Computer), multi-processor system, microprocessor-based or programmable consumer electronic, game consoles, set-top box, network personal computer (PC), mini-computer, brain computing interface, etc. that can provide network connectivity and processing resources for enabling a user to communicate with one or more systems over one or more Computer Networks. Several examples described herein provide that methods, techniques, and actions performed by a computing device are performed programmatically, implemented by a computer, operated by a person and a combination thereof. Programmatically, as used herein, means through the use of computer-executable instructions or computing code. These instructions can be stored in one or more memory resources of one or more computing device. A programmatically performed step may or may not be automatic. Implemented by a computer, as used herein, means through the use of a computing device, software, firmware, operating system, website application, mobile application and other device applications, software, firmware or operating system.

The term “operated by a person and a combination thereof”, as used herein, means that a person or computer performs actions or receives information from another person or computer. The operations or actions of a person or computer may include but are not limited to clicking, dragging, touching, swiping, scrolling, panning, rotating, zooming, tilting, searching, filtering, sorting, browsing, sending, receiving, modifying, creating, removing, encrypting, decrypting, provisioning, administrating, monitoring, moderating, analyzing, compressing, decompressing, obfuscating, animating, sharing, referring, referencing, uploading, downloading, caching, storing, retrieving, reading and writing information.

The term “information” is hereto referred to as any contextual, media, document, bit or formatted string of data, application, module, component, the plurality of data, media, document and bit that a person or computer can operate with, perform actions against, or a combination thereof. Information may be something that is conveyed or represented by a particular arrangement or sequence of things, data that is processed, stored, or transmitted by a computer, or a quantity expressing the probability of occurrence of a particular sequence of symbols, impulses, and others. In a defining expression, information can be thought of as the resolution of uncertainty; it answers the question of “What an entity is” and thus defines both its essence and the nature of its characteristics. The concept of information has different meanings in different contexts. For example, the concept becomes related to notions of constraint, communication, control, data, form, education, knowledge, meaning, understanding, mental stimuli, pattern, perception, representation, and entropy. Information is associated with data. The difference is that information resolves uncertainty. Data can represent redundant symbols, but approaches information through optimal data compression. Information can be transmitted in time, via data storage, and space, via communication and telecommunication. Information is expressed either as the content of a message or through direct or indirect observation. That which is perceived can be construed as a message in its own right, and in that sense, information is always conveyed as the content of a message. Information can be encoded into various forms for transmission and interpretation (for example, information may be encoded into a sequence of signs, or transmitted via a signal). It can also be encrypted for safe storage and communication.

One or more examples described herein can be implemented using components, engines, or programmatic modules. A component, engine, or programmatic module can include a program, a subroutine, a portion of a program, a software component or a hardware component capable of performing one or more stated tasks or functions. As used herein, a module or component can exist on a hardware component. Alternatively, a module or component can be a shared element or process of other modules, programs, or machines.

Some examples described herein can generally require the use of computing devices, including processing and memory resources. For example, one or more examples described herein may be implemented, in whole or in part, on computing devices such as servers, desktop computers, cellular or smartphones, PDAs, laptop computers, printers, digital picture frames, network equipments (for example, routers), tablet devices, brain computing interfaces and so forth. Memory, processing, and network resources may all be used in connection with the creation, use or performance of any method, or with the implementation of any system.

Furthermore, one or more examples described herein may be implemented through the use of instructions that are executable by one or more processors. These instructions may′ be carried on a computer-readable medium. Machines shown or described within the figures below provide examples of processing resources and computer-readable mediums on which instructions for implementing examples of the invention can be carried and/or executed. In particular, the various machines shown with examples of the invention include processor(s) and various forms of memory for holding data and instructions. Examples of computer-readable mediums include permanent memory storage devices, such as hard drives on PCs or servers. Other examples of computer storage mediums may include portable storage units, such as CD or DVD units, flash memory (such as carried-on smartphones, multifunctional devices, or tablets), and magnetic memory, and so on. Computers, terminals, network enabled devices (for example, mobile devices, such as cell phones) are all examples of devices and machines that utilize processors, memory, and instructions stored on computer-readable mediums. Additionally, examples may be implemented in the form of computer programs, or a computer-usable carrier medium capable of carrying such a program.

In an example according to the present invention, the system comprises at least one processor and at least one non-transitory computer-readable storage medium storing instructions, wherein the instructions are executed on the system when executed by the at least one processor. In an example according to the present invention, the system may further comprise instructions that, when executed by at least one processor, cause the system to send a service request comprising the service identifier to the provider. In an example according to the present invention, the system, when executed by at least one processor, receives a service request from a requestor and sends a confirmation to the provider. There may be further instructions for causing the system to send a refund to the requestor for services not rendered, withdraw the payment amount from the providers account, and send a refund message to the requestor and the provider.

The present systems and methods for a marketplace that include: one or more orders of magnitude reduction on marketing, advertising and operating costs in acquiring customers; a multi-process, multi-application, multi-network and multi-tenant services paradigm; enabling marketplace members a means to communicate with professionals on a transactional services model; service providers and service requestors engaging in pre-paid, scheduled virtual meetings; a hybrid network architecture enabling peer-to-peer, decentralized and centralized networking capabilities; a single place to facilitates financial transactions, event scheduling and virtual communication; a direct-communication model where no electronic output or digital good is produced; a measure of value exchanged that is equal to the service rendered by service providers through pre-paid, on-demand and real-time virtual meetings.

The examples provide unique networking technology, user interface, machine control interface, encryption, databases and internet search capabilities through the various systems and methods that are distinguished herein.

The present examples uses a hybrid centralized, distributed and peer-to-peer network architecture which include:

a centralized service architecture that is enabled as the primary means of facilitating services but is not limited to a particular network paradigm;

services that may be enabled via peer-to-peer networking, decentralized networking or through a centralized network architecture;

components that facilitate hybrid services by intermediation in a centralized, distributed (for example, using a blockchain), or peer-to-peer network architecture;

virtual meeting services that may be centralized or distributed across one or more computing networks;

the use of multiple network-oriented arrangements or communication protocols including peer-to-peer, distributed, cloud and neural networks (for example, communication between one or more neural-cohorts through a brain computing interface);

the use of a computer network, network service, application, messaging service, platform, computing system and network devices; and

the use of multiple device types (for example, desktop, mobile, audio-only, etc.) over one or more internet and digital networks.

The present examples uses a multi-tenant event-oriented service model which include:

a service paradigm that enables profiling, listing, searching, messaging, procuring, scheduling, conferencing, translating, rating, recommending and referring professional services;

event driven paradigm where service requestors select a date and time for services to be rendered (for example, using a calendar driven event scheduler) before, during and after a scheduled virtual conference session (for example, a virtual conference date and time can be extended in real-time);

the use of peer-to-peer (for example, a person to person meeting), peer-to-group (for example, a person provides services to a team) and group-to-group (for example, two organizations attend a virtual exposition) services between requestors and providers which expands the breath of serviceability and the multiplicity of service paradigms supported in a service marketplace;

support for varying member classifications (for example, individuals, groups, commercial entities, governments, virtual entities, non-profit, automated bots) that expands the use of services to more than one group classification (for example, by sector, industry, category, type, discipline, segment, degree, etc.);

support for multi-tenant usage (for example, groups of experts, anonymous users, multi AI agents, information service providers, contacts or connected users of personal or social networks, digital automated sources, online real time available matched users and subscribed and preference base matched service providers or searchers etc.);

meeting times that are scheduled by service requestors where service provides may limit the range of available days, times and services available;

a means for services to be scheduled and confirmed through one or more notification services (for example, phone, email, SMS, IoT device, brain computing interface, virtual reality device, etc.); and

self-service options providing members with the means to evaluate service providers (for example, search and filter), ensuring that both service providers and requestors have a dynamic opportunity to connect.

The present examples uses real-time on-demand service delivery which include:

support for on-demand communication where value exchange is produced through pre-paid, scheduled virtual meetings where service providers are not required to produce digital goods (for example, video content);

communication oriented services paradigm that enable placing information shared by a service provider, in real-time, as the measure of value within the marketplace without the need to place electronic output in the form of virtual goods as measure of value by producers of the marketplace;

service delivery method that specifically makes use of virtual meeting software to enable real-time, on-demand voice and video communication between service providers and service requestors;

components that enable service providers with options to request virtual meetings to be recorded where service requestors may accept, deny or negotiate terms of the recording;

support of virtual events (for example, webinars, web conferences, etc.) in a group-oriented service model;

multiple modes of digital communication is supported (for example, automated phone system, virtual meeting software, web message service, mobile messaging, email service, etc.);

the use of intelligent agents (for example bots) with human-to-human, human-to-bot and bot-to-bot communication;

components that enable users to utilize an auto-response bot in their inbox to answer frequently asked questions from other users who use bots to auto-request quotes for services;

components that enable the use of semi-automated intelligent agents (for example, a chat bot is configured by a user and deployed to a network) where users of a network have the capability of communicating with other users with a semi-automated intelligent agent; and

components that enable users to employ intelligent agents to assist with asking or answering questions (for example, one user has a list of questions and follow up questions that is communicated to another user in a chat session).

The present examples uses a social network oriented electronic commerce which include:

components (for example, networked servers in a datacenter, distributed computing systems, website applications, mobile applications and others) that enable member profiling, listing, searching, messaging, payment processing, scheduling, virtual meeting, rating and reviewing technologies for a plurality of professional service providers and knowledge experts to engage their services in real-time;

facilitating multiple communication modes (for example, collaboration, sharing, searching, messaging, responses via one or more applications including email, instant messaging, video, voice, services including communication services, devices including mobile, networks including internet, intranet and technologies including voice enabled, voice to text or text to voice, SMS, MMS, translation system);

components that enable members to engage in professional discussions (for example, tutoring, reviewing a contract, and/or commitment, providing customer support, reviewing an agreement, resolving an issue, developing an idea, prioritizing action items, reviewing documents, reviewing a virtual product, discussing technical details, business advising, conducting professional training, performing lectures, conducting seminars, etc.);

pre-procurement components that enable communication between requestors and service providers using streams of information exchange through messaging capabilities and document sharing services (for example, a requestor sends a direct message, uploads a document and selects an allocation of time required for services);

components that enable alerts and notification services across multiple devices, applications and systems (for example, sending emails, push notifications, web application prompts, etc.);

components that enable members within the marketplace to refer other members for an incentive (for example, referral commissions, account credits, service discounts, gift cards, etc.);

Components that enable requestors to upload digital artifacts (for example, a document) prior to the scheduled meeting (for example, a requestor uploads a tax document and a provider reviews the document prior to having a virtual meeting);

components that check uploaded documents for malicious spyware or viruses and validates that the document can be viewed on the screen by checking the file type (for example, a document format such as PDF, JPG, PNG, etc.);

components that enable users to evaluate service providers by the use of one or more filters (for example, filter by rating, price, etc.);

components to validate professional credentials (for example, provide a link to their social profile, upload a resume, upload a certification); and

components that enable professional data aggregation from social networks and other sites.

The present examples uses a flexible procurement and payment service model which include:

a service model paradigm where service requestors pay for services in advance of the service being performed;

components where the issuance of payments to a service provider is contingent on the fulfillment of a service to a service requestor;

components to facilitate financial transactions between service provider and service requestor through the use of a payment system (for example, credit card processor, PayPal), Bitcoin, etc.);

components enabling a hybrid transactional model where services may be purchased directly or through a bidding system;

the use of a bidding system that supports multi-faceted bidding options (for example, bidding based on on-time, off-time, service terms, etc.) where a service requestor is enabled to bid or negotiate price and service availability directly with a service provider if a service provider determines that the service may be available for bids;

components for bidding that is not based on a frequency or duration of time remaining since services are bound to service availability;

components that bind financial transactions to the deliverability of services between a service provider and a service requestor (for example, payments to service providers are held in escrow and released after the date and time of the scheduled service); and

payments from a multiplicity of services models (for example, question and answer service, searching service, analysis service, task service, research service, consulting service, business service, language service, career service, health service, matrimonial service, lifestyle service, information service, location specific services, fitness service, education and training service, sales and marketing service, idea formation service, product review service, entertainment service, tax service, assessment service, finance and stock service, mobile service, technical support service, advisory service, accounting service, event service, communication and support service).

The present examples uses a service oriented professional marketplace which include:

a direct approach to connecting service providers to service requestors;

methods whereby service marketplace is not exclusively available to a single service classification;

methods that do not require the location of a user to facilitate communication between users;

methods that do not support money transfers directly from one member to another (for example, send remittances);

methods that do not place uploaded documents as a type of conversation;

methods that are not designed for the purposes of organizing group outings;

methods that do not make use of a ticketing module;

methods that do not require members to be authorized or invited to request for services interest between members;

methods that do not place electronic output in the form of virtual goods or virtual output as measure of value by producers of the marketplace;

methods that do not make use of an invoice analytics system; and

methods that are not prominently search appliances for accessing knowledge.

The first component are the users who utilize tools and internet-based software services and applications in order to receive value from said utilization as is described in detail below. More specifically the users are broken down into three user types, namely a user who requests services, a user who provides services and a user who facilitates information transfer in an artificially intelligent and semi-autonomous way. The goal of the user who requests for services is to obtain professional services (through the exchange of information over a video call) from a professional. The goal of the user who provides services is to obtain a financial benefit (such as payment for services and tips) and social clout (in the form of reviews, ratings, recommendations, and referrals). In order for a user who request services to receive professional services from a user who provides services, a third user must enable the transfer of information between the requestor and provider of services. The goal of the third user is to assist in the exchange of information through digital methods, namely through software systems (in example, networking services from a cloud provider such as Amazon Web Services) and internet services (in example, third party programs and software applications like Zoom). When the interactions of all three user types come to an end, it is said that the professional services life-cycle is complete. Either a user who request services or a user who provides services can initiate the professional services life-cycle. For example, a user who provides services may solicit services through a public profile link to members of other networks (in example, sharing a profile link to a social network like Instagram or a video network like YouTube). In another example, a user who request services may create an account on the professional services marketplace, search for a service of interest and initiate the professional services life-cycle by procuring the services. There are instances where the third user type, who facilitates services may initiate the professional services life-cycle. For example, an intelligent agent (artificial intelligent software that acts as a non-biological user) may suggest services to a requestor of services based on specific behavioral patterns, historical search queries and categories of interest of the requestor of services. When an intelligent agent suggest services, the suggestion is targeted towards a specific user who provides services and a specific service offering by the user who provides services. In general, the professional services life-cycle starts from the service page of the user who provides services and continues through-out other pages such as the procurement page, video conference page, and the reviews page. The professional services life-cycle ends when both the user who request services and the user who provides services have concluded the reviews, ratings, tips and other related steps.

The second components are the marketplace system and software services that provide the tools, information and support for users as will described below. The marketplace system may take the form of a website (for example, a web application that is viewed on an internet browser), mobile application (for example, an app on an iOS or Android device) or other device applications (for example, television application, smart watch application, and others). The marketplace software services include applications (for example, programs that perform specific functions or a collection of functions in a particular domain or area of focus) that users of the professional service marketplace may interact with, consume or share. The tools that are utilize may include one or more tools for enabling basic marketplace functionality to be accessible by users (for example, searching for services, filter and sorting service items from a search result, and browsing a service catalog). The information that the professional services marketplace system may also vary including, user information, service information, an aggregate of user information, services information and trends, scheduling and payment information and others. The support for users on the marketplace system can take the form of one or more mediums which may include a combination of software services and user interactions. For example, the marketplace system contain frequently asked questions and a library of definition and terms that are user defined. The marketplace system is most active (meaning software services are provided and tools are utilized) when users of the professional services marketplace interact by performing actions (for example, clicking, selecting, scrolling, typing, talking, viewing) using one or more devices (for example, a laptop, mobile phone, tablet device, internet enabled device, brain machine interface device, etc.) that support interactive capabilities (for example, touching, dragging, thinking, seeing, rotating, panning, swiping, etc.). In additional, the marketplace system can operate independently of user actions (for example, software services that perform background operations that do not require a user's input) and can be activated by other software systems (a third-party application can invoke an action through an Application Programmable Interface, API).

The third components are the networking technology that enable both users and the marketplace to achieve utility as will be described below. Networking technology may range from region to region where the laws and capabilities or support for specific networking functions may be limited. Through networking technology, users can interact with the marketplace and the marketplace can interact with users respectively. When a user utilizes an internet enabled device (for example a laptop device such as a MacBook), the device connects to one or more internet technologies (for example Wireless Fidelity, Wi-Fi or Local Area Network, LAN) that transmit data (for example, a user's request to search the professional services marketplace website for a service) through a secure protocol, port, MAC address, IP address and subnet. The networking technology then transmits data to one or more other networking technologies (for example, by satellite or fiber optic cable). The final delivery of data reaches the marketplace system which interprets the data and responds accordingly. The networking technology enables both users and marketplace to interact and exchange information ad infinitum.

When the users, marketplace system and networking technology are all working together, the present invention is whole and complete.

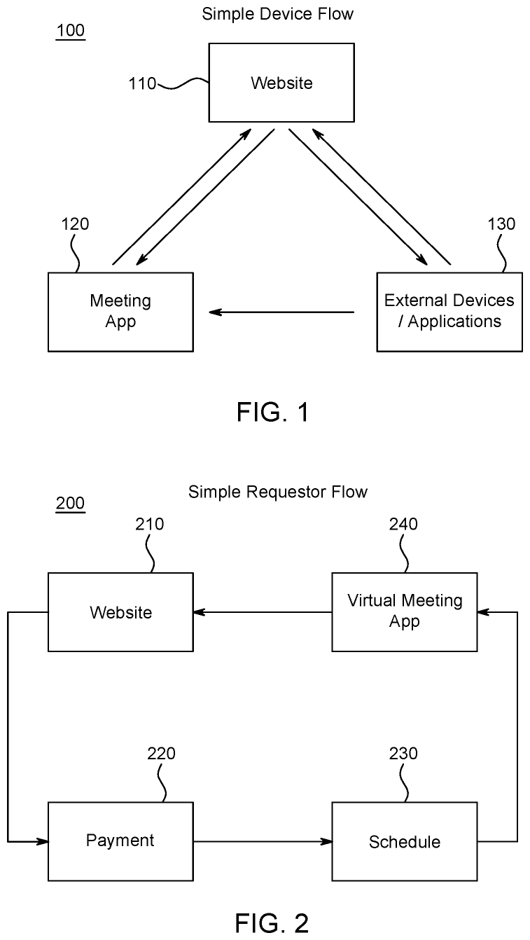

FIG. 1 is a block diagram illustrating a simple device flow 100, according to some examples. A networked system of computers, through one or more communication networks, such as the Internet or Wide Area Network (WAN), for example, of provides server-side functionality and a user interface in the form of a website 110 to one or more external devices and applications 130. FIG. 1 illustrates, for example, a web client 110, such as a browser, for example, and a meeting application 120 executing on respective external devices and applications 130.

The website 110 may be a professional services marketplace and may, make use of multiple device types over one or more internet and digital networks. The device types may include a desktop, mobile, audio-only devices, for example. In various implementations, the external devices and applications 130 comprise a computing device that includes at least a communication capability that provide access to the networked system of computers via one or more communication networks. The external devices and applications 130 comprise, but are not limited to, a remote device, work station, computer, general purpose computer, Internet appliance, hand-held device, wireless device, portable device, wearable device (for example, smart watch), cellular or mobile phone, PDA, smartphone, tablet, ultrabook, netbook, laptop, desktop computers (for example, PC), multi-processor system, microprocessor-based or programmable consumer electronic, game consoles, set-top box, network PC, mini-computer, brain computing interface, artificial intelligent system, blockchain enabled device, decentralized computing device, and networked devices and applications. In an exemplary example, the external devices and application 130 comprise one or more of a touch screen, accelerometer, gyroscope, biometric sensor, camera, microphone, Global Positioning System (GPS) device, brain computing interface sensor and the like.

The website 110 makes use of meeting services that may be centralized or distributed across one or more computing networks. A meeting application 120 may communicate to one or more external devices and applications 130 and may also communicate with the website 110 using various communication interfaces, protocols, networks and the like. A meeting application 120 may be used to support virtual events (for example, webinars, web conferences, etc.) in a group-oriented service model that makes use of on-demand communication where value exchange is produced through pre-paid, scheduled meetings. A meeting application 120 further comprise, but are not limited to communicating to an Application Program Interface (API) server, a web server, an application server, a decentralized server, a cloud enabled server, a local server, a peer-to-peer computing system, a brain machine interface (BMI) and others. While the meeting application 120 are shown in FIG. 1 to form part of the networked system of external devices and applications 130, it will be appreciated that, in alternative examples, the external devices and applications 130 may form part of a service that is separate and distinct from the meeting application 120. With some example examples, the meeting application 120 may contain what is referred to herein as a “virtual meeting” or a “conference call”. The flow by which a person navigates from the website 110 to a meeting 120 is described in more detail below in conjunction with FIG. 2.

Further, while the website 110 shown in FIG. 1 employs a client-server architecture, the present invention is of course not limited to such an architecture, and could equally well find application in a distributed, or neural network, architecture system, for example. The various external devices and applications 130 could also be implemented, represented, configured, distributed or registered as standalone software programs, which do not necessarily have networking capabilities. In an example, the external devices and applications 130 hosts an offline and pre-recorded collection of previously attended meetings 120. In some examples, the meeting application 120 is part of the website 110 while in other examples, the meeting application 120 is separate from the website 110 while being communicatively coupled to the external devices and applications 130.

The website 110, meeting application 120, and external devices and applications 130 may contain at least one or more third-party applications (for example, a widget or application extension), executing on at least one or more third-party servers, as having programmatic access to the networked system that connects to the website 110, to the meeting application 120 or to the external devices and applications 130 via the programmatic interface provided by the API server or other communication means. For example, the meeting application 120 may, utilizing information retrieved from one or more external devices and applications 130, support one or more features or functions on a website 110 hosted by the third-party. Such an exemplary website 110 may, for example, provide one or more functions that are supported by the relevant applications of the networked system and may also support one or more features by other websites 110 that utilize the modules, extensions and components of the professional services marketplace. For example, a website 110 may contain embedded JavaScript code that, when generated, enables a meeting application 120 and communicates to one or more external devices and applications 130.

FIG. 2 is a block diagram illustrating an example of a simple requestor flow 200. Utilizes a flexible procurement and payment service model allows service requestors to utilize a payment processor 220 for services in advance of the service being performed; where the issuance of funds from the website 210 to a service provider is contingent on the fulfillment of a service to a service requestor; where transactions are bound to the deliverability of services between a service provider and a service requestor (for example, payments to service providers are held in escrow and released after the date and time of the scheduled 230 service); where meeting times are scheduled 230 by service requestors; and where service provides may limit the range of available days, times and services available on the website 210. The requestor flow may be comprised of modules which include a website 210, a payment processor 220, a scheduling system 230, and a meeting application 240. It will be appreciated that each module can be implemented as a single module, combined into other modules, or further subdivided into multiple modules. Although not illustrated, other modules not pertinent to example examples can also be included in any arrangement or flow.

The website 210, similar to website 110 described above, may provide for services to be scheduled and confirmed through one or more notification services (for example, phone, email, sms, IoT device, brain computing interface, virtual reality device, etc.). After the payment processor 220 provides functionality to facilitate payments, the scheduling system 230 may provide a collection of components, modules and systems for scheduling services. Since a service requestor is enabled with self-service options during a service lifecycle (for example, from searching, procuring, scheduling, and meeting to rating, revising, tipping and referring), a service requestor may utilize the website 210 to benefit from a plurality of communication enabled modules, whereas the plurality of communication enabled modules includes at least, the payment processor 220, the scheduling system 230 and a meeting application 240, similar to meeting application 120 described above.

The scheduling system 230 is enabled by a transaction trigger of the payment processor 220, for example, enable scheduling once the payment has cleared. The website 210 contain user interface and server-side application modules to facilitate both the payment processor 220 and the scheduling system 230, where the scheduling system 230 is enabled by a plurality of transaction triggers of the payment processor 220, where each transaction trigger is grouped by the given session of the user on the website 210. The scheduling system 230 may enable one or more transaction triggers of the payment processor 220, although such enabling is not necessary as enabling may also or instead occur through a third-party API server, a network enabled device, a distributed blockchain application and others.

In some implementations, the website 210 provides various modules and user interface functionality operable to interactively present (or cause presentation) and receive information from the payment processor 220, the scheduling system 230, or the meeting application 240. For instance, the website 210 may cause the presentation of user interfaces configured to facilitate meetings, such as based virtual conferencing, for example.

In various implementations, the website 210 and the meeting application 240 may present or cause presentation of information (for example, visually displaying information on a screen, acoustic output, haptic feedback). Interactively presenting information is intended to include the exchange of information between a particular device and the user. The user may be of one or more classifications (for example, individual, company, nonprofit, government, group, agent, bot, etc.) herein referred to as the “user.” The user may provide input to interact with the user interface in many possible manners, such as, alphanumeric, point based (for example, cursor), tactile, or other input (for example, touch screen, tactile sensor, light sensor, infrared sensor, biometric sensor, microphone, gyroscope, accelerometer, brain computing interface sensor or other sensors). It will be appreciated that the website 210 and/or the meeting application 240 provides many other user interfaces to facilitate functionality described herein. Further, it will be appreciated that the “website” as used herein is intended to include communicating information or instructions to a particular device that is operable to perform presentation based on the communicated information or instructions.

The website 210 and/or the meeting application 240 provides various module specific functionality and web services. For example, the website 210 provides network communication such as communicating with the networked device that contains the meeting application 240, communicating with decentralized and peer networks, connecting to a neural cohort network and others. In various example examples, the network communication of the website 210 and the meeting application 240 may operate over wired or wireless modalities. Website 210 is intended to include retrieving information from the third-party server(s), database(s), and the application server(s) that communicate to one or more meeting applications 240, payment processor 220 and/or scheduling system 230. In some implementations, information retrieved by the website 210 comprises data linked to the user (for example, user profile information from an online account, social network service data linked to the user), or other data to facilitate the functionality described herein such as information related to the payment processor 220, the scheduling system 230 and/or the virtual meeting application 240. In further example examples, the scheduling system 230 provides functionality to generate alerts and notifications to facilitate communications between potential service requestors and service providers. For example, the notifications may include email, private messages, notification registration services, text messages (Short Messaging Service (SMS), Multimedia Messaging Service (MMS), Enhanced Messaging Service (EMS), etc.) and so forth. The professional services marketplace may be enabled with modules to facilitate payment, scheduling and streaming of on-demand virtual meetings through use of a website 210, a payment processor 220, a scheduling system 230 and a meeting application 240.

The payment processor 220 may provide functionality to facilitate payments between service requestors(s) and service providers. Wherein the payment processor 220 may include a connected payment services gateway to hold money for services reserved using online payment methods (for example, credit cards, debit cards, PayPal®, etc.) in escrow until a specific period of time after the ending of a virtual meeting session in the meeting application 240 specified by the scheduling system 230. Service providers may indicate whether they accept one or more currencies (for example, cryptocurrency or fiat currency). Service requestors may choose a method of payment, based on the accepted methods of payment indicated by a service provider or as set by the professional services marketplace by default. The payment processor 220 may orchestrate payment through the website 210, through the meeting application 240 or both. The website 210 may orchestrates the payment processor 220 independently, through a web based virtual meeting application 240, through an API server, or by a decentralized payment service, peer-to-peer payment service, third-party service, for example.

The scheduling system 230 may provide functionality to facilitate scheduling and notifications between service requestor(s) and service provider(s). The scheduling system 230 may include modules to allow scheduling (for example, date and time) and allows potential service requestors to select and request available meeting times of service providers. The scheduling system 230 may include an interactive scheduling system such that potential service providers may confirm available meeting times specified by service requestors on the website 210 or the meeting application 240. For example, the scheduling system 230 is enabled to graphically illustrate the availability of a service provider in providing the availability. The scheduling system 230 may allow a service requestor to view the availability of a service provider, select a time and confirm the meeting request for one of the available times of the selected meeting time. The scheduling system 230 may be enabled to allow a service provider to indicate one or more services provided (for example, personal coaching after regular business hours), neither (for example, restricted offline hours, holiday restrictions, religious days or time restrictions, etc.). The website 210 may be enabled with a scheduling system 230 to allow a potential service provider to choose meeting times and restrictions for the services provided based on the options indicated by the service requestor or configured by the service provider.

The meeting application 240 may provide functionality to facilitate virtual meetings. The meeting application 240 may be enabled to allow meeting participants (for example, service requestor, service provider, groups, meeting bot, etc.) to use various functions such as to conduct a poll, configure audio/video settings, enable recording, select locale, send messages, send attachments, enable meeting recording, transcribe audio, share screen, enable and configure add-on widgets and so forth. The meeting application 240 may contain one or more architectures designed to enable virtual meetings. The meeting application 240 may for example contain a user interface for displaying digital imagery (for example, live video streaming, uploaded attachments, screen sharing, polling details, etc.), or may not contain a user interface display and instead is audio enabled (for example, network enabled IoT home device with speaker and microphone support). The meeting application 240 may be enabled to be embedded as software or programs within a brain computing interface where digital imagery is perceived without external devices or appliances. In the context of a virtual meeting, the meeting application 240 may act as a source of information sharing and is not restricted to any of the mentioned architectures. The meeting application 240 may be enabled by the use of other modules, namely the use of the scheduling system 230 for scheduling the meeting and notifying participants, the payment processor 220 for facilitating payments in advance of the meeting and during the meeting and the use of a website 210 for connecting service providers with service requestors.

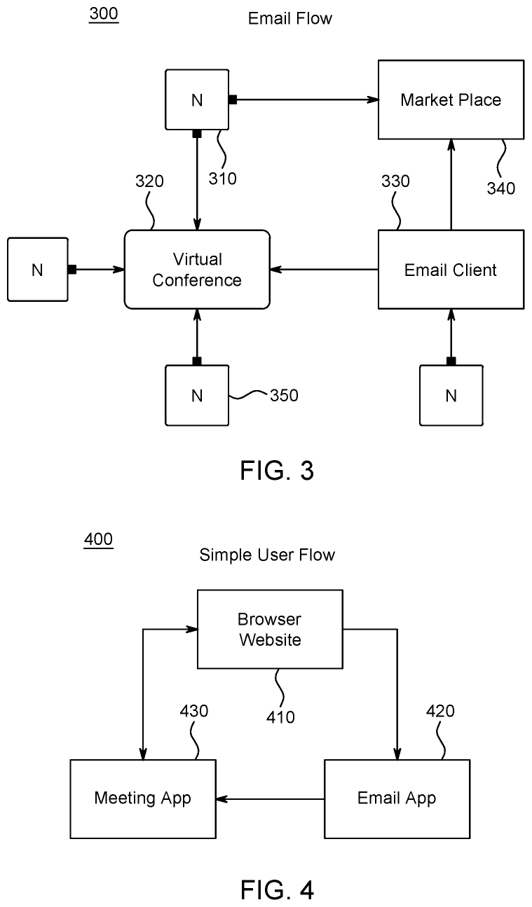

FIG. 3 illustrates an example method for an email flow 300 on a computing device. In the professional services marketplace, multiple modes of digital communication are supported. These modes include automated phone system, virtual meeting software, web message service, mobile messaging, email service, for example. These modes are supported through a service delivery method that makes use of meeting software as described in FIGS. 1 and 2 to enable real-time, on-demand voice and video communication between service providers and service requestors. The professional services marketplace makes use of pre-procurement components that enable communication between requestors and service providers using streams of information exchange through messaging capabilities and document sharing services. For example, a requestor may send a direct message, upload a document and select an allocation of time required for services.

The professional services marketplace makes use of components that enable alerts and notification services across multiple devices, applications and systems. These components include components to send emails, push notifications, web application prompts, for example. A method such as described by an example of FIG. 2 can be implemented using, for example, components described within an example of FIG. 3. Accordingly, references made to elements of FIG. 3 are for purposes of illustrating a suitable element or component for performing a step or sub-step being described (for example, communication using an email client 330, conference application 320 or the marketplace 340 website or device application).

Computer networks, network services, application, messaging services, platform services, computing systems and network devices may be utilized as described herein. For example, the marketplace 340 may receive communication from a computing device 310 hereto referred as a “node”, “computer” or “computing device”. According to different implementations, the node 310 may also communicate to a conference application 320 that can be determined and enabled based on data provided by an email client 330. As an example, a user operating a computing device 310 may click on a link provided the message of an email client 330, whereas the email client 330 is configured to communicate to the computing device 310 with instructions to open a conference application 320, or to open a browser tab with a reference pointer, such as a webpage URL, for example, for navigating to the marketplace 340.

The illustration in FIG. 3 demonstrates a simple email flow 300 primarily between an email client 330 and a marketplace 340 and/or one of a conference application 320. In a different variation of the email flow 300, the email client 330 may not be enabled, provided, or used to communicate to a conference application 320, whereas an external node 350 hereto referred as “external node”, “external device” or“computing interface”, may communicate directly to a conference application 320 without the intermediation of an email client 330 or a marketplace 340.

In the instance where an external node 350 communicates to a virtual conference application 320, additional identity verification, payment processing or the like, may be used to enable access to the virtual conference application 320. For example, a user of an external device 350 may connect to a virtual conference application 320 through a voice command, authenticate access using a unique identifier, and complete payment processing using pre-saved payment details. For example, an IoT appliance may be used to initiate an audio only meeting. In another example, a person with an embedded brain computing interface as external device 350 thinks about scheduling or attending a virtual meeting, the brain computing interface via external device 350 registered the thought, and connects directly to a meeting application 320, with instructions that tell the meeting application 320 to completes payment processing, schedule meeting time and initiates the meeting in real-time.

The meeting application 320 and the marketplace 340 may communicate availability of services, user account details, marketplace details and others in a direct flow, through computing devices 310, modules, components, applications and others. For example, the meeting application 320 may connect to an external node 350 of a decentralized network containing one or more external nodes 350 (for example, using a blockchain network to send and receive messages). The meeting application 320 may be initiated by standalone external devices 350 or networked computing devices 310 and many communicate to one or more devices 310-350 in simple and complex network schemes, architectures and protocols (for example, using a TCP connection to connect to one or more devices).

FIG. 4 is a schematic representation of a simple user flow 400. The operations of FIG. 4 will be described with reference to the example of FIG. 1. However, it should be understood that the operations of FIG. 4 can be performed by examples of the invention other than those discussed with reference to FIG. 1, and the examples discussed with reference to FIG. 1 can perform operations different than those discussed with reference to FIG. 4. The marketplace may utilize an event driven paradigm where service requestors select a date and time for services to be rendered before (for example, using a calendar driven event scheduler), during and after a scheduled conference session (for example, a conference date and time can be extended in real-time). Upon a selection, a service requestor is provided a means for services to be scheduled and confirmed through one or more notification services (for example, using an email application 420 to send notifications.).

According to one example of flow 100 FIG. 1, the website 110 performs the operations of FIG. 4. With reference to FIG. 4, an email application 420 enabled to communicate to a website browser 410 transmits communication to start a virtual meeting application 015. With reference to FIG. 1, the external devices and applications 130 may be one or many devices, applications, modules, components or intelligence, designed to perform operations and communicate to a meeting application 120 of the same external devices and applications 130 or different applications, modules components, interfaces and the like. The simple user flow 400 schematic represented in the example of FIG. 4 is an example of a typical journey a user takes to configure a meeting. The meeting application 430 is enabled to communicate to a website browser 410 with information related to the meeting session and other information that is used during the meeting (for example, information related to extending the current virtual meeting time is sent). The simple user flow 400 illustrates bi-directional communication between the meeting application 430 and the website browser 410, whereas the email application 420 contain uni-directional communication between the website browser 410 and the meeting application 430. Other configurations schemes and architectures can be enabled to facilitated pre-paid, virtual meeting sessions.

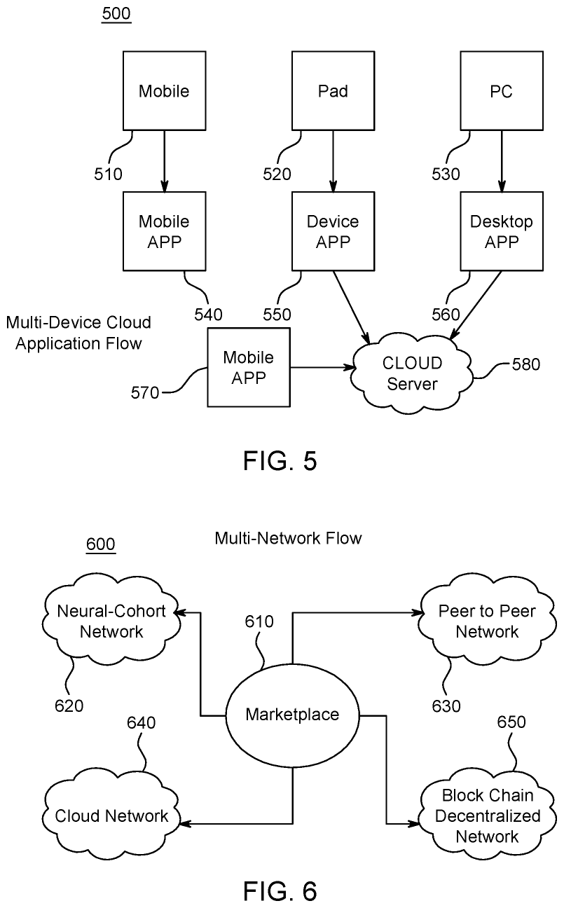

FIG. 5 is a flow diagram illustrating an example method 500 for a multi-device application flow for devices and applications. Multiple network-oriented arrangements or communication protocols are used. These arrangements may include peer-to-peer, distributed, cloud and neural networks (for example, communication between one or more neural-cohorts through a brain computing interface). The device software or application that operates on a virtual or physical device may be classified by a multiplicity of types, functions, procedures, processors, parts, arrangements, groups and others. For the purposes of illustrating a typical cloud server 580, connectivity for device software or application, FIG. 5 includes details relevant to the understanding of how a user may access a marketplace.

The marketplace may be enabled to facilitate multiple communication modes (for example, collaboration, sharing, searching, messaging, responses via one or more applications including email, instant messaging, video, voice, services including communication services, devices including mobile, networks including internet, intranet and technologies including voice enabled, voice to text or text to voice, SMS, MMS, translation system). Additional components may be used to enable multiple communication services across multiple devices, applications and systems (for example, sending emails, push notifications, web application prompts, etc.). For example, a mobile device 510 may install, arrange, compile, execute, assemble, process, reference, consist of, or make use of a mobile application 540, containing instructions, procedures, routines, executables, code, units, features, components, modules that enable service providers and service requestors with the ability to connect. The flow diagram illustrating an example method 500 for a multi-device application flow, displays three types of devices, however the device types may vary. For example, a user may access the professional services marketplace through a smart watch or an IoT home appliance (for example, using an Amazon Alexa enabled device at home).

The flow diagram in FIG. 5 also only presents devices that are designed for portability (for example, using the device while traveling), but the means of accessing the marketplace are usability agnostic and the specific or general functions of the devices may vary. There are a plethora of other varying attributes, features, functions, classifications and the like that may differ among devices (for example, the connectivity of devices may vary), however the utility of connecting professional services providers with the requestors of such services are the same. By way of example, all devices can connect to some, all or none of the other devices, some of the devices may connect to the cloud 580, and some devices may connect to other networks while other devices may not be connected at all (for example, a device is operating in offline mode).

Since users of a marketplace may utilize features that do not require persistent connectivity, some of the devices and applications may work offline while others may not. For example, a user may operate a portable electronic notebook or pad 520 to connect to the internet, where the device application 550 that operates on the pad 520 may connect to a cloud server 580, containing information relevant to the user's request. The device application 550 may be enabled to connect to one or more cloud servers 580 or connect to other devices (for example, using Bluetooth to connect to an IoT device) that may use the internet to send and receive communication to the cloud server 580. The device application 550 may operate and exist independently of a particular device hardware or arrangement of software. For example, a mobile phone 510 may install and run the mobile application 540, the pad 520 may install and run the device application 550 and the personal computer 530 may install and run the desktop application 560. The mobile application 540, the device application 550 and the desktop application 560 may contain the same or similar functionality, features, specifications, utility that enable users to connect, consume services, and perform other functions.

An application related to a marketplace may connect to a variety of networks. In the basic sense, an application may use a Local Area Network from the device level, a Wide Area Network, Metropolitan Area Network or other computer networks. The marketplace may be designed to enable devices and device applications 550 to utilize a network including preferred or required networks to connect users regardless of region, boundaries, jurisdiction or others. The marketplace may make use of multiple network-oriented arrangements or communication protocols including peer-to-peer, distributed, cloud and neural networks (for example, communication between one or more neural-cohorts through a brain computing interface).

FIG. 6 is an example system and process flow illustrating a multi-network flow 600 according to some example examples. A computer network is a group of computers that use a set of common communication protocols over digital interconnections for the purpose of sharing resources located on or provided by the network nodes. The marketplace 610 makes use of multiple computer networks which may contain heterogenous, homogenous, or hybrid arrangements or communication protocols, peer-to-peer, distributed, cloud and neural networks (for example, communication between one or more neural-cohorts through a brain computing interface), and others. A computer network, network service, application, messaging service, platform service, computing system and network device may be utilized within the marketplace 610. There may also be other components that facilitate hybrid services by intermediation in a centralized, distributed (for example, using a blockchain), or peer-to-peer network architecture that is used within the marketplace 610. The multi-network flow 600 illustrated in FIG. 6 demonstrates how multiple networks may connect to the professional services marketplace website 610. A typical computer network is made up of machine components or computer nodes that communicate with other nodes through a vast array of protocols, channels, frequencies and specifications.

A network may be classified into one or many types. With a general computer network, connectivity at its core is derived from specified boundaries that vary based on geographical or security related restrictions. For example, a Virtual Private Network or VPN, uses the internet to connect a device with protected resources to other devices (for example, a company uses VPN to allow employees to access and share resources from outside of the physical boundary of the company's location). Employees at a company may utilize an Enterprise Private Network or EPN through one or more connected devices (for example, an employee connects to the company's EPN to receive professional on-demand training on leadership and management). The marketplace 610 may be accessed using public, private or other variations of networks. For example, a Campus Network may connect to the marketplace 610 and enable students, staff members and vendors access to professional services (for example, students connect to the Campus Network to receive on-demand tutoring services).

A cloud network 640, or cloud computing is the on-demand availability of computer system resources, especially data storage and computing power, without direct active management by the user. Using cloud architecture in thousands of different locations globally, cloud networking allows organizations to deliver content faster and monitor their devices and operations in real-time. It also helps to keep them abreast of any network security issues, including monitoring high volumes of traffic. Today's modern applications are deployed to a cloud network 640 which aims at high availability, redundancy, speed, security and deliverability of digital products, services and resources in the form of software, media, and others. The marketplace 610 utilizes a cloud network 640 to provide, consume, modify, exchange, classify, recommend, and provision services to users. The marketplace 610 utilizes a centralized service architecture that is enabled as the primary means of facilitating services but is not limited to a particular network paradigm. For example, services may be enabled via peer-to-peer networking, decentralized networking or through a centralized network architecture. The marketplace 610 may make use of components that facilitate hybrid services by intermediation in a centralized, distributed (for example, using a blockchain), or peer-to-peer network architecture.

A cloud network 640 may be used to connect the marketplace 610 with users using a myriad of cloud network 640 resources. For example, a cloud network may provide media files (for example, images and videos) to the professional services marketplace website using a Content Delivery Network or CDN. There are many and varying cloud resources that may be used to service users through a professional services marketplace website 610. A cloud network 640 by design, is centrally managed, meaning that there is a possibility for a single source of failure to exist due to the centralized structure. The marketplace 610 uses a cloud network 640 while making use of emerging and varying network architectures to better service users. Not all features, components, modules and services offered and supported on the professional services marketplace website utilize all of the same networks. For example, the actual content that generates the marketplace 610 may be assembled, bundled, compressed and served through one or more cloud computing servers with service requestors enabled to provide tips for quality services using a peer-to-peer network 630, which may enable direct payment to a service provider. Any combination of services, software, components, modules, features, and resources can be available using any number of networks, architectures, protocols and others.

Peer-to-peer networking 630 is a distributed application architecture that partitions tasks or workloads between peers. Peers are equally privileged, equipotent participants in the application and are said to form a peer-to-peer network 630 of nodes. Peers make a portion of their resources, such as processing power, disk storage or network bandwidth, directly available to other network participants, without the need for central coordination by servers or stable hosts. The marketplace 610 may be enabled to support one or more peer-to-peer network 630 architectures for a range of services where users may benefit the most. For example, a user of the marketplace 610 may securely transfer digital documents using a private peer-to-peer network 630 during a web conferencing session. In another example, a user may use a combination of a cloud network 640 and a peer-to-peer network 630 to send and retrieve data (for example, sending media data over the cloud network 640).

The marketplace 610 may utilize virtual meeting services that may be centralized or distributed across one or more computing networks. For example, during a conference session, a user may wish to use a peer-to-peer network 630 to securely transfer files to other users in the virtual conference. In some cases a direct peer-to-peer network connection is not feasible and, in that instance, a standard peer-relay server may be required. The marketplace 610 may also make use of a peer-to-peer blockchain decentralized network 650. In blockchain network 650, data is copied and stored on two or more nodes within the network in the form of a distributed ledger. To verify and keep record of live conference sessions, the marketplace 610 may use a blockchain decentralized network 650 as a way of enabling transparency and trust within the marketplace. For example, tracking and analytics during a meeting lifecycle, stored and an identifier for the stored item (for example, a hash value) is stored in a ledger, which enables service providers and service requestors with a way of verifying that the meeting session actually started, persisted and ended. Connection between the marketplace 610 and the blockchain decentralized network 650 may be established using one or more connection services (for example, using an Application Programmable Interface, API to connect to the Mainnet to Ethereum Blockchain Network).

In the emerging technological era, newer IoT devices are enabling users with the ability to achieve tasks and simply routines at ease. For example, a brain machine interface device may be used to connect a user's brain waves to software that converts waves into interpreted data. With a growing demand for brain machine interfaces, the network capabilities for a high bandwidth, highly connected world will give users the ability to communicate to other users of a brain machine interface device by simply thinking the thoughts. A neural-cohort network 620 is formed when two or more brain machine interface devices securely connect. The network connectivity, protected by security measures (for example, using encryption, telemetry handshake, multi-factor authentication, etc.) of a neural-cohort network 620 provides users with the ability to communicate. The marketplace 610 may be displayed to each user using a spatial holographic overlay that the brain machine interface software produces.

The example illustration in FIG. 6, demonstrates several examples of heterogenous networks that may connect to the professional services marketplace website 610. Other networks types not illustrated may be users to communicate to the professional services marketplace website 610. For example, a Wide Area Network may be used by local governments as a way of localizing professional services within a particular network boundary.

The marketplace 610 may connect to one or more networks 620-650 and one or more networks 620-650 may connect to the professional services marketplace website 610. In the marketplace 610, the use of a computer network, network service, application, messaging service, platform, computing system and network devices are present. The example illustration in FIG. 6 demonstrates a possible arrangement of networks 620-650 but there is no specific arrangement of networks that are specified since anyone skilled in the arts of arranging a particular network may find that other network arrangements may be used.

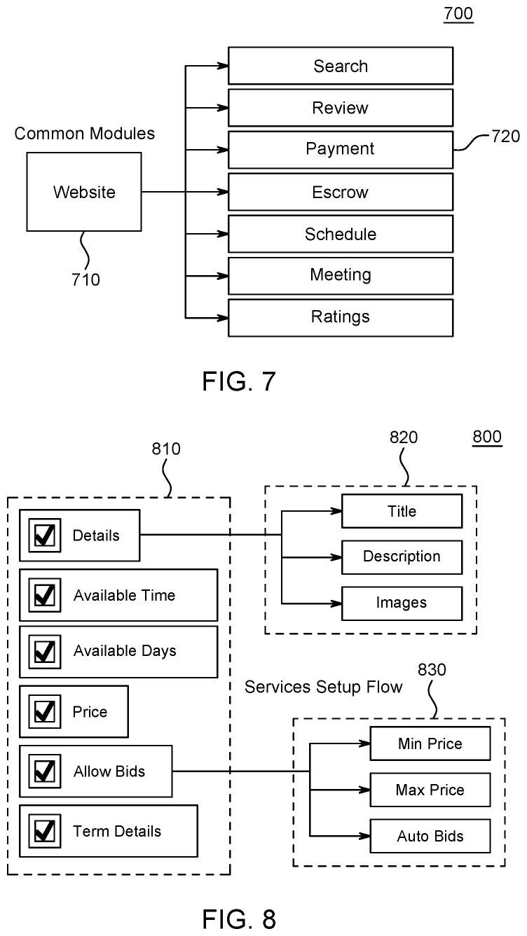

FIG. 7 is a block diagram that represents a set of common modules 700 to enable the requestor to complete a service lifecycle. A module is a representation of a collection of software or a part of a program that contains one or more routines. One or more independently developed modules make up a software program. For example, an enterprise-level software application may contain several different modules, and each module serves unique and separate business operations. A modular service architecture is a type of software design pattern that emphasizes separating the functionality of a program into independent, interchangeable parts, such that each contains everything necessary to execute only one aspect of the desired functionality.

The use of common modules 700 on the website 710 is enabled, such that there may exist one or more types of modules 720 for one or more purposes, actions, or functions. Common modules 700 illustrated in FIG. 7 represent a collection of modules 720 that are used frequently to perform certain actions or respond to specific triggers emitted by other modules. For example, a service requestor may navigate to the website 710 in order to utilize the search user interface (for example, clicking on a search box, typing a search term and pressing a button to conduct a search) which enables search functionality to be accessible on the website 710.

The website 710 enables self-service options that provide members with the ability to evaluate service providers (for example, search and filter service items), ensuring that both service providers and requestors have a dynamic opportunity to connect. To evaluate a service, a service requestor utilizes one or more common modules 700 within the website 710. Common modules 700 can include multiple types of events, triggers and related actions that may vary from other modules. For example, after a meeting has ended, a user may provide ratings privately or publicly to one or more meeting participants. The ability to provide ratings is only triggered after the meeting has ended, the type of event that activates the trigger may be classified as an “end of meeting” event and the set of actions that follow may include logging details related to the meeting, saving the recorded meeting to a database, enabling funds initiated from payment to be available, and releasing funds from an escrow upon completion of one or more ratings.

The website 710 contain specific collection of common modules 700 that are necessary for performing the basic set of operations required to connect service requestors with service providers. The common modules 700 include search, review, payment, escrow, schedule, meeting and ratings 720. The common modules 700 may be arranged in any order, connect to any other module, component, network, node, system, software, utility, database, processor, machine, device or collection of resources.

Within the common modules 700, performing a search provides a means for users and guests of the website 710 to receive listing information of related service listings and other relevant information. When a search is performed, the search request, initiated by the user of the website 710, is sent to a server, whereas the server is enabled to handle the search request with one or more routines, sub-routines, operations, triggers, actions and through one or more networks, databases, components and API services to fulfill the request. In the common modules 700, search is generally proceeded by a display of search results, that a user of the website 710 can click on to review a particular item from the search results.

Within the common modules 700, performing a review provides for users and guests of the website 710 to review information of related service listings and other relevant information. When a search listing or search result is presented, the user may navigate to an extended, detailed view of the related search item of interest on the website 710, whereas the search item being reviewed may contain one or more displays of information (for example, title, excerpt, headline, description, price, schedule, promotion details etc.), one or more media resources (for example, image(s), video(s), audio recording(s), interactive media(s) etc.), one or more attachments (for example, portable documents such as a PDF), and one or more actionable elements (for example, menus, buttons, dropdown lists, sliders, toggle buttons, accordions, links, etc.) and may be designed to support one or more formats (for example, website format, mobile format and others). In the common modules 700, review is generally proceeded by a display of service payment, that a user of the website 710, may configure after a review of the service item.

Within the common modules 700, processing a payment provides a means for users of the website 710 to purchase professional services from other users of the website. When a payment request is initiated, the payment details provided by the user of the website 710, is sent to a payment system (for example, a payment gateway, a payment processor, a payment facilitator, etc), whereas the payment system is enabled to handle the payment request with one or more routines, sub-routines, operations, triggers, actions and through one or more networks, databases, components and API services to fulfill the request. In the common modules 700, payment is generally proceeded by an escrow of the payment system, where funds received by the service requestor of the website 710 may be held and distributed proceeding a set of acceptable actions, triggers, operations, routines, sub-routines and processes.

Within the common modules 700, the escrow provides a means for payments made by a service requestor of website 710 to be held, evaluated and released to the designated service provider(s) proceeding a set of acceptable actions, triggers, operations, routines, sub-routines and processes. When a payment is processed, the payment details, transaction details, and related information is held, copied or transformed into an escrow of the website 710, held for a period of time, and released to one or more users (for example, a service provider received payment proceeding the end of a virtual meeting, a portion of funds held in escrow is converted to credit on the service requestors account, etc.). In the common modules 700, the escrow of funds from a payment system may be proceeded by a schedule of meeting time, that a user of the website 710 may configure to request a meeting with a particular user.

Within the common modules 700, configuration a schedule for services enables a service requestor of the website 710 to configure meeting details (for example, meeting date, time, duration) of the related service. When a service requestor completes the payment of service and payment information is kept in escrow, the service requestor of the website 710, is redirected to a flow that enables the schedule of the virtual meeting, whereas the schedule contains a scheduling component, meeting configuration options (for example, enable video, enable microphone, record meeting, etc.), notification options and others. Upon completion of the schedule, one or more routines, sub-routines, operations, triggers, actions and processes are enabled, modified, and transformed through one or more networks, databases, software, components and API services to fulfill the schedule of a meeting. In the common modules 700, schedule for services is generally proceeded by virtual meeting, that users of the website 710 are enabled to attend at the designated meeting date, time and duration.

Within the common modules 700, the meeting between users of the website 710 is enabled during a designated date, time and duration. When a meeting is conducted, the meeting participants of the website 710 has meeting specific options to enable during the meeting, whereas the meeting specific options may vary. For example, a meeting participant may enable video and microphone support, whereas a different meeting participant may disable video but enable the microphone support. The meeting may be configured for advanced functionality or third-party modules where meeting participants are enabled to include additional modules, components and applications into the meeting (for example, screen sharing is enabled). In the common modules 700, the meeting is generally proceeded by a rating, that users of the website 710 are enabled to complete.

Within the common modules 700, ratings give users of the website 710 the ability to provide feedback and endorse meeting participants of the related service. When a rating is conducted, the users of the website 710 users are enabled to provide feedback (for example, give a star rating, write a review of the experience), share their experience (for example, share or recommend the service or user to others), and endorse users (for example, service requestor tips the service provider, service provider gives a discount coupon for the next service booked, etc.). Upon completion of ratings, reviews, tips, discounts, sharing and others, the website 710, confirms the completion of the service lifecycle by releasing funds held in escrow to the appropriate users. The completion of the service lifecycle follows one or more routines, sub-routines, operations, triggers, actions, API requests and record keeping through one or more networks, databases, components, technologies, software, system, component, module and API services. It is appreciated that, although the common modules 700 illustrated in the diagram of FIG. 7 relate to a particular configuration, process, or otherwise, it is not limited to the illustration as other configurations, flows, modules and components may be used in a different arrangement, with varying modules and a multiplicity of connection, routines, sub-routines, operations, triggers, actions and processes.

FIG. 8 is a block diagram that demonstrations a service provider's service setup flow 800. The marketplace enables service providers with controls and features 810 that support listing services. Through an event driven paradigm, service requestors are enabled to select a date and time for services to be rendered (for example, using a calendar driven event scheduler) before, during and after a scheduled virtual conference session (for example, a virtual conference date and time can be extended in real-time) and services providers are enabled to create services that are available during specific dates and times. Services are oriented towards a specific collection of basic details that are required for searching, listing and procuring services on the professional services website, whereas a minimum set of required service details 820 may include a service title (for example, a one line description of the service), service description (for example, a detailed paragraph that describes the service and supported offerings) and an image (for example, an illustration or photograph of the service provider or service being offered). There may be additional features supported in the service details 820. For example, an image gallery containing one or more images of the service, a video or video gallery containing a video explanation of the service, a category and tags that assign searching classifications of the service, and others.

The services setup flow 800 in FIG. 8, illustrates an example set of controls and features 810 that a service provider can utilize when creating a service. In addition to service details 820, the service provider is enabled to enter other relevant attributes such as available time (for example, the available time frame for the service), available days (for example, the months, weeks and days that the service is available), price (for example, a single or range of prices for the service), allow bids (for example, whether to allow the service to be purchased through a bidding system or directly), terms details (for example, any terms that are relevant to the service provider for the service), and others.

Although it is not exclusively illustrated in FIG. 8, any number of features, collections, groups, sub-features, derivatives, parts, extensions and mutations may be used in any order of arrangement in the services setup flow. For example, a service provider can allow bids, which include one or more sub-features or derivatives. When a service provider allows bids, there may be certain bidding details 830 that provide a way for the service to contain a minimum price, maximum price and automatic bidding. In the bidding details 830, automatic bidding may be enabled to allow for a service requestor to automatically win a bid after low or no activity or to increase the bid amount automatically when another user bids. A service provider may enable bids or service procurement to support multiple payment options. A flexible procurement and payment service model which include use of components to facilitate transactions between service provider and service requestor through the use of a payment system (for example, credit card processor, PayPal®, Bitcoin, etc.) is enabled for bids and direct purchase of a service.

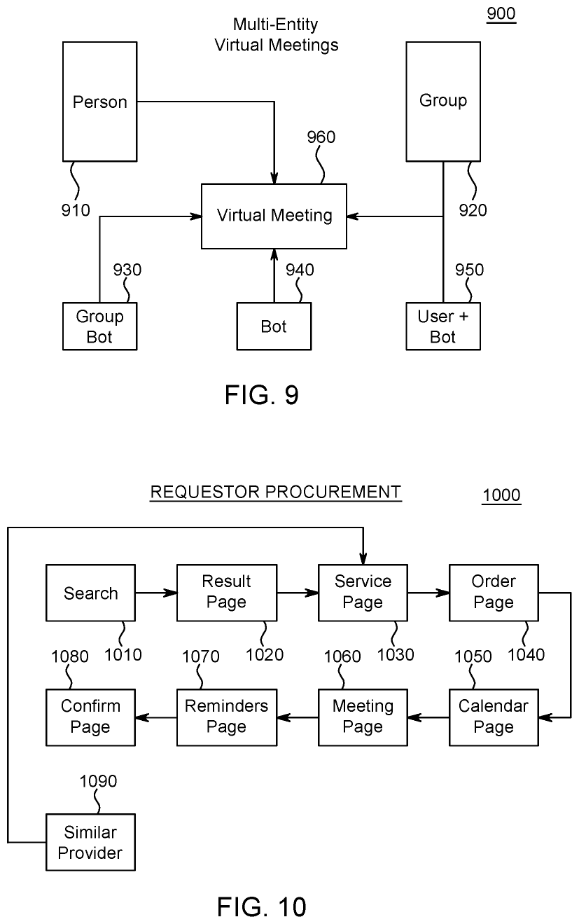

FIG. 9 is a block diagram that illustrates multi-entity virtual meetings 900 upon which examples described herein may be implemented. The marketplace enables meetings 960 between service providers and service requestors. By facilitating multiple communication modes (for example, collaboration, sharing, searching, messaging, responses via one or more applications including email, instant messaging, video, voice, services including communication services, devices including mobile, networks including internet, intranet and technologies including voice enabled, voice to text or text to voice, SMS, MMS, translation system), the professional services marketplace expands the availability and serviceability of service providers and their digital services. Additionally the marketplace makes use of components that enable members to engage in professional discussions (for example, tutoring, reviewing a contract, and/or commitment, providing customer support, reviewing an agreement, resolving an issue, developing an idea, prioritizing action items, reviewing documents, reviewing a virtual product, discussing technical details, business advising, conducting professional training, performing lectures, conducting seminars, etc.) through a multiplicity of services models (for example, question and answer service, searching service, analysis service, task service, research service, consulting service, business service, language service, career service, health service, matrimonial service, lifestyle service, information service, location specific services, fitness service, education and training service, sales and marketing service, idea formation service, product review service, entertainment service, tax service, assessment service, finance and stock service, mobile service, technical support service, advisory service, accounting service, event service, communication and support service).

A multi-tenant event-oriented service model may be used. The model may utilize peer-to-peer (for example, a person to person meeting), peer-to-group (for example, a person provides services to a team) and group-to-group (for example, two organizations attend an exposition) services between requestors and providers which expands the breath of serviceability and the multiplicity of service paradigms supported in a service marketplace. During a scheduled meeting 960 the meeting participants may join, host, interact and direct the meeting 960 under a range of entities (for example, types of users or meeting participants). For example, a person 910 can participate in a meeting discussion with another person 910, a group 920 can participate in a meeting with another group 920, or a bot 940 may participate in another meeting with another bot 940.

The marketplace supports a wide range of member classifications (for example, individuals, groups, commercial entities, governments, virtual entities, non-profit, automated bots) and expands the use of services to more than one group classification (for example, by sector, industry, category, type, discipline, segment, degree, and others) and includes multi-tenant usage (for example, groups of experts, anonymous users, multi AI agents, information service providers, contacts or connected users of personal or social networks, digital automated sources, online real time available matched users and subscribed and preference base matched service providers or searchers etc.). There may be one or more entities within a scheduled meeting 960 whereas, a user of an entity classification of person 910 can communicate with a user of an entity classification of group 920 (for example, a group having one or more users of one or more user types), a user of an entity classification of group 920 may participate with a user of an entity classification of person 910, or a user of an entity classification of bot 940 may communicate with a user of an entity classification of person 910 or with a user of an entity classification of group 910.

Intelligent agents (for example, computer bots) may be utilized with human-to-human, human-to-bot and bot-to-bot communication. A scheduled meeting 960 may include a collection of bots controlled by a group of users (for example, a chat bot, a survey bot, an advertisement bot, etc.) referred to as a group bot 930 and a user bot (for example, a person who activates and controls a bot). For example, the marketplace may contain components that enable users to utilize an auto-response bot in their inbox to answer frequently asked questions from other users who use bots to auto-request quotes for services. Within the context of a meeting 960, a group bot 930 and a user bot 950 may communicate or exchange relevant data to provide a group 920 or a person 910 with information relevant to the meeting 960. The scheduled meeting 960 session may contain any number meeting participants ranging from a person 910 or group 920 to a group bot 930 or a user bot 950.

A service delivery method may be utilized to use of meeting software to enable real-time, on-demand voice and video communication between service providers and service requestors. A scheduled meeting 960 may include pre-paid (for example, a meeting that is paid before it is scheduled) meetings and post-paid (for example, a meeting that is paid after it is scheduled) meetings by any entity classification including a person 910, a group 920, a group bot 930, a user bot 950 or a bot 940. Semi-automated intelligent agents (for example, a chat bot is configured by a user and deployed to a network) may be used where users of a network have the capability of communicating with other users with a semi-automated intelligent agent. Intelligent agents may be employed to assist with asking or answering questions (for example, one user has a list of questions and follow up questions that is communicated to another user in a chat session). A bot 940 may include or more software, system, application, component, module, and others to fulfill a particular function before, during and after one or more meeting 960 sessions. A user bot 950 may be enabled, activated, modified, disabled, deactivated, suspended, paused, added or removed by a person 910 during any duration of time of a meeting 960. A group bot 930 may be enabled, activated, modified, disabled, deactivated, suspended, paused, added or removed by a group 920 during any duration of time of a meeting 960.

FIG. 10 is a block diagram that illustrates a service requestor procurement flow 1000. The marketplace enables service requestors to procure services from a service provider through a communication-oriented services paradigm that enable placing information shared by a service provider, in real-time, as the measure of value within the marketplace without the need to place electronic output in the form of virtual goods as measure of value by producers of the marketplace. Electronic commerce makes use of computers that enable member profiling, listing, searching, messaging, payment processing, scheduling, virtual meeting, rating and reviewing technologies for a plurality of professional service providers and knowledge experts to engage their services in real-time. In the block diagram of FIG. 10, the concept of a page is used to denote any presentation or delivery of a collection, package, part, unit, fragment, or otherwise and may include components and modules (for example, a web page, a mobile page, an audio enabled page, a neural-data page, an IoT device page and others).

The marketplace contains a flexible procurement and payment service model paradigm where service requestors pay for services in advance of the service being performed. The illustration of FIG. 10 contain a simple process by which a service requestor may procure services where the issuance of payments to a service provider is contingent on the fulfillment of a service to a service requestor. The procurement of services by a service requestor may begin from a search 1010 action that is followed by a flow through pages which enable a service requestor to complete procurement. The discovery of professional services may be initiated with a search 1010, activated by a person or computer program (for example, a software may search for professional services through the use of an API or other software implementations).

Results of a search 1010 may be presented (for example, a computing device displays a graphical user interface GUI, an internet of things IoT device may present results through audio enabled interface AEI, a brain machine interface BMI may send brain signals to the brain, etc.) to a user through a result page 1020, whereas the result page 1020 may be presented on one or more types of interfaces (for example, a brain machine interface, graphical user interface, audio enabled interface, and others) proceeding a search 1010. The result page 1020 is set to present the user with one or more items related to the search 1010, whereas the search 1010 items may be related to one or more search 1010 words or phrases, whereas the result page 1020 is enabled to display relevant or derivative items. The items of a result page 1020 are enabled with features that give a user ways of retrieving more details related to the items (for example, a user may click on a hyperlink, a user may speak out the item name, a user may think of the item, and others). Details of the item are accessed by following through from the result page 1020 to the service page 1030.

The service page 1030 enables users to view details of the selected service item from the result page 1020 and perform actions (for example, send a message to the service provider, procure services, share service details, etc). There could be one or more actions performed on the service page and each action may trigger or enable a different flow or experience for the user. For example, following through an action to procure services can direct a user (for example, a service requestor) to the order page 1040. The service page 1030 may also be configured to restrict procurement of services (for example, if a service provider is no longer providing a service at a specific time frame), suspend procurement of services (for example, a service provider places services on a temporary hold due to personal matters), extend procurement of services (for example, a service provider extends service hours or duration of service), add or adjust service terms (for example, a service provider adds a disclaimer or terms of service) or support any range of services, functions, features, details, promotions, discounts and others.

The marketplace is enabled to facilitate financial transactions between service provider and service requestor through the use of a payment system (for example, credit card processor, PayPal®, Bitcoin, and others). Through the order page 1040, users are enabled to procure services (for example, paying for services, service add-ons, additional features, premium subscriptions, and others) whereas, one or more payment types (for example, Credit Card, Debit Card, Bitcoin, eCheck, Service Credit) may be used, one or more merchant service providers (for example, PayPal®, Venmo®, Stripe®, Amazon Pay®, Google Pay®, Apple Pay®, etc.) may be used, one or more payment terms (for example, one-time payment, partial payments, recurring payments, automatic payment, event-driven payment, etc.) may be used, one or more procurement model (for example, direct payment, auction payment, conditional payment, delayed payment, etc.) may be used and any payment type, payment term, merchant service provider, and procurement model may be used with any others. There are no specific arrangement or order by which the order page 1040 or any procurement enabled page, component or module may support procurement of services, as the unique functions, methods, services, processes, modes, features, modules and applications required for procuring services can vary. The marketplace makes use of components enabling a hybrid transactional model where services may be purchased directly or through a bidding system

Following the order page 1040, a service requestor may be directed to a calendar page 1050 which enables the use of scheduling modules (for example, using a date/time widget to set the start date/time of the virtual meeting), notification modules (for example, sending email, mobile and browser notifications prior to a virtual meeting) and other features. The calendar page 1050 may be enabled to with one or more features, modules, components or software programs that enhance, transform and improve the usability of the calendar page 1050. For example, the calendar page 1050 may include an API integration with third-party calendar applications (for example, Google Calendar, Calendly, etc.). There is no particular order, configuration or otherwise that determines the function of scheduling a virtual meeting on the calendar page 1050.

Upon completing of one or more actions on the calendar page 1050, a service requestor is enabled to enter the meeting page 1060. The meeting participants on the meeting page 1060 may include of any range of entities (for example, person, group, bot, group bot, user bot, etc.). The meeting page 1060 may use a module to conduct the meeting (for example, an embedded iframe that contain the meeting utility), a module to extend the meeting (for example, a web or mobile form with fields such as meeting time, meeting duration, payment button, etc.), a module to share digital documents and other digital resources, and others. The meeting page 1060 may use pre-configured settings (for example, a service provider sets the default meeting settings for the service) that can be modified at any time prior to and during a meeting. The service requestor and other meeting participants may also be enabled to modify options, controls, elements, fields and settings with acceptable permissions when available. After meeting participants configure their settings on the meeting page 1060, reminders and notification options are configured on the reminders page 1070 and confirm the configuration and meeting details on the confirm page 1080.

Although the confirm page 1080 completes the flow 1000 in the block diagram of FIG. 10, there may be additional pages enabled after the confirm page. For example, the service requestor may be enabled to view similar providers 1090 to diversify service options and maximize the potential value from multiple service providers. The marketplace may include additional pages that are presented before the confirm page 1080 and any other preceding page. The block diagram of FIG. 10 is merely one example of a potential requestor procurement flow 1000.

There may exist other arrangements or user experiences that differ from the block diagram of FIG. 10. For example, a service requestor may be directed from the calendar page 1050 to the reminders page 1070 and from the confirm page 1080 to the virtual meeting page 1060. There is no single flow, arrangement or preference for a service requestors journey through each page or through each module within each page, whereas the serviceability of a professional services marketplace may involve one or more variations and arrangements of pages, user flows, journeys, modules, components and others.

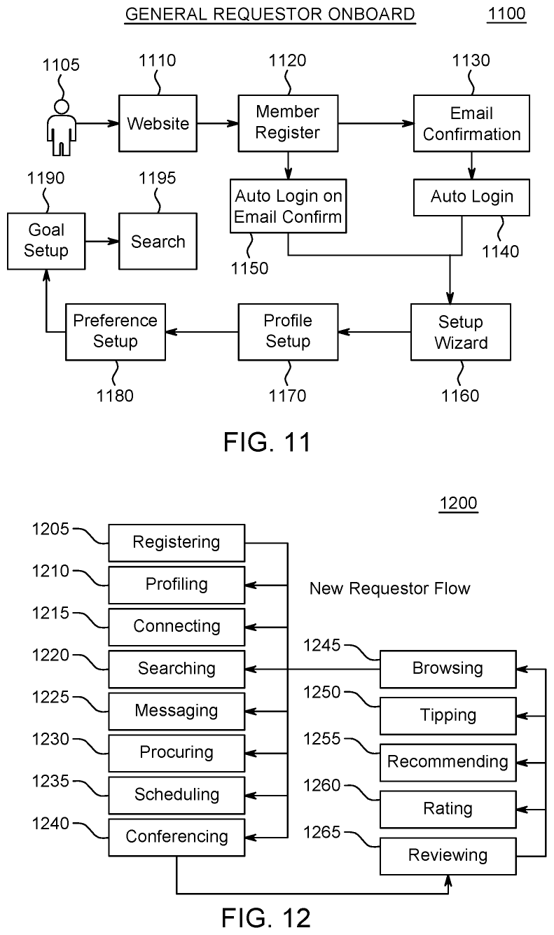

FIG. 11 is a block diagram 1100 that illustrates a general service requestor onboard process upon which examples described herein may be implemented. A service requestor 1105 via the marketplace website 1110 is focused on a number of pages and modules that support a number of functions (for example, account registration, identity authentication, profile and preferences setup and goals). When a service requestor 1105 decides to join the website 1110, the first step in the general onboarding process is to create an account on the member registration page 1120. Account creation may involve completing a registration that may contain one or more elements (for example, form fields for user name, email address, phone number, and others).

Following a completed registration, a service requestor may complete an electronic mail or email confirmation 1130. The email confirmation is designed to validate the service requestors email account and provides a hyperlink to automatically login or auto login 1140 to the website 1110. The electronic mail confirmation may also include other relevant information about the service requestors account that is necessary for email recovery such as a unique personal identifier number (PIN).

The service requestor 1105 may complete the email confirmation 1130 through the same computing device as the member registration page 1120 or a different device. The member registration page 1120 may be initiated from a personal computing device (for example, a laptop or desktop computer) and the email confirmation may be initiated from a mobile computing device (for example, a smart phone). In the case where the computing device used for a service requestor 1105 to register differs from the computing device where the service requestor confirms an email, the member registration page 1120 may be enabled to auto-login on email confirmation 1150. As an example, the website 1110 may receive a notification that the service requestor 1105 has completed the email confirmation 1130, the website 1110 may then communicate to the member registration page 1120 which is enabled to auto login 1140, whereas an auto login on email confirmation 1150 or an auto login 1140 from an external email client may direct the service requestor 1105 to the setup wizard page 1160.

The setup wizard page 1160 comprises of modules and components that guide the service requestor 1105 towards completing various social media and security-oriented preferences. For example, the service requestor 1105 may be directed from the setup wizard 1160 to the profile setup page 1170. The profile setup page 1170 may contain modules and components to complete social media related profile details (for example, linking social media accounts, setting a public username, uploading a profile photo, and others). The profile setup page 1170 may require service requestors 1105 who also provide services to validate professional credentials (for example, provide a link to their social profile, upload a resume, upload a certification) by using one or more validation softwares, modules or components. The profile setup page 1170 may also contain one or more modules for setting up the service requestor's 1105 profile. For example, the service requestor 1105 may include a biography about themselves or select topics that relate to their interests, whereas biography details may be retrieved through professional data aggregation from social networks (for example, importing a backup of your social profile from LinkedIn®, Facebook®, Twitter® and others) and other sites (for example, from a data services provider). The marketplace may enable members to engage in professional discussions (for example, tutoring, reviewing a contract, and/or commitment, providing customer support, reviewing an agreement, resolving an issue, developing an idea, prioritizing action items, reviewing documents, reviewing a virtual product, discussing technical details, business advising, conducting professional training, performing lectures, conducting seminars, etc.) using preferences that are pre-defined, system generated or user defined. After completing the profile setup page 1170, the service requestor can be enabled to navigate to the preference setup page 1180.

The preference setup page 1180 comprises of modules and components that support configuring specific preferences for the service requestor 1105 as part of the general requestor onboarding process. There may be one or more types of preferences from one or more module or component that is used on the preference setup page 1180. For example, a service requestor 1105 may configure preferences such as locale (for example, changing the primary language to English, Spanish or others), location (for example, setting the current location or a different location), search (for example, setting default search settings), email (for example, email notification settings), mobile sms (for example, text messaging settings), browser notification (for example, browser push notification and alerts) and application preferences (for example, selecting a dark theme, light theme or auto-adjusting by the time of day). The preference setup page 1180 may include other modules and components not mentioned in the examples given such as conference settings (for example, enable video and audio).

Following the preference setup page 1180 a service requestor 1105 may be enabled to perform other functions that are relevant to the general requestor onboarding process. For example, a service requestor 1105 may configure one or more goals in the goal setup page 1190, which create a context by which the services requestor may maximize the utility of the website 1110 over time. The goal setup page 1190 may include other workflows that are associated with other pages, modules or components. For example, the service requestor 1105 may be enabled to configure a goal related to completing the profile setup 1170, whereas the profile setup 1170 may be completed in part and later revisited. There may be other service oriented goals that the goal setup page 1190 may include in the form of a module or component. For example, the service requestor 1105 may set one or more goals related to understanding a particular topic, whereas the service requestor 1105 may then procure services from service providers who are relevant for a particular topic, whereas the service requestor 1105 may initiate the procurement process by conducting a search 1195 for services. Pre-procurement components may be utilized to enable communication between requestors and service providers using streams of information exchange through messaging capabilities and document sharing services (for example, a requestor sends a direct message, uploads a document and selects an allocation of time required for services).

FIG. 12 is a block diagram that illustrates a potential service requestor flow 1200 upon which examples described herein may be implemented. The marketplace supports facilitating multiple communication modes (for example, collaboration, sharing, searching, messaging, responses via one or more applications including email, instant messaging, video, voice, services including communication services, devices including mobile, networks including internet, intranet and technologies including voice enabled, voice to text or text to voice, SMS, MMS, translation system). A service requestor is enabled to perform specific actions on the professional services marketplace independently or with other members. For example, members are enabled to engage in professional discussions (for example, tutoring, reviewing a contract, and/or commitment, providing customer support, reviewing an agreement, resolving an issue, developing an idea, prioritizing action items, reviewing documents, reviewing a virtual product, discussing technical details, business advising, conducting professional training, performing lectures, conducting seminars, etc.), refer other members for an incentive (for example, referral commissions, account credits, service discounts, gift cards, etc.), upload digital artifacts (for example, a document) prior to the scheduled meeting (for example, a requestor uploads a tax document and a provider reviews the document prior to having a virtual meeting), and others.

In FIG. 11, a service requestor is enabled to complete the general requestor onboarding process which includes creating an account through pages and modules that enable registering 1205, updating profile details through pages and modules that enable profiling 1210 and linking social media accounts and setting notification preferences through pages and modules that enable connecting 1220. A new service requestor may be directed to a new requestor flow by searching 1220 for services, messaging 1225 a service provider about specific services, and procuring 1230 services. In some examples, procuring services may include messaging 1225 while in other examples, procuring 1230 services may not include messaging 1225. Messaging 1225 (for example, a service provider sending a message to a service requestor) may be configured by a service provider or may include default modules (for example, file uploader). A service requestor may be directed from procuring 1230 services to scheduling 1235 services and from scheduling 1235 services to attending a conferencing 1240 session with a service provider.

The scheduling 1235 of a meeting may exist prior to procuring 1230 services. For example, a service requestor may be directed to a page or module that displays a service providers current schedule, whereas the availability for services may vary based on pending service appointments and modifications to the calendar of the service provider. A service provider may restrict specific times and days on their calendar, which enables a service requestor to pre-select a date and time that is most appropriate prior to procuring services. The scheduling 1235 of conferencing 1240 sessions may exist after procuring 1230 services. For example, a service requestor is directed from messaging 1225 the service provider to procuring 1230 a service by the service provider, whereas the scheduling 1235 of a meeting is enabled after procuring 1230 (for example, a service provider pays for services first, then selects a date, time and duration of a meeting). The scheduling 1235 of a meeting may exist during a conferencing 1240 session. For example, during a conferencing 1240 session, a service requestor is enabled to extend the conferencing 1240 session (for example, a person may add 30 minutes of time to the meeting) with conditions (for example, extending the current session is contingent on the availability of time within the service providers calendar) or without conditions (for example, the service provider has an open schedule, is performing a live broadcast, is servicing a group, etc.).

Procuring 1230 services exists before, during and after a conferencing 1240 session. For example, a service requestor is enabled to repeat procuring 1230 of a service from a service provider of which the service requestor has completed a conferencing 1240 session. A service requestor may initiate procuring 1230 services from other service providers who provide similar services, and the service requestor is enabled to initiate the procuring 1230 of services by any service provider in the marketplace.

The term reviewing 1265 is descriptive of a single review, multiple review and varying types of review. A service provider and a service requestor may be enabled to initiate reviewing 1265 of the conferencing 1240 session while the conferencing 1240 session is active. For example, a service requestor may initiate reviewing 1265 of a service provider (for example, a review module is presented to a service requestor during the meeting) 15 minutes before the conferencing 1240 session ends. A service provider and a service requestor may initiate reviewing 1265 of the conferencing 1240 session after the conferencing 1240 session ends. For example, a service provider may initiate reviewing 1265 of a service requestor (for example, the service provider shares their experience with the service requestor privately) upon completion of a conferencing 1240 session. Reviewing 1265 a conferencing 1240 session may include one or more pages, modules (for example, a file uploader) or components that provide a dynamic set of options for service providers and service requestors. Reviewing 1265 may include any form of feedback, commentary, document, resource, digital artifact and others that provide both service provider and service requestor with information and insight. The professional services marketplace is enabled with software, applications, services, components, modules and pages that enable reviewing 1265 details to be cross-posted (for example, a review written on the professional services marketplace may be posted to Google, Yelp, etc.) across one or more websites. A service provider and a service requestor may be enabled to cross-post any information that is related to reviewing 1265, rating 1260 and recommending 1255. In one example, a service provider may cross-post a review (for example, a case study of a service requestor) to their website to populate their portfolio of successful conferencing 1240 sessions. In a second example, a service requestor may cross-post a review (for example, a summary of their experience with the service provider) to Yelp and Google.

A service provider and a service requestor may be enabled to initiate rating 1260 of the conferencing 1240 session in the same or similar order as reviewing 1265. The term rating 1260 is descriptive of a single rating, multiple ratings and varying types of rating. A rating 1260 may include pages, modules and components that provide a focused context (for example, a 5-star rating 1260 module provides a simple grading scale). A rating 1260 may be enabled during and after a conferencing 1240 session and may be cross-posted in the same or similar way as reviewing 1265 of a conferencing 1240 session. A rating 1260 module or component may contain one or more sets of grading scales (for example, multiple grading scales may be used for the overall rating 1260), one or more types of grading scales (for example, a 5-star rating 1260, a number range rating 1260, a Boolean rating 1260, a multi-select rating 1260, etc.) and one or more ratings 1260 categories (for example, a video quality rating 1260, professional services rating 1260, etc.). A rating 1260 and a review may be published privately or publicly on the marketplace and a service requestor may elect to allow service providers to publish a rating 1260 of their experience (for example a service provider requests a service provider to allow their ratings 1260 and review 1265 to be published on their website).

Social network-oriented components may be utilized to enable members within the marketplace to refer other members for an incentive (for example, referral commissions, account credits, service discounts, gift cards, etc.). The completion of a rating 1260 or reviewing 1265 may be followed by recommending 1255. A service requestor or a service provider may be enabled to recommend potentially viable connections for a variety of opportunities. For example, a service provider may recommend a service requestor by complimenting service providers (for example, a dating coach may recommend a nutritionist and a therapist). A service requestor may recommend a connection to a service provider (for example, a client recommends a friend to receive coaching). The act of recommending 1255 may exist internal and external of the marketplace, whereas recommending 1255 may occur between users within the marketplace website, with one or more users within the website and one or more users from external websites, and with personal or professional contacts from a contact book (for example, a contact list from a smartphone, contacts from a web or desktop application, a comma separated value or CSV file, and other file formats.) Recommending 1255 may be independent from the new requestor flow of FIG. 12, since any user of the professional services marketplace can recommend 1255 one or more users, contacts or connections from any system, application, document, or resource where contacts are stored. Recommending 1255 may also be performed through voice commands (for example, using an IoT device to continue recommending 1255), from thought (for example, using a brain computing interface to continue recommending 1255), through software (for example, desktop application, web application, mobile application, IoT application, and others) and through automated means (for example, a bot or automated software system may continue recommending 1255).

When conferencing 1240 ends, a service provider and a service requestor may be enabled to initiate 1250 tipping. In one example, a service requestor may tip 1250 a service provider (for example, initiate procuring 1230 in the form of a tip for a service well done). A tip, that acts as a demand-side incentive for service providers, may be a flat amount or a percentage of the total payment of the services procured 1230, whereas tipping 1250 is not required by a user in the marketplace, users are enabled to tip 1250 at any rate (for example, flat-rate or percentage of procured 1230 services) or currency (for example, cryptocurrency, fiat-currency, and others). In another example, a service provider may provide a discount 1250 (for example, account credit for use on a service requestor's next service order), whereas a discount 1250 acts as a supply-side incentive (for example, to attract repeat ordering of services) for service requestors by service providers. Tipping 1250 may include procuring 1230 and may include the use of one or more modules, components and computing systems.

Upon completion of conferencing 1240, reviewing 1265, rating 1260, recommending 1255 or tipping 1250, a user of the marketplace is enabled to initiate browsing 1245 of professional services. Browsing 1245, a term that denotes locating one or more services, can be done through a page, module or component or by searching 1220 for professional services. Browsing 1245, may also be associated to an action performed through voice commands (for example, using an IoT device to locate professional services), from thought (for example, using a brain computing interface to view service listing), through software (for example, desktop application, web application, mobile application, IoT application, and others) and through automated means (for example, a bot or automated software system can select services from a database, cache or digital repository).

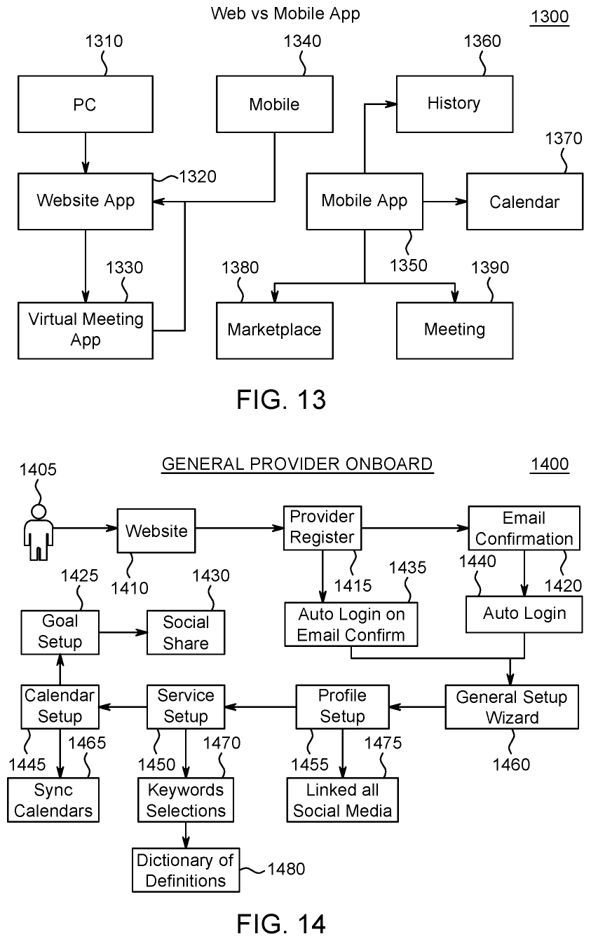

FIG. 13 is a block diagram that illustrates navigation and data flow 1300 for web and mobile applications. The website application 1320 may use of multiple device types (for example, desktop, mobile, audio-only, etc.) over one or more internet and digital networks. For example, the website application 1320 may be utilized from a personal computer (PC) 1310 or by a smart-phone (mobile) 1340. Both the website application 1320 and the mobile application 1350 may enable a virtual meeting application 1330 using software, modules and components that are specific to the device that the virtual meeting application 1330 is loaded from. Both the PC 1310 and the mobile 1340 may enable access to the website application 1320 through a browser (for example, a desktop browser on a PC 1310, mobile 1340 browser, mobile application 1350, audio browser on an IoT device, brain machine interface browser, and others).

The mobile application 1350 may keep a record of browsing through a history 1360 (for example, a local device storage of various logs of data). The history 1360 of a mobile application 1350 may include user experiences, application logs, device logs and others. The mobile application 1350 may be enabled to access the marketplace 1380 in online mode (for example, a connection to the internet is established), or offline mode (for example, a pre-fetched cache of the marketplace 1380 is stored in the mobile application 1350 memory). Although FIG. 13 illustrates the history 1360 of a mobile application, other applications may also be enabled with a history 1360. For example, the website application 1320 may include a history (for example, data is stored in a persistent local storage in the browser of the PC 1310).

The meeting application 1330 may exist within a mobile application 1350 or any other meeting 1390 applications (for example, brain machine interface meeting application). Users of the marketplace may access the marketplace 1380 or the website application 1320 through one or more devices (for example, PC 1310 or mobile 1340), one or more applications (for example, a mobile application 1350, an IoT application, a brain machine interface application and others). One or more networks, interfaces, protocols, connection types and data sources may connect to one or more devices or applications in the professional services marketplace. For example, a PC 1310 may use a cloud network to access the website application 1320 while a mobile 1340 may use a distributed network to access the website application 1320.

The mobile application 1350 may include a calendar 1370 module or component, or use other calendar 1370 modules or components that are accessible from outside the mobile application 1350 (for example, the mobile application 1350 may synchronize with another application on the mobile 1340 or PC 1310). The calendar 1370 module is one of many modules or software programs that may exist in the mobile application 1350, website application 1320 and other applications (for example, IoT application, brain machine interface application, audio application, etc.). Since the marketplace utilizes a service paradigm that enables profiling, listing, searching, messaging, procuring, scheduling, conferencing, translating, rating, recommending and referring professional services, other modules or components may be enabled through other device types. There are no limits to the number of modules, devices, applications and configuration, order, assembly, or arrangement of modules, devices or applications that can be used on the marketplace.

FIG. 14 is a block diagram that illustrates a general service provider onboard flow 1400 upon which examples described herein may be implemented. A service requestor 1405 is enabled to navigate to the marketplace website 1410, with a service provider enabled to initiate the provider registration 1415. The provider registration 1415 enables a service provider to create an account on the professional services marketplace website 1410.

Following a completed registration, a service provider 1405 may complete an email confirmation 1420. The email confirmation is designed to validate their service providers 1405 email account and provides a hyperlink to automatically login 1435 to the website 1410 on email confirmation 1420. The electronic mail confirmation may also include other relevant information about the service providers 1405 account that is necessary for email recovery such as a PIN.

The service provider 1405 may complete the email confirmation 1420 through the same computing device as the provider registration page 1415 or from an alternate device. The provider registration page 1415 may be initiated from a personal computing device (for example, a laptop or desktop computer) and the email confirmation may be initiated from a mobile computing device (for example, a smart phone). In the case where the computing device, used for a service provider 1405 to register, differs from the computing device where the service provider 1405 confirms an email, the provider registration page 1415 may be enabled to auto-login 1435 on email confirmation 1420. As an example, the website 1410 may receive a notification that the service provider 1405 has completed the email confirmation 1420, the website 1410 may communicate to the provider registration page 1415 which is enabled to auto login 1435 with an auto login on email confirmation 1435 or an auto login 1420 from an external email client to direct the service provider 1405 to the general setup wizard page 1460.

The general setup wizard page 1460 comprises of modules and components that guide the service provider towards completing various social media and security-oriented preferences. For example, the service provider 1405 can be directed from the general setup wizard 1460 to the profile setup 1455 page, whereas the profile setup 1455 page contain modules and components to complete social media related profile details (for example, linking social media accounts, setting a public username, uploading a profile photo, and others). The profile setup page 1455 may contain one or more modules for setting up the service providers 1405 profile. For example, the service provider may include a biography about themselves or select topics that relate to their interests. In another example, the profile setup 1455 may include a module that links all social media 1475 (for example, adding social networking profile links). After completing the profile setup 1455 page, the service provider 1405 can be enabled to navigate to the service setup 1450 page.

The service setup 1450 page includes modules and components that support configuring services for the service provider 1405 as part of the general provider onboarding process. There may be one or more types of services from one or more module or component that is used on the service setup 1450 page. For example, a service provider 1405 may configure services. The service setup 1450 page may include other modules and components that extend the service setup 1450. For example, a keywords selection 1470 module may be enabled in the service setup 1450 page that give the service provider 1405 a way to define specific definitions that relate to their industry, sector, or domain of expertise. Keyword selections 1470 may be stored in a dictionary of definitions 1480 where guests and users of the marketplace website 1410 are enabled to discover a service provider 1405 through keywords from the keyword selection 1470 or dictionary of definitions 1480.

The service setup 1450 is followed by a calendar setup 1445 page where a service provider 1405 configures availability (for example, selecting dates and times for that service). A calendar setup 1445 may include other components and modules that enable a service provider 1405 to perform other scheduling functions. For example, a service provider 1405 may synchronize calendars 1465 from another calendar application by importing or transferring calendar data through the use of a data integration software, component or module. Following the calendar setup 1445, the service provider 1405 may be directed to the goal setup 1425 page where the service provider 1405 is enabled to set goals (for example, set financial goals, service requestor acquisition goals, visitor count goals and others). Upon completion of the goal setup 1425 page, the service provider 1405 may be directed to the social share 097 page. The service provider 1405 may share service with a social network of choice.

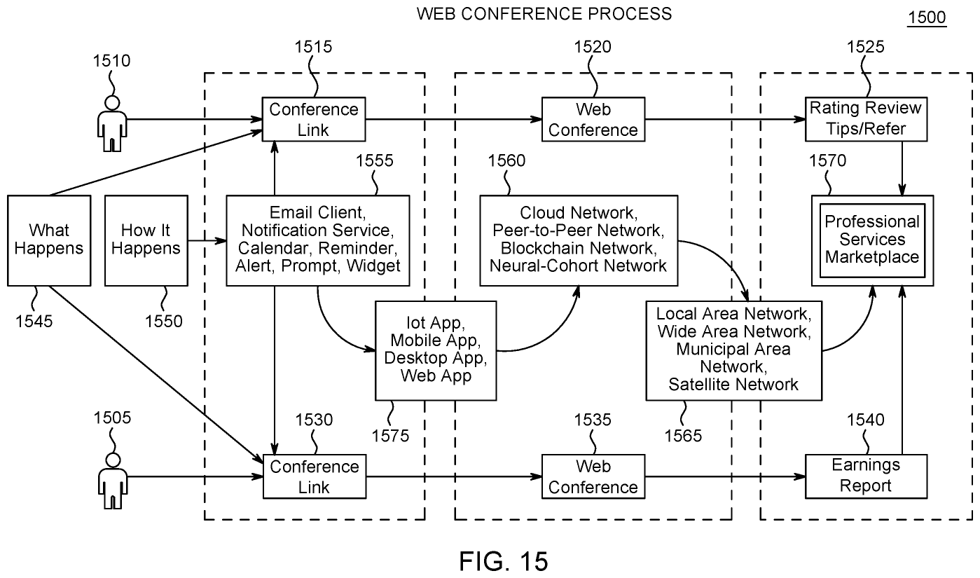

FIG. 15 is a block diagram that illustrates a web conference process 1500. In an example, the block diagram illustrates the flow 1500 of what happens 1545 to enable users to communicate via a conference and the process demonstrating how it happens 1550 by which users access each part of the flow 1500. Two or more users of the marketplace, at least one service provider 1405 from the block diagram of FIG. 14 and at least one service requestor 1510 have scheduled a meeting. For a service requestor 1510, the scheduled web conference 1520 is accessed through a conference link 1515. For a service provider, the web conference 1535 is accessed through a conference link 1530. The conference link 1515 of the service requestor 1510 and the conference link 1530 of the service provider may be accessed using one or more application sources 1555 such as an email client (for example, desktop email application, mobile email application, and others), notification service, calendar, reminder, alert, prompt or widget. The application sources 1555 utilize some form of device level application 1575 such as an IoT Application, mobile application, desktop application or web application.

There may be other device level applications 1575 used to access one or more application sources 1555 such as a brain machine interface application, audio enabled application and others. Each device level application 1575 uses one or more data networks 1560, such as a cloud network, peer-to-peer network, blockchain network and neural-cohort network to access, transmit, transform, compile, convert, produce, consume, manage, secure, and utilize data of varying types, categories, classifications, structures, encodings, formats, sizes, fragments, groups, or parts. Each data network 1560 may connect using one or more data connectivity networks 1565 such as a local area network or LAN, a wide area network or WAN, a municipal area network or a satellite network.

With each data connectivity network 1565, the marketplace website 1570 enables users, namely service providers 1405 and service requestors 1510 to communicate. A service requestor 1510 who uses a conference link 1515 to access a web conference 1520 may provide feedback and support 1525 to a service provider 1405 in the form of one or more modules such as a rating, review, tips or referral. A service provider 1405 who uses a conference link 1530 to access a web conference 1535 may provide feedback and view an earnings report 1540 detailing the earnings produced from a completed service.

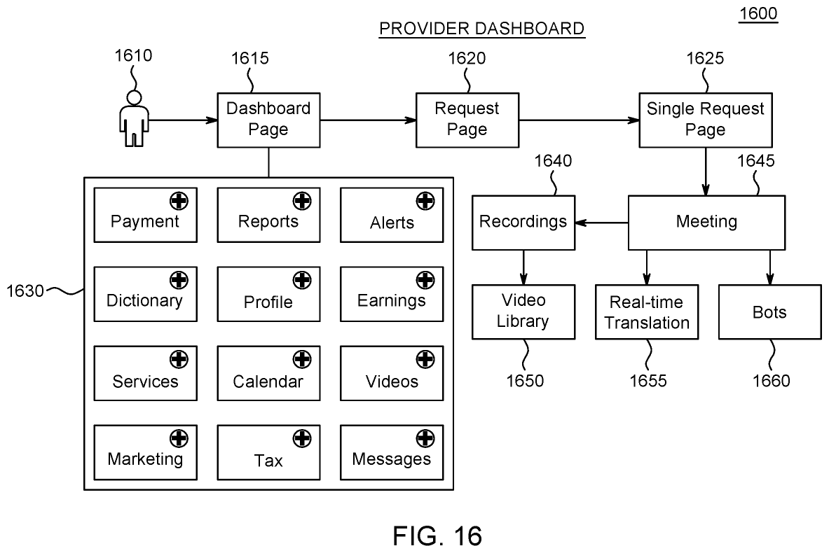

FIG. 16 is a block diagram that illustrates a service provider dashboard 1600 upon which examples described herein may be implemented. The marketplace website enables service providers 1610 to view, configure, customize, setup, add, modify, delete, create and use modules and components through a dashboard page 1615. The service provider 1610 may access one or more modules 1630, each module 1630 containing at least one option for configuring, modifying or adjusting settings, and each module 1630 having specific properties, states and meta data. Modules 1630 may be related to payment, reporting, alerts, dictionary (for example, a definition of service specific terms created by the service provider 1610), profile, earnings, services, calendar, videos, marketing, tax and messages. The dashboard page 1615 may include other modules 1630 not illustrated in the block diagram of FIG. 16.

A service provider 1610 is additionally enabled to access a requests page 1620 for which all service requests may be accessed. The requests page 1620 enables a service provider 1610 to view individual service requests on a single request page 1625 that contain details related to the service request (for example, date and time, duration, messages, uploads, requestor details and others). The single request page 1625 may be configured or modified prior to a meeting 1645, whereas the service provider 1610 is enabled to set default options for each service request. The single request page 1625 may include a link to access the meeting 1645 room where one or more functions, actions, modifications, services, software, components or modules may be enabled. For example, the meeting 1645 may include bots 1660 that assist the service provider with gathering polling or moderating the discussion. Bots 1660 in a meeting 1645 may perform a number of functions, operations, or routines with a given set of instructions, using artificial intelligence, or a combination of managed, unmanaged, semi-managed artificial intelligence. In addition, bots 1660 may be used for gathering information, reporting information, revenue generation, education or entertainment purposes. A service provider 1610 may be enabled to configure bots for each request made available in the single request page 1625. Configurations may include enabling, disabling, adding, removing, modifying, updating, replacing, updating, or suppressing bots 1660.

The meeting 1645 may be enabled with recordings 1655 which may be accessed by the service provider 1610 and used for any number of reasons. For example, a service provider 1610 may offer video recordings 1655 as digital assets for paid subscribers who access the video recordings 1655 for education or entertainment purposes through a video library 1650. The digital assets produced from video recordings is optional since electronic output in the form of virtual goods or virtual output is not the measure of value by producers of the marketplace. The marketplace may not limit service providers to producing digital goods or be bound to a single service classification (for example, educators). The meeting 1645 may include real-time translation 1655 of the meeting 1645. The service provider 1610 may configure settings for real-time translations 1655 for one or more service requests. Realtime translation 1655 may be performed after the upload of digital artifacts (for example, a document) prior to the scheduled meeting (for example, a requestor message is translated) and during a virtual meeting (for example, a text-to-speech and speech-to-text engine is enabled).

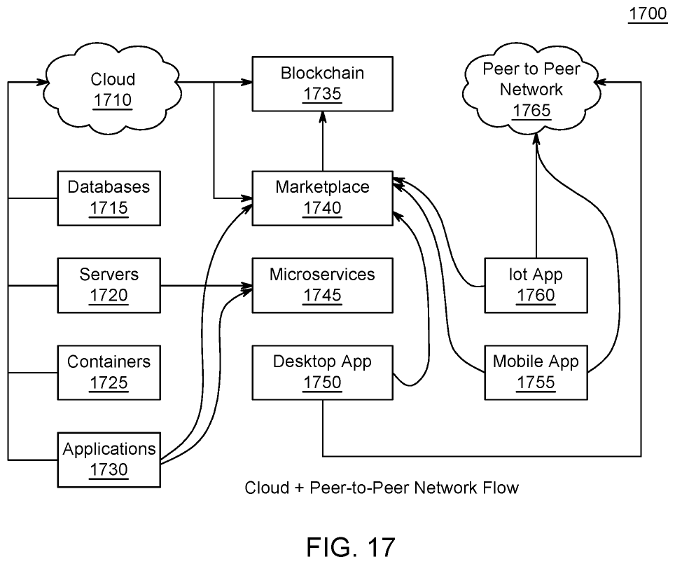

FIG. 17 is a block diagram that illustrates a cloud and peer-to-peer network flow 1700. The marketplace may use a hybrid centralized, distributed and peer-to-peer network architecture which include: a centralized service architecture that is enabled as the primary means of facilitating services but is not limited to a particular network paradigm; services that may be enabled via peer-to-peer networking, decentralized networking or through a centralized network architecture; components that facilitate hybrid services by intermediation in a centralized, distributed (for example, using a blockchain), or peer-to-peer network architecture; virtual meeting services that may be centralized or distributed across one or more computing networks; the use of multiple network oriented arrangements or communication protocols including peer-to-peer, distributed, cloud and neural networks (for example, communication between one or more neural-cohorts through a brain computing interface); and a computer network, network service, application, messaging service, platform, computing system and network devices. Multiple device types (for example, desktop, mobile, audio-only, etc.) may be used over one or more internet and digital networks.

Data from the marketplace 1740 may be sent and receive through a number of computing networks. In the illustration of FIG. 17, the cloud 1710 can be used to run the marketplace through databases 1715 (for example, a cloud data storage application keeps record of relational data), servers 1720 (for example, virtual machines that contain the execution environment), containers 1725 (for example, a collection of virtual machines, packaged with only the required resources) and other cloud applications 1730. For example, notifications can be scheduled through one or more notification services that run on one or more cloud applications 1730 that communicate to one or more devices (for example, phone, email, sms, IoT device, brain computing interface, virtual reality device, etc.). The use of servers 1720 in the cloud 1710 may extend to operations that require one or more microservices 1745. For example, when a user schedules a virtual meeting, the professional services marketplace 1740 may utilize microservices 1745 to validate the request against a procurement module.

The cloud 1710 may be enabled to connect to a blockchain network 1735 (for example, for retrieving immutable records of service-oriented transactions) prior to connecting to the marketplace 1740. A connection to the professional services marketplace 1740 may exist through device level applications, such as an IoT application 1760, mobile application 1755 or desktop application 1750 where one or more networks may be utilized. The peer-to-peer network 1765 enables two or more systems (for example, a desktop computer, mobile phone, IoT application and others) to connect, transport, synchronize, initialize, compute, fragment and encrypt data between systems across multiple devices. For example, an IoT application 1760 may connect to the peer-to-peer network 1765 to transport sensitive documents between a service requestor and service provider without accessing the professional services marketplace directly. Any person, group, entity or computer program may access the peer-to-peer network from any number of devices such as a desktop application 1750, mobile application 1755, or IoT application 1760.

Although the illustration of FIG. 17 presents the use of three device level applications, other device level applications may be used. For example, a brain machine interface device may utilize an application that communicates to one or more networks, each having an association, connection, or affiliation to the marketplace 1740, whereas at least one network connects with an application to access the marketplace 1740.

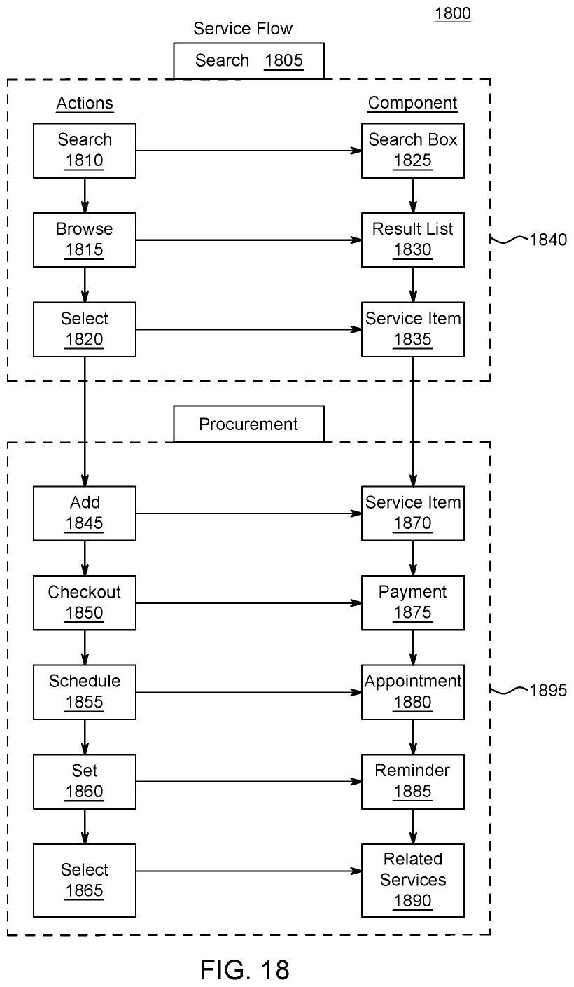

FIG. 18 is a block diagram that illustrates a service flow 1800 from search 1805 to procurement 1897 of services. Real-time on-demand service delivery may be utilized supported by on-demand communication where value exchange is produced through pre-paid, scheduled meetings. Through a communication-oriented services paradigm, information shared by a service provider, in real-time, is placed as the measure of value within the marketplace without the need to place electronic output in the form of goods as measure of value by producers of the marketplace. Additionally, professional services are retained by service requestors on the marketplace through multiple means but are primarily acquired by first conducting a search 1805. When a service requestor begins a search 1805 (for example, typing a search term in a text field and pressing a button to initiate the search), their action imitates the search 1805, which includes the actions and components related to the search 1805. For example, the search 1805 action may include a search box 1825 component that enables a search of a particular thing. Upon retrieval of the data related to the particular thing being searched 1810, the user or guest is directed to browse 1815 the collection of results in a result list 1830. From the result list 1830, the user or guest is directed to select 1820 a service item 1835 and begin the procurement 1897 of the service selected 1820 from the service item 1835.

The marketplaces may contain a flexible procurement and payment service model paradigm where service requestors pay for services in advance of the service being performed. The procurement 1897 of the services selected 1820 from the service item 1835 that the user searched 1810 includes actions and components related to the procurement 1897 of services. When a service item 1835, selected 1820 from a search result list 1830, is added 1845, the service item added 1870 may contain the required details (for example, data about the service, options selected, and others) to begin the checkout 1850 process. The checkout 1850 process may direct users to modules and components to facilitate financial transactions between service provider and service requestor through the use of a payment 1875 system (for example, credit card processor, PayPal), Bitcoin, etc); The payment 1875 system may enable a service requestor to complete payment 1875 for services. Upon a successful payment 1875 for services, the service requestor may be directed to schedule 1855 a meeting appointment 1880, set 1860 one or more reminders 1885 and notifications about the meeting, and select 1865 any related service 1890 on the marketplace.

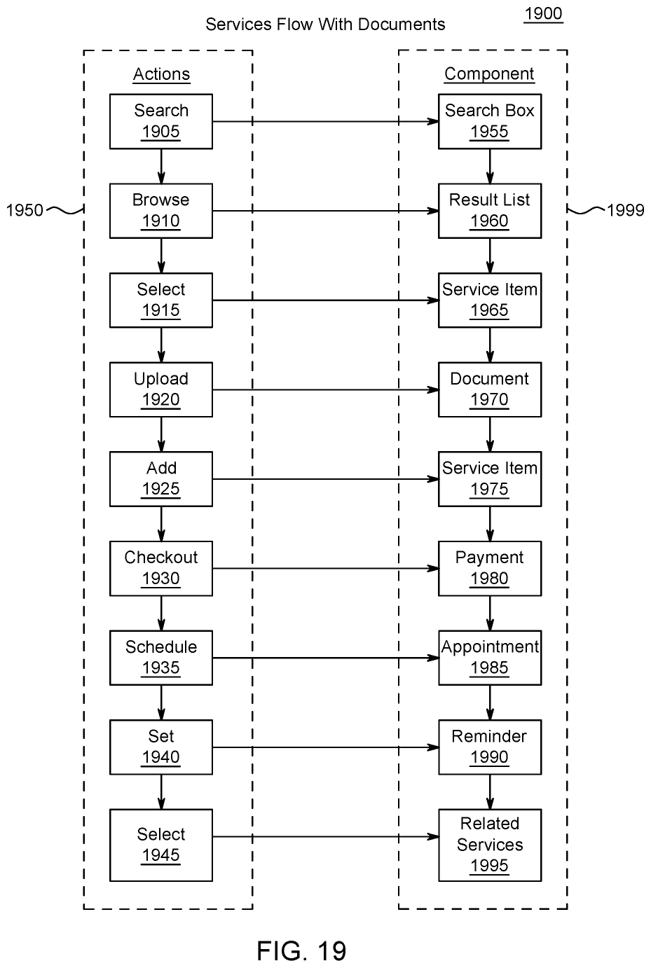

FIG. 19 is a block diagram that illustrates the actions and components of a services flow 1900 with documents upon which examples described herein may be implemented. An action represents the doing of a thing. A component is a representation of something. When a service requestor begins a search 1905 by typing a search keyword or term in the search box 1955, the service requestor is enabled to browse 1910 the search result list 1960. The search result list 1960 enables a service requestor to select 1915 a service item 1965 from the search result list 1960. The service requestor may continue browsing 1910, searching 1905, or is enabled to select 1915 a service item 1965.

When a professional service is discovered or searched 1905, a service requestor is enabled to communicate to a service provider prior to procuring the service. The action of selecting 1915 a service item 1965 may enable a service requestor to write a message and upload 1920 a document 1970 prior to procuring the service. Although the method do not place uploaded documents as a type of conversation exclusively, the use of uploaded documents within a conversation is relevant for the purposes of improving the breath of information required within the context of the communication. There may be one or more components, modules or pages that are enabled through actions performed by users of the professional services marketplace. By way of example, FIG. 19 represents one of the many actions and components that users of the professional marketplace are enabled to utilize.

The marketplace makes use of social network-oriented components that enable members to engage in professional discussions. There may be components that enable service requestors to upload digital artifacts (for example, a document) prior to the scheduled meeting (for example, a requestor uploads a tax document and a provider reviews the document prior to having a virtual meeting). For example, pre-procurement components that enable communication between requestors and service providers using streams of information exchange through messaging capabilities and document sharing services (for example, a requestor sends a direct message, uploads 1920 a document 1970 and selects an allocation of time required for services) may be used by a service requestor after selecting 1915 a service item 1965. The document 1970 sharing service may additionally contain a document 1970 upload 1920 components that check uploaded 1920 documents 1970 for malicious spyware or viruses and validates that the document may be viewed on the screen by checking the file type (for example, a document 166 format such as PDF, JPG, PNG, etc.). When a service requestor uploads 1920 a document 1970, the document sharing service may perform one or more operations prior to confirming the document is safe. Upon a confirmation, the service requestor is enabled to then add 1925 the service item 1975 to the shopping cart and checkout 1930 by fulfilling payment 1980 of the service item. Upon a successful payment 1980, the service requestor may set a scheduled 1935 appointment 1985 which consists of a date, time and other attributes. The service requestor is enabled to also set 1940 a reminder 1990 for the service appointment 1985 or select 1945 other related services 1995 from the marketplace.

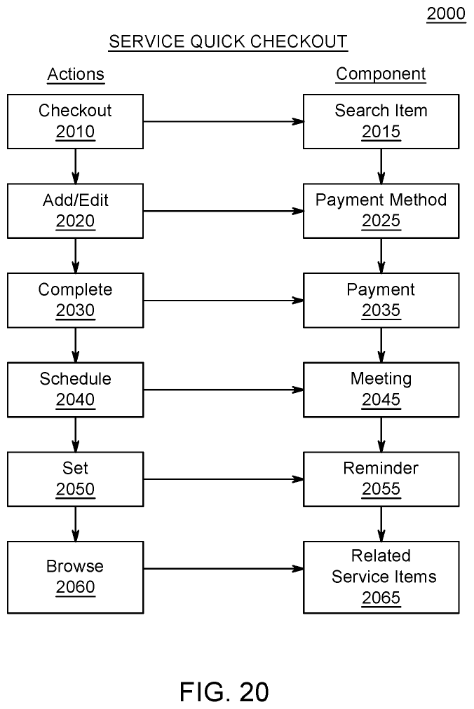

FIG. 20 is a block diagram that illustrates the actions and components of a quick checkout of services 2000 upon which examples described herein may be implemented. Similar to the illustration in FIG. 19, the use of actions and components are presented in FIG. 20. A service quick checkout process 2000 includes actions and components that expedite the process of procuring and scheduling meetings.

When a service requestor initiates a checkout 2010 of a service item 2015, the service requestor is enabled to add or edit 2020 the payment method 2025 prior to completing 2030 the payment 2035 of a service item 2015. The payment method 2025 of a service item 2015 may be one or more mode or forms of payment 2035. For example a payment method 2035 may be enabled in the form of an electronic check or eCheck, automated clearing house or ACH, bank wire transfer, store credit (for example, existing credit from the users account balance), bank card (for example, debit card or a credit card), mobile app transfer (for example, a payment 2035 transfer from apps like Venmo, ZellePay, QuickPay, CashApp and others), or web app transfer (for example, from PayPal or MetaMask).

The payment 2035 of a service item 2015 may be one or more types, classification, currency, partials or fragments. For example, a type of payment 2035 may be a website payment 2035 (for example, a payment 2035 made through a website), mobile payment 2035 (for example, a payment 2035 made through a mobile application), an IoT payment 2035 (for example, a payment 2035 made through an IoT device application) and others. Additional types of payment 2035 may be used such as a single payment 2035 (for example, a payment made from a single payment method 2025), fragment payment 2035 (for example, a payment 2035 made using multiple payment methods 2025), partial payment 2035 (for example, a portion of a payment made using a single payment method 2025) and others. There may be other mode, forms, types, partials or fragments used that are not explicitly stated in the examples and newer mode, forms, types, partials or fragments may be derived from the examples in one or more combinations, arrangements, orders, inclusions or exclusions.

A classification of a payment 2035 may be an individual payment 2035 (for example, a payment 2035 made by a person), business payment 2035 (for example, a payment 2035 made by a business entity such as a Corporation, LLC, and others), government payment 2035 (for example, a payment 2035 made by a government entity), and others. A payment 2035 currency may be a website currency (for example, a currency that is only used on the website), digital currency (for example, digital money, electronic money or electronic currency used between websites and applications), cryptocurrency (for example, individual coin ownership records are stored in a ledger), fiat currency (for example, currency used in a country), asset-backed currency (for example, a currency backed by an asset or commodity) and others. There can be other classifications or currencies used that are not explicitly stated in the examples and newer classifications or currencies may be derived from the examples in one or more combinations, arrangements, orders, inclusions or exclusions.

The payment 2035 of a service item 2015 may be set by one or more occurrences, frequencies, or conditions. For example, a payment 2035 may be set as a single occurrence payment 2035 (for example, a payment made once), multiple occurrence payment 2035 (for example, a payment 2035 made multiple times) and others. A payment 2035 may be set by one or more frequencies such as every week, every month, every year, every other week, twice a month, and others. A payment 2035 may be set by one or more conditions such as when a service duration is exceeded, when a threshold of an account balance is exceeded, after a payment 2035 method is added or updated, when a previous payment 2035 was declined, when a specific day in the month is current, when a service requestor approves an offer, and other conditions. There may be other occurrences, frequencies, or conditions used that are not explicitly stated in the examples and newer occurrences, frequencies, or conditions may be derived from the examples in one or more combinations, arrangements, orders, inclusions or exclusions. Upon a successful payment 2035, the service requestor may set a scheduled 2040 a meeting 2045. The service requestor is enabled to also set 2050 a reminder 2055 for the meeting 2045 or browser 2060 other related services teams 2065 from the marketplace.

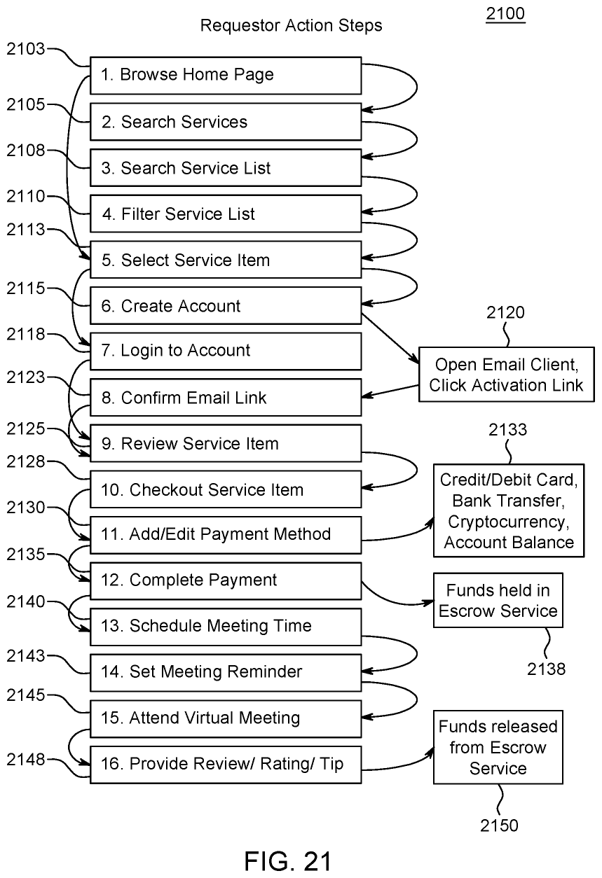

FIG. 21 is a block diagram that illustrates service requestor action steps 2100 according to some examples described herein. A service requestor is enabled to perform one or more steps that allow for services to be procured and meetings to be scheduled on the marketplace. A service requestor may browse the home page 2103 of the marketplace to identify categories, tags, topics, popular, recent, or highly rated services to evaluate. While browsing the home page 2103 or any other page, the service requestor may search for services 2105 using one or more search modules, components of features that are available for the specific application that the service requestor is using to access the marketplace. There can also be different search functions (for example, search utilities, software or computer code), inputs (for example, audio input from an IoT application or textual input from a website application) and outputs (for example, a graphical user interface, an audio output, and others) used on the professional services marketplace. For example, a service provider may search for services 2105 using voice commands and listen to a voice service which reads the search service list 2108 of items from an IoT device (for example, an Alexa enabled echo device). The service requestor is enabled to filter the service list 2110 by one or more filtering options (for example, filter by editors pick, popularity, most relevant, most recent, ratings, and others) and is enabled to select a service item 2113 of interest.

A service requestor who is not registered on the marketplace is enabled to create an account 2115 that initiates an activation link 2120 being sent to the service requestor by email, sms or other means. The service requisition may confirm the email link 2123 and login to account 2115 after successfully creating an account 2115 and confirming the email link 2123. There may be additional verification requirements set when creating an account 2115 or confirming an email link 2123 (for example, a captcha or verification module may be used periodically). After creating an account 2115, a service requestor is enabled to login to the account 2118 and review the service item 2125 or select a service item 2113 for review. Reviewing a service item 2125 may include reading or listening to the selected service item 2113 details (for example, title, description, price, duration and others). The service requestor may checkout the service item 2128, which may include adding or editing a payment method 2130, selecting a payment method 2133 (for example, selecting a credit card, debit card, bank transfer, cryptocurrency or account balance) and completing payment 2135 by clicking on a submit button, verbally confirming a payment for processing, or thinking about completing payment 2135 (for example, using a brain machine interface device to control a software application).

The marketplace may utilize components and modules that bind transactions to the deliverability of services between a service provider and a service requestor (for example, payments to service providers are held in escrow and released after the date and time of the scheduled service). When a service requestor finalizes the act of completing payment 2135, the marketplace website activates an escrow service 2138 to hold the funds and the service requestor is directed to schedule a meeting time 2140 with the service provider. The service requestor may set a meeting reminder 2143 prior to attending the meeting 2145 or extend the duration of the meeting when scheduling the meeting time 2140. When attending a meeting 2145 the service requestor may modify the scheduled meeting time by extending the duration of time for the meeting. After attending a meeting 2145, a service requestor is enabled to provide a review, rating and tip 2148 to a service provider. When all or some actions are completed, including one or more actions of providing a review, rating, tip, referral and others, the website activates an escrow service 2150 to release funds to the service provider.

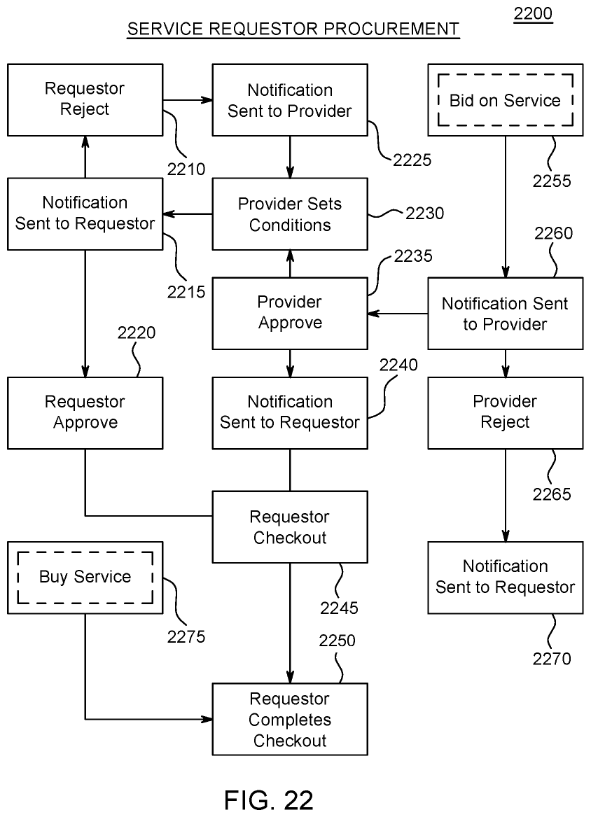

FIG. 22 is a block diagram that illustrates a service requestor procurement 2200 upon which examples described herein may be implemented. The marketplace enables service requestors to bid on services 2255 or buy services 23655 directly. Using a hybrid transactional model, professional services may be purchased directly or through a bidding system that supports multi-faceted bidding options (for example, bidding based on on-time, off-time, service terms, etc.) where a service requestor is enabled to bid or negotiate price and service availability directly with a service provider if a service provider determines that the service may be available for bids. Other components for bidding not based on a frequency or duration of time remaining since services are bound to service availability may be used. When a service requestor places a bid on services 2255, the minimum price for the service increases. Placing a bid on a service may be prevalent during times where a service is highly requested (for example, a popular dating coach has a limited availability for coaching and enables bids for a specific timeframe). When a service requestor places a bid on a service 2255 the marketplace website sets a notification to be sent to a service provider 2260.

When a notification is sent to a provider 2260, the service provider may reject 2265 the bid. A service provider rejection 2265 may activate a provider rejection notification 215 to be sent to the service requestor. Notifications can be alerts, popups, message boxes, text messages, or any software application, component or module that relays a brief status during a specific period of time (for example, a push notification, alert, dialog, confirmation, slide out box, popup box and others from a web browser application, desktop application, mobile application, smart watch application, IoT application or brain machine interface BMI application).

When a provider approves 2235 a bid on a service 2255, there are two actions that may lead to procurement of services. A notification is sent to a requestor 2240 expressing the approval, or the service provider sets conditions 2230 that the service requestor approves prior to procuring services. Upon a provider approval 2235, a requestor notification 2240 is sent with a call-to-action (for example, a button, link, audio response or others that direct a user to a different experience such as a different view, visual presentation, an audio confirmation, and others) allowing a requestor to checkout 2245 and complete payment 2250 of services.

A service provider is enabled to set conditions 2230, which activates a conditional requestor notification 2215. A service requestor may reject the request 2210. Upon rejecting a request 2210, a rejection provider notification 2225 is sent to the service provider. Rejecting a request 2210 based on provider set conditions 2230 enables a service provider to modify conditions 2230 according to the service requestors rejection 2210. A service requestor rejection 2210 may include a message that details the rejection, a counter-offer with pricing and conditions, or simply a rejection without a message, counter offer with pricing or conditions. If a service requestor approves 2220, a condition 2230 set by a service provider from an approved 2235 bid on services 2255, the service requestor may checkout 2245 and complete payment 2250 of services.

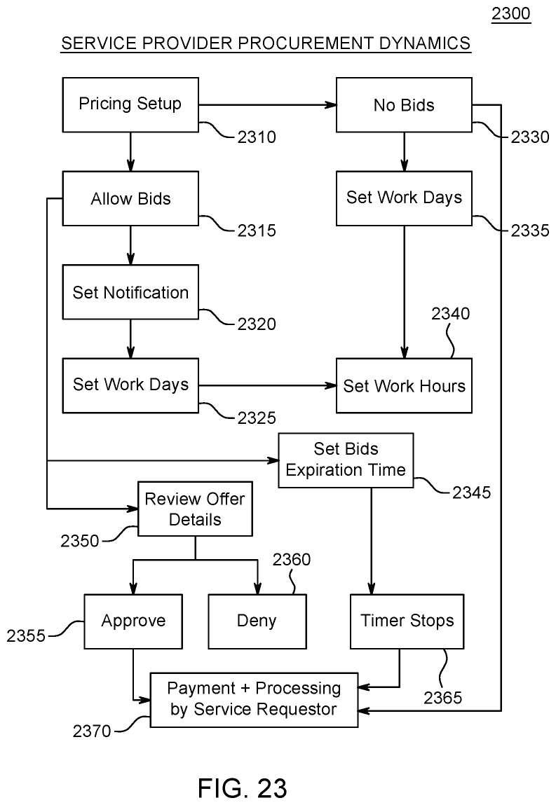

FIG. 23 is a block diagram that illustrates a service provider procurement dynamic 2300 according to some examples described herein. The marketplace enables service providers with pages, modules and components for creating services, procuring services and setting service details. One important aspect of a professional service is pricing. In FIG. 23, the block diagram illustrates a pricing setup 2310 where the procurement of professional services can be initiated. A pricing setup 2310 involves one or more steps, processes or configurations that enable service providers to customize how services are procured.

From the pricing setup 2310, a service provider may set a particular service to contain no bids 2330 (for example, a service requestor procures for services directly without a change in the base price of the service). When no bids 2330 is set, the service provider is enabled to set work days 2335, whereas any date, day, week, month or year may be customized. The service provider may be enabled to set work hours 2340, whereas any minute, hour, or range of minutes and hours may be configured. A service that includes no bids 2330 proceeds to the payment and processing 2370 flow.

The pricing setup 2310 may contain components, modules and features for allowing bids 2315. A service may be procured through a bidding system or bidding features with bidding enabling a service to contain an alternate base price over a course of time (for example, a service requestor can place a bid on a service during peak hours). When a service provider allows bids 2315, the service provider may set notification 2320 preferences that alert a service provider of bidding activity. In addition to setting notifications 2320, the service provider may be enabled to set work days 2325, whereas any date, day, week, month or year can be customized. The service provider may be enabled to set work hours 2340, whereas any minute, hour, or range of minutes and hours may be configured.

The marketplace makes use of components that enable service providers with options to allow bidding of services where service requestors may accept, deny or negotiate terms of a bid. Service providers may be enabled to allow bids on all or specific services based on one or more conditions (for example, availability of services, specific date condition, and others). When a service provider allows bids 2315, the service provider may be enabled to set a bid expiration time 2345 (for example, a bid may last for one hour, until the end-of-day, or after a threshold is met). Setting a bid expiration time 2345 enables a time-based module to track bidding activity and when the timer stops 2365, a service requestor may procure services with payment and processing 2370. Allowing bids 2315 may enable a service provider to review offer details 2350 from a service requestor (for example, a service requestor send a request for services with an associated bidding price added to the request). The service provider may review offer details 2350, approve 2355 or deny 2360 the offer. An approved 2355 offer may enable a service requestor to proceed with payment and processing 2370 of the service order.

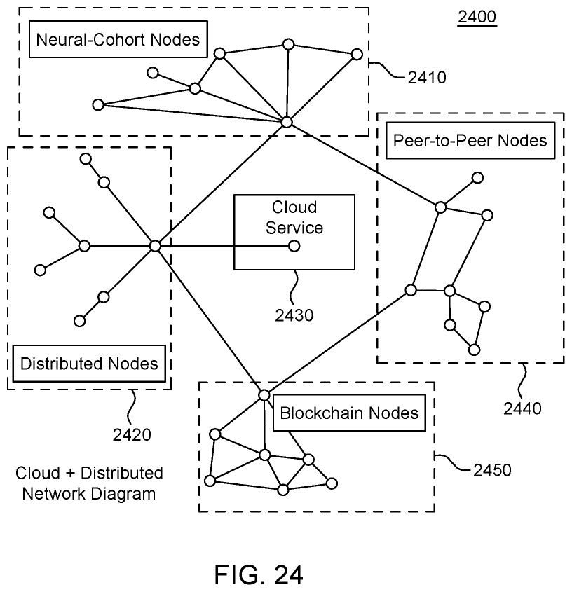

FIG. 24 is a block diagram that illustrates a cloud and distributed network 2400 upon which examples described herein may be implemented. A hybrid centralized, distributed and peer-to-peer network architecture is utilized including a centralized service architecture that is enabled as the primary means of facilitating services. A particular network paradigm is not necessary instead services that may be enabled via peer-to-peer networking, decentralized networking or through a centralized network architecture with components that facilitate hybrid services by intermediation in a centralized, distributed (for example, using a blockchain), or peer-to-peer network architecture; virtual meeting services that may be centralized or distributed across one or more computing networks; the use of multiple network oriented arrangements or communication protocols including peer-to-peer, distributed, cloud and neural networks (for example, communication between one or more neural-cohorts through a brain computing interface. The use of a computer network, network service, application, messaging service, platform, computing system and network devices and the use of multiple device types (for example, desktop, mobile, audio-only, etc.) over one or more internet and digital networks. The marketplace utilizes one or more types of networks to deliver and acquire services. In a centralized multi-tenant environment, the marketplace may connect to one or more cloud services 2430 (for example, Amazon Web Services, Microsoft Azure, Google Cloud Platform, and others) to perform a number of actions, tasks, routines, configurations, deployments, optimizations and others. A cloud service 2430 makes use of one or more data-centers that are optimized with software and components to extend a plethora of software as a Service or SaaS-based services such as deploying the marketplace website across one or more regions.

A cloud service 2430 may perform other functions, services or operations such as data archiving, backup and disaster recovery, networking, blockchain shared ledgers, business applications, application migration, data migration, database migration, data storage, data analytics, computing workload management, content delivery, developer operations, online sales and retail, edge computing, website development, mobile development, infrastructure management, machine learning and others. A cloud service 2430 may be enabled with workload management services that manage distributed nodes 2420 or computers that are distributed across one or more networks. The marketplace website may leverage distributed nodes 2420 from one or more networks. For example, blockchain nodes 2450, neural-cohort nodes 2410 or peer-to-peer nodes 2440 may be connected to distributed nodes 2420 through one or more network systems, protocols, software, component or module.

The marketplace may utilize nodes (for example, a collection of computers, operating systems, software systems and sub-systems) within one or more networks to exchange data, whereas data may consist of a range of letters, numbers, symbols, bytes, and others that are stored, transformed, added, removed, encrypted, decrypted, updated, transported and translated in one or more computing system. Transmission of data between nodes may be done routinely, on-demand, with user or machine input or through other means. For example, blockchain nodes 2450 may transmit data to peer-to-peer nodes 2440 that share a common session and require a specific function to be completed (for example, a file is uploaded and shared to meeting attendees during a virtual conference session). A session may contain nodes of the same or different classification with the heterogenous arrangement of nodes may differ, or change in accordance to the rules, routines, processes, instructions, user actions, machine actions or configurations that are enabled within the professional services marketplace.

The nodes in a cloud and distributed network may share common patterns, assembly, network, connections, configurations, routines, process, rules, libraries, components, modules and others. For example, a neural-cohort node 2410 may be enabled to connect to a peer-to-peer node 2440, whereas both the neural-cohort node 2410 and the peer-to-peer node 2440 may share a common process of validating connections (for example, performing a secure digital hand-shake), authenticating credentials (for example, using multi-factor authentication), and transporting data (for example, a payload of data and metadata). The marketplace may make use of various networks, nodes, and software systems to provide secure services to users, whereas users are enabled to connect and transmit data using one or more networks, devices, applications and system.

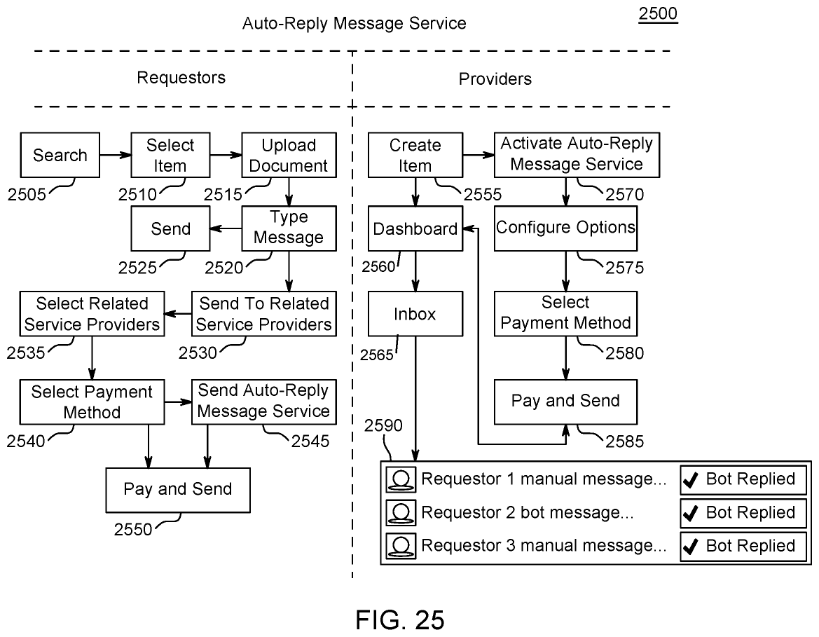

FIG. 25 is a block diagram that illustrates an auto-reply message service 2500 for requestors. Services requestors of the marketplace may be enabled to send messages to one or more service providers using automatic replies, automated bots and semi-automatic messaging services. When a service requestor searches 2505 for services, locates a service in a search result and selects the item 2510 from the search result list, the service requestor is enabled to upload a document 2515, type a message 2520 and send 2525 the message to the service provider of whom the selected service item 2510 is associated. In an alternative arrangement, after uploading a document 2515, a service requestor is enabled to type a message 2520 and instead of sending 2525 the typed message 2520 along with the uploaded document 2515, the service requestor may send the message to related service providers 2530.

When a service requestor types a message 2520 and sends the message to related service providers 2530, the service requestor is presented with options to select related service providers 2535, select a payment method 2540, complete payment and send 2540 the typed message 2520 or select an auto-reply message service 2540, then complete payment and send 2540 the typed message 2520 to the service provider associated with the selected item 2510. When selecting related service providers 2535, the service provider may sort, filter or configure options that enable a particular list of service providers to be presented using one or more means (for example, audio command on an IoT device, using touch on a mobile device, using a mouse and keyboard on a desktop computer, thinking of options using a brain machine interface).

A selection of related service providers 2535 may be determined using one or more filtering or sorting option (for example, using tags, categories, availability, online status, price, ratings, location and others), using one or more processes (for example, accessing a real-time database of online service providers, using geolocation to determine region specific preferences, and others), and one or more type of presentation (for example, a display interface, audio interface, and others). The requestors section of FIG. 25 represents one possible diagram that enable a service requestor to automatically send 2525 type messages 2520 and uploaded documents 2515 to service providers by selecting an auto-reply message service 2545, but there can be other configurations or arrangements. For example, a service requestor may not be required to upload a document 2515 but may type a message 2520 and continue to pay and send 2550 the message to one or more service providers.

The service requestor may select different types of auto-reply message services 2545. For example, an auto-reply message service 2545 may use a pre-written message (for example, a message template or user defined message), an artificial intelligent or AI based message (for example, a unique message that is generated by a computer system that uses artificial intelligence and machine learning), a guided artificial intelligent message (for example, a message that is modified or customized using a message template or user defined message and an artificial intelligent messaging bot), and other software systems that utilize automated, machine learning software and components. The service requestor may select one or more auto-reply message services 2545, one or more related service provider 2535, and one or more payment methods 2540 to pay and send 2550 the typed message 2520 associated with the selected item 2510 of interest.

Service providers may be enabled to create and deploy auto-reply message services 2570 using the same or similar auto-reply messaging types as service requestors. Service requestors and service providers are enabled to customize pre-written messages, create new messages, edit existing messages, copy messages from a library, sync messages from external sources (for example, a collection of messages can be uploaded from a spreadsheet that is located on a remote computer), remove previously saved messages, view message statuses, view statistics about auto-reply messages, and share messages with others. Service requestors and service providers may be enabled to modify settings, configure options 2575, setup processes, manage flows, and change routines of an AI based message services prior to activating an auto-reply message service 2570.

When a service provider creates a service item 2555, the service provider may be enabled to activate one or more auto-reply message services 2570, configure options 2575 of one or more auto-reply message services 2570, select a payment method 2580, pay and send 2585 the auto-reply message service 2570 to the dashboard 2560. From the dashboard 2560, a service provider may be enabled to view an inbox 2565 module containing messages 2590. Messages 2590 in the inbox 2565 module may contain auto-reply messages. Auto-reply message services 2570 enable messages 2590 to contain indicators (for example, a label denoting that an AI bot has replied to a message) that enable for service providers and service requestors to view, add, remove, archive, reply, filter, sort, flag, like, score, rate, share and search messages 2590 in the inbox 2565.

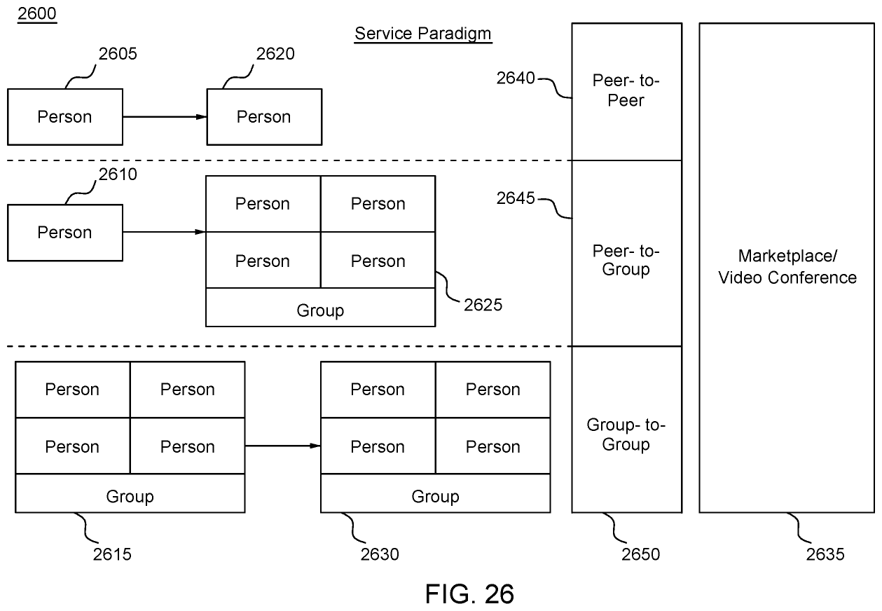

FIG. 26 is a block diagram that illustrates a service paradigm 2600 upon which examples described herein may be implemented. The marketplace's video conferencing 2635 utilizes and enables users to configure peer-to-peer 2640, peer-to-group 2645 and group-to-group 2650 meetings. The attendee types that define the grouping or non-grouping of meeting attendees may be configured by a service provider and a service requestor prior to or during a marketplace's video conferencing 2635 session. The term peer-to-peer 2640 may be used to describe computer networkings (for example, file sharing between two or more computers who share a common network protocol, security standard, messaging service and port). In the domain of a service paradigm, the term peer-to-peer 2640 may be descriptive of one-person 2605 communicating with another person 2620 through the marketplace's video conferencing 2635. In a one-to-one 2640 service paradigm, one-person 2605 is enabled to join a conference with another person 2620, whereas one-person 2605 is a service requestor and another person 2620 is a service provider. There is no specific order or time range by which why person 2605 or another person 2620 may connect, since the marketplace's video conferencing 2635 session provides peer-to-peer 2640 communication as a standard service paradigm.

Another service paradigm that enables communication between a service requestor and service provider is through a peer-to-group 2645 service paradigm. Through a peer-to-group 2645 service paradigm, a person 2610 communicates with two or more people 2625 also called a “group”. For example, a possible marketplace's video conferencing 2635 session may include a person 2610 who provides education services to a group 2625 of students, a person 2610 who receives information from a group 2625 on a webinar or a person 2610 who watches a collection of advertisements from a group 2625 of advertisers. There can be other examples that express the relationship between a person 2610 and a group 2625 and there may be multiple classifications of what defines a group. For example, a group 2625 may include people, AI bots, advertisements and other tenants and attendees on a marketplace's video conference 2635. A peer-to-group 2645 service paradigm may be established prior to or during a marketplace's video conferencing 2635 session. A peer-to-group 2645 service paradigm may be formed by adding an additional person 2620 in a peer-to-peer service paradigm or removing all but one person in a collection of people 2615 from a group-to-group 2650 service paradigm in an ices marketplace's video conferencing 2635 session.

In a group-to-group 2650 service paradigm, a collection of people 2615 communicate with another collection of people 2630. For example, an estate attorney may consult a family, business startup founders may ask questions to a panel of advisors and investors, a set of professional speakers may communicate to an audience on a marketplace's video conferencing 2635 session. There are other profiles or classifications of groups (for example, a band, department, company, team, assembly, cohort, bunch, circle, society, community, body, union, tribe, fellowship, club, association, family, and others). A collection of people 2615 may all be service requestors and another collection of people 2630 may all be service providers. There may be a mix of service providers and service requestors in in a group-to-group 2650 service paradigm.

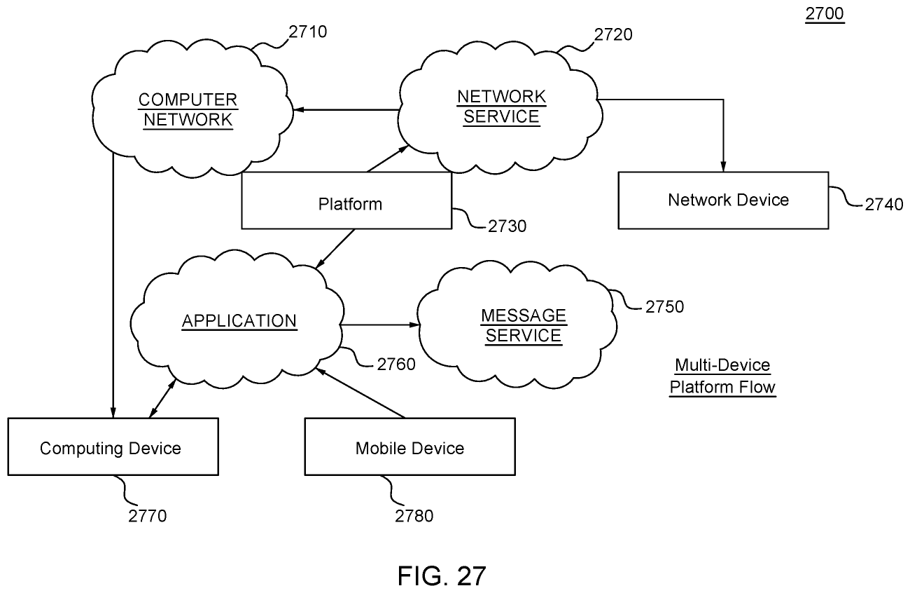

FIG. 27 is a block diagram that illustrates a multi-device platform flow 2700 upon which examples described herein may be implemented. The marketplace acts more like a platform 2730 that utilizes technology in the form of computer networks 2710, network services 2720, applications 2760 and message services 2750. A computer network 2710 may initially connect to a computing device 2770 after a network service 2720 relays data from a network device 2740. When data is sent to a computing device 2770 or a mobile device 2780, data may be relayed to one or more applications 2760 that communicate to one or more message services 2750. A message service 2750 may receive data from an application 2760 and may perform one or more operations, routines, sub-routines, processes, or tasks.

The computing device 2770 may utilize one or more computer networks 2710 (for example, a local area network, wide area network, wireless network, satellite network, and others), whereas one or more network services 2720 connect to one or more network devices 2740. Network devices 2740 may be any type of computing device (for example, networking appliance such as a router, modem, etc.), digital appliances (for example, network device software, network application, and others), machine operated systems (for example, an artificial intelligence enabled device, robot or software), or user operated appliance (for example, a computer, mobile phone, smart watch, IoT device, brain machine interface device, and others).

When a network service 2720 connects to the professional services platform 2730, the platform 2730 is enabled to send and receive data to and from the network service 2720. The platform 2730 may be enabled to also send and receive data to and from one or more applications 2760 and the platform 2730 is enabled to connect to other networks, services and appliances not illustrated in FIG. 27. The multi-device platform flow in FIG. 27 illustrates one of many variations, arrangements, orders, and combinations that connect devices to the platform 2730. In FIG. 27, the devices are illustrated include a network device 2740, computing device 2770 and mobile device 2780. The platform 2730 may be enabled to connect to other devices such as stationary devices (for example, devices that are not mobile), non-networked devices (for example, devices that have switched to offline mode) and artificial intelligent enabled devices (for example, an AI robot or hybrid).

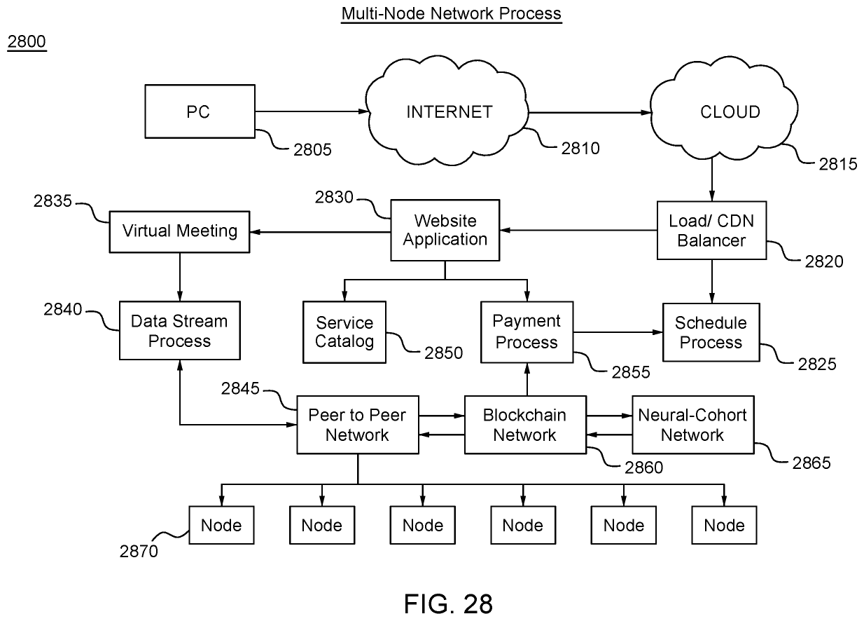

FIG. 28 is a block diagram that illustrates a multi-node network process 2800 upon which examples described herein may be implemented. The marketplace may utilize multiple network-oriented arrangements or communication protocols including peer-to-peer, distributed, cloud and neural networks (for example, communication between one or more neural-cohorts through a brain computing interface). In FIG. 28, a PC 2805 connects to the internet 2810, the internet 2810 connects to the cloud 2815 and the cloud 2815 connects to cloud services 2820 such as load balancers and content delivery networks or CDN. Cloud services 2820 provide the resources needed to present the website application 2830 that service providers and service requestors utilize.

The marketplace may contain components that facilitate hybrid services by intermediation in a centralized, distributed (for example, using a blockchain), or peer-to-peer network architecture. From the cloud 2815, cloud services 2820 may be enabled to provide or utilize other systems, software, components and modules. For example, a cloud service 2820 may utilize or deploy services for completing the scheduling process 2825 of a virtual meeting 2835. There may be one or more cloud services 2820 used in the cloud 2815. Each cloud service 2820 may perform similar or different operations, routines, sub-routines, processes, and functions.

The website application 2830 may utilize a service catalog 2850 and payment processing 2855 in order to enable service providers to list services and receive compensation for services rendered, service requestors to browser and search the service catalog 2850, complete payment processing 2855 and complete scheduling 2825 of meetings 2835, and allow users to use other services found on the website application 2830 and the meeting 2835 application. Service providers may add, modify and remove services in the service catalog 2850 and service requestors may browse, search, procure and review services in the service catalog 2850. Service providers may set service prices, allow bidding of services and provide availability of a service prior to a service requestor completing the payment process 2855. Service requestors are enabled to set a meeting 2835 schedule and complete other functions in the schedule process 2825 (for example, set reminders, extend meeting duration, etc).

When users of the marketplace initiate or enter a meeting 2835, meeting logs, application logs, user input and other types of data are transported through a data stream process 2840. The data stream process 2840 may send and receive data between the meeting 2835 application and one or more networks such as a peer-to-peer network 2845, a blockchain network 2860 and a neural-cohort network 2865, whereas nodes 2870 of one or more networks transport, store, process, assemble, encode, encrypt, combine, fragment, compress, or modify data provided by the data stream process 2840 or through one or more networks. A network may be enabled to transport, store, process, assemble, encode, encrypt, combine, fragment, compress, or modify data from other processes. For example, a blockchain network 2860 may send data to a payment processing 2855 service in order to validate a transaction, payment method, credentials and others. Networks may send and receive data to and from other networks. For example, a peer-to-peer network 2845 may communicate with a blockchain network 2860 and a blockchain network 2860 may communicate with a neural-cohort network 2865. Any number of nodes 2870 may connect to any number of networks and there may be multiple service catalogs 2850, payment processes 2860 and scheduling processes 2825.

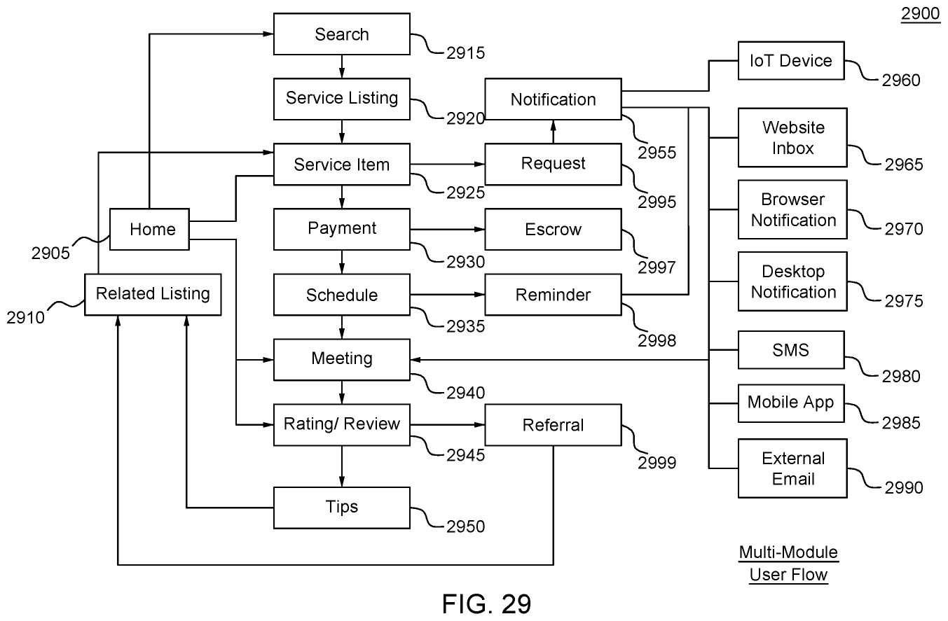

FIG. 29 is a block diagram that illustrates a multi-module user flow 2900 upon which examples described herein may be implemented. The marketplace's home page 2905 includes modules and components that give users the ability to perform actions that are relevant to their specific needs. From the home page 2905, a service requestor may search 2915 for professional services, browse a service listing 2920 of professional services and select a service item 2925 of the service listing 2920. Upon selecting a service item 2925, the service requestor may continue to payment 2930 of the service item 2925, where payment 2930 details are entered or selected from previously saved payment 2930 details. Upon completion of payment 2930, a service requestor may schedule 2935 a time that is appropriate to conduct a meeting 2940 with the service provider.

After the completion of the meeting 2940, the service requestor may submit ratings and reviews 2945 based on their experience with the service provider. The service requestor may enter additional payment 2930 in the form of tips 2950 to the service provider. After the service requestor completes ratings and reviews 2945 or tips 2950, the service requestor may view other related listings 2910. There may be one or more ways to classify a related listing 2910. For example, a related listing 2910 may be assimilated from the search 2915 history of the service requestor, from the category, topic or tag of a previous meeting 2940 or from a service listing 2920 with high ratings and reviews 2945. The related listing 2910 may be a page, component or module (for example, a widget on a page). The service requestor may select a service item 2925 from a related listing 2910, from the home 2905 page, or from a service listing 2920 that is produced from a search 2915.

The service requestor may navigate to a meeting 2940 or a ratings and review 2945 of a service item 2925 from the home page 2905. For example, after a meeting 2940, the service requestor may choose to skip the process of providing a rating and review 2945 and navigate back to the home 2905 page or view a related listing 2910 of the service item 2925. The service requestor may provide a referral 2999 in place of a tip 2950 to the service provider with the referral 2999 including sharing (for example, sending an email, posting details on a social media website or sending a SMS invitation) the service item 2925 or service provider details. After a referral 2999 is complete, the service requestor may then view a related listing 2910 or navigate to the home 2905 page.

A service requestor may request 2995 additional information, share a document or negotiate prices of a service item 2925 with the service provider of the service item 2925. When a request 2995 is initiated, a notification 2955 is sent to the service provider, whereas the service provider may receive the notification 2955 on an IoT device 2960 (for example, a home assistant device signals an alert of a new service request 2995), a website inbox 2965 (for example, the inbox of a web based email application), browser notification 2970 (for example, a browser based push notification), desktop notification 2975 (for example, a desktop push notification), short message service or SMS 2980 (for example, a mobile text message), mobile application 2985 (for example, a virtual marketplace mobile application with push notifications enabled), external email 2990 (for example, a desktop email client, smart phone email client, brain machine interface email client, etc.), or others with one or more devices and applications may contain details and a reference (for example, a hyperlink) to the meeting 2940.

A notification 2955 may include a reminder 2998. A service requestor and a service provider may be notified of a scheduled 2935 meeting 2940 through one or more reminders 2998 that are presented as a notification 2955 on one or more devices and applications or in one or more intervals, frequencies, and occurrences. For example, a service provider may receive a reminder 2998 from a short message service 2980 on their smart phone a day before the scheduled 2935 meeting 2940, a reminder 2998 on their IoT device 2960 an hour before the scheduled 2935 meeting 2940 and a notification 2955 in the marketplace website inbox 2965 five minutes before the meeting 2940 starts.

A service requestor may schedule 2935 a reminder 2998, whereas one or more notifications 2955 may be sent or pushed to one or more devices, applications, components, modules or interfaces. The marketplace may automatically enable notifications 2955 that are relevant to the service provider, service requestor and general user. For example, the website may display a notification 2955 on the home 2905 page related to updates (for example, new feature releases), news (for example, announcements), important alerts (for example, website maintenance time), and reminders 2998 related to incomplete ratings and reviews 2945 of a completed meeting 2940.

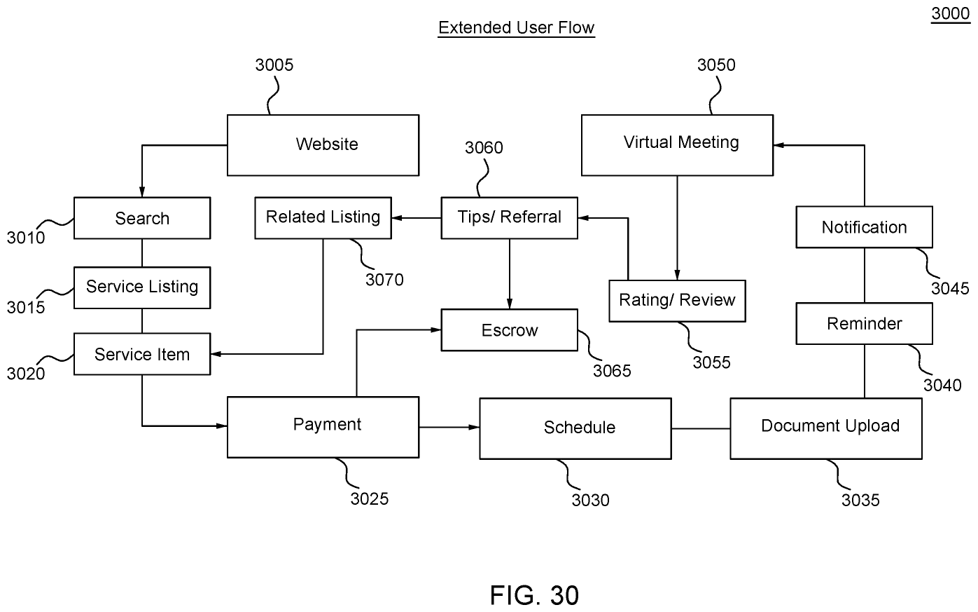

FIG. 30 is a block diagram that illustrates an extended user flow 3000 upon which examples described herein may be implemented. Modules may enable payments from a multiplicity of service models (for example, question and answer service, searching service, analysis service, task service, research service, consulting service, business service, language service, career service, health service, matrimonial service, lifestyle service, information service, location specific services, fitness service, education and training service, sales and marketing service, idea formation service, product review service, entertainment service, tax service, assessment service, finance and stock service, mobile service, technical support service, advisory service, accounting service, event service, communication and support service). Components may bind financial transactions to the deliverability of services between a service provider and a service requestor (for example, payments to service providers are held in escrow and released after the date and time of the scheduled service). When a user enters the marketplace website 3005, the user may search 3010 for services, view a service listing 3015 of a search 3010 and select a service item 3020 from the service listing 3015. The user may continue with fulfilling payment 3025 of a service item 3020, schedule 3030 a time to conduct a meeting 3050, upload documents 3035 related to the service item 3020, add a reminder 3040 and enable notifications 3045 to be sent to devices and applications prior to a meeting 3050.

After completing a meeting 3050, a user may provide ratings and reviews 3055, tips and referrals 3060 and view related listing 3070. After viewing a related listing 3070 a user may select a service item 3020 and continue to payment 3025, schedule 3030, document upload 3035, reminders 3040, notifications 3045 and the meeting 3050.

After rating and reviewing 3055 a meeting 3050, a user may provide tips and referrals 3060. When a payment 3025 of a service item 3020 is initiated, the payment 3025 is held in escrow 3065. When a user provides a tip 3060 for a completed meeting 3050, the tip 3060 is held in escrow 3065. The payment 3025 and tip 3060 of a service item 3020 are released from escrow 3065 after an event or trigger. An event may include a particular time, user action, computed process. A trigger may include a combination of actions, computations and calculations. For example, the escrow 3065 may release payment 3025 to the service provider after the service requestor marks a service item 3020 as complete triggering upon an action taken by the service requestor. The escrow 3065 may release payment 3025 an hour after the completion of a meeting 3050 driven by a time-based event.

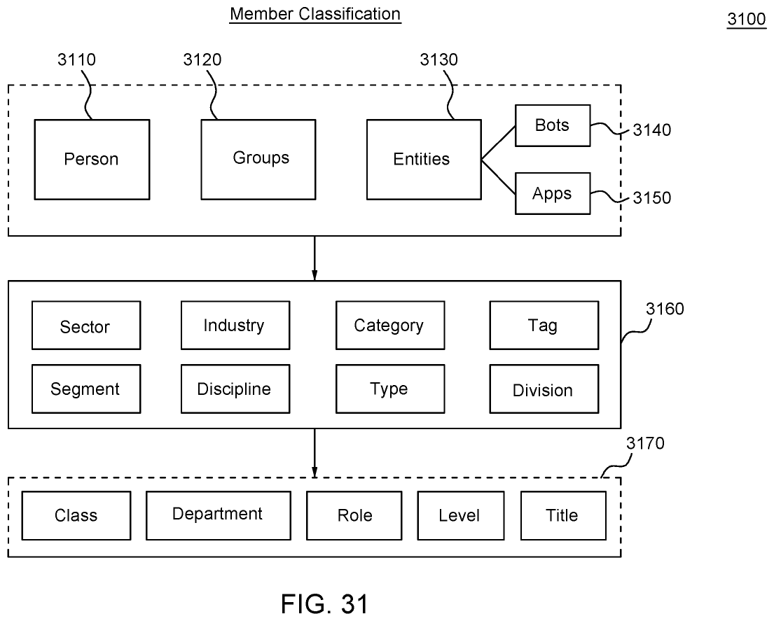

FIG. 31 is a block diagram that illustrates a member classification 3100. A multi-tenant event-oriented service model is utilized. The model includes an event driven paradigm where service requestors select a date and time for services to be rendered (for example, using a calendar driven event scheduler) before, during and after a scheduled virtual conference session (for example, a virtual conference date and time can be extended in real-time). The use of peer-to-peer (for example, a person to person meeting), peer-to-group (for example, a person provides services to a team) and group-to-group (for example, two organizations attend a virtual exposition) services between requestors and providers expands the breath of serviceability and the multiplicity of service paradigms supported in a service marketplace. Support for varying member classifications (for example, individuals, groups, commercial entities, governments, virtual entities, non-profit, automated bots) and expands the use of services to more than one group classification (for example, by sector, industry, category, type, discipline, segment, degree, etc.). The use of intelligent agents (for example bots) with human-to-human, human-to-bot and bot-to-bot communication; and support for multi-tenant usage (for example, groups of experts, anonymous users, multi AI agents, information service providers, contacts or connected users of personal or social networks, digital automated sources, online real time available matched users and subscribed and preference base matched service providers or searchers etc.).

Users of the marketplace may include of one or more-member classifications. Users may change their member classification in the setting and configuration pages of the marketplace and may not be required to keep a specific member classification. Users may invite other users to join the marketplace under any member classification. For example, a person 3110 may invite a group 3120 of people to provide a common set of services to others. In another example, a group 3120 may integrate an entity 3130, such as a custom application 3150, into the group's 3120 account. The custom application 3150 may be enabled with specific restrictions, rights, roles, permissions and features on the group's 3120 account.

A user may be a person 3110 (for example, a living human being) who is interested in providing services, requesting services or referring other users to services items or service providers. For example, a person 3110 may use the marketplace as a place to request services from groups 3120, such as a lifestyle coaching organization. A person 3110 may provide services to another person 3110 (for example, one-on-one math tutoring services) or groups 3120 (for example, after school math tutoring class). A person 3110 may provide services to entities 3130 (for example, filling out a survey or watching an advertisement). The entities 3130 are enabled to compensate a person 3110 for providing feedback, insight, or responses to a solicitation, survey, poll and others.

A user may be groups 3120 (for example, an organization containing a tax classification of corporation). A group 3120 may use the marketplace to acquire multiple services (for example, a school is a type of group 3120 that may acquire tutoring services, staff training services, and others), provider services to other users (for example, a law firm is a type of group 3120 that may provide legal services), or refer other groups (for example, a consulting firm is a type of group 3120 that may refer users to marketing firms for a referral fee). Groups 3120 may be enabled to request and provide services in the same or similar way as a person 3110. In the marketplace, groups 3120 may be created from the registration of a new account, or by converting an existing account of a person 3110 into a group 3120 by changing account settings and configurations.

The marketplace may utilize intelligent agents (for example virtual entities 3130) with human-to-human, human-to-bot and bot-to-bot communication. For example, there may be components that enable users to utilize an auto-response bot in their inbox (for example, to answer frequently asked questions from other users who use bots to auto-request quotes for services), components that enable the use of semi-automated intelligent agents (for example, a chat bot is configured by a service provider and deployed to a virtual meeting session). Users of a network may have the capability of communicating with other users with a semi-automated intelligent agent. Components may enable users to employ intelligent agents to assist with asking or answering questions (for example, one user has a list of questions and follow up questions that is communicated to another user in a chat session). There may be other components that are used to achieve human-to-human, human-to-bot and bot-to-bot communication. Various components, modules and software services may be utilized and may be accessed through a network service, device application, and others and used to facilitate communication or digital transactions with users.

A user may be an entity 3130 (for example, a software program) such as a bot 3140 (for example, an auto-reply message bot) or an application 3150 (for example, third-party widgets and components that integrate with the marketplace website and mobile application). In the marketplace, entities 3130 can be created from the registration of a new person 3110 or group 3120 account, or by adding entities 3130 to an existing account of a person 3110 or group 3120 through account settings and configurations. A person 3110 or group 3120 may have zero or more entities 3130 added, created, updated, or deleted on their account. Some entities 3130 may not be removable (for example, an auto-reply message bot) but may be disabled instead, while other entities 3130 may be inactive or restricted due to one or more reasons (for example, security policies, abuse policies, compliance policies, and others). An entity 3130 may be enabled to perform one or more functions, actions, process, or measure through one or more means. For example, an entity 3130 may be enabled by default upon the creation of a new account, after a user action is performed, from one or more triggers (for example, a collection of software programs may activate an entity 3130 when one or more conditions are met), or any combination of automatic, process oriented, user action-oriented set of actions.

A user of any member classification of person 3110, group 3120 or virtual entity 3130 may be distinguished by one or more classifications 3160 such as by sector, industry, category, tag, segment, discipline, type or division. When a user searches for services via the marketplace, the service listings may be filtered or sorted by classifications 3160, ratings, reviews, availability, and others. A person 3110 may provide services that relate to a specific classification 3160 such as an industry (for example, a service provider may provide technical training services in the technology industry). A group may also be distinguished by classifications 3160 such as by discipline (for example, a tutoring school focuses or teaching math and critical thinking lessons). There may be sub-classifications 3170 associated with a person 3110, group 3120, or entity 3130 such as class, department, role, level, or title. For example, a person 3110 may classify their role as senior math tutor to distinguish themselves from other math tutors on the marketplace.

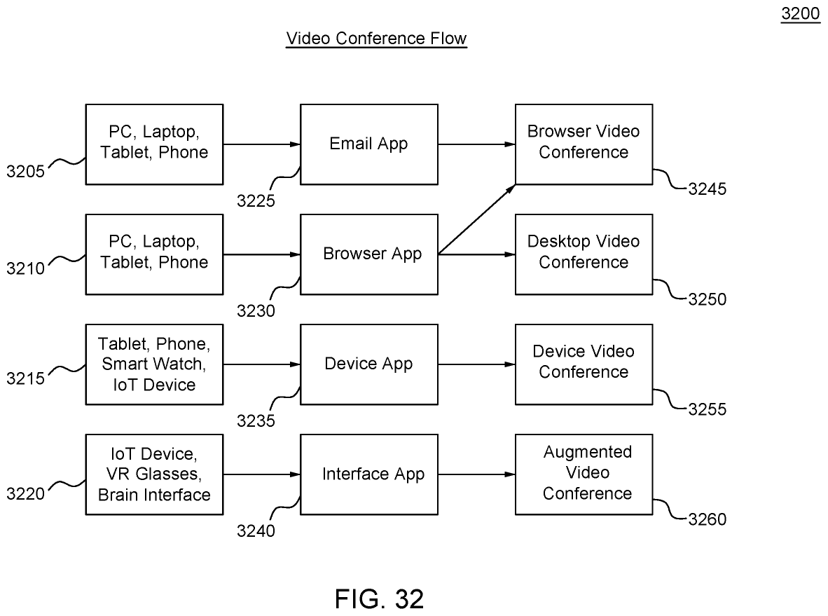

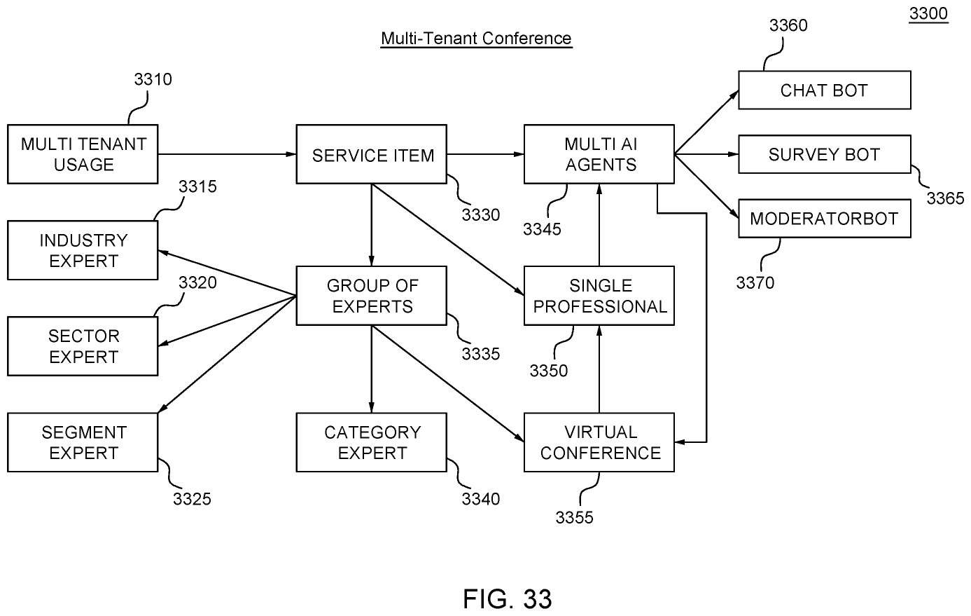

FIG. 32 is a block diagram that illustrates a video conference flow 3200. A user on the marketplace can use one or more applications, software, component or module that provide a way to conduct conferencing with another user. For instance, a user may utilize one computing device 3205 (for example, a personal computer, laptop, tablet, smart phone, etc.) containing an email application 3225 that provides a reference (for example, a hyperlink) to a browser-based video conference 3245 application and another user may utilize a different computing device 3210 (for example, a laptop, personal computer, tablet, smart phone, etc.) containing a browser application that provides a reference (for example, an application opener link) to a desktop-based video conference 3250 application. One computing device 3205 may be enabled to support email applications 3225 and the different computing device 3210 may be enabled to support a browser application 3230. One computing device 3205 may be enabled to load a browser video conference 3245 and the different computing device 3210 may be enabled to load a desktop video conference 3250. A browser application 3230 may be enabled with features that support loading a browser video conference 3245 or a desktop video conference 3250 (for example, a pointer to a desktop application can be used instead of a web or browser application).

A user on the marketplace may use one or more computing devices 3205 with one or more email applications 3225, browser application 3230 or device application 3235 to connect to a video conferencing session. For example, a user may connect to an IoT device 3215 (for example, a tablet, phone, smart watch, IoT Device) that is enabled with a device application 3235 that connects to a device-level video conference 3255. When connecting users to a device video conference 3255, a device application 3235 may use a graphical user interface or be configured with audio-only preferences. For example, a personal assistant device (for example, Amazon Alexa enabled pod) uses an audio-only preference at the device application 3235 level and users are enabled to speak commands instead of navigating a graphical user interface with a visual pointer.

Users of the marketplace may utilize other devices 3220 (for example, IoT Device, VR Glasses, Brain Machine Interface, and others) to connect to an augmented video conference 3260 through an interface application 3240. For example, a user may utilize a brain machine interface, think about specific commands that are registered into an interface application 3240 that converts brain waves into machine readable code and initiate an augmented video conference 3260 session from thought. There may be other devices 3220 that one or more users of the marketplace utilize to connect over a conference and FIG. 32 is merely an example of a few of these devices, applications, software, component or module.

FIG. 33 is a block diagram that illustrates a multi-tenant conference flow 3300. The marketplace supports a multi-tenant usage 3310 where a service item 3315 can be created, updated, delete, added, removed, procured, rated, reviewed and others, by multiple tenants. A tenant is descriptive of multiple types of user classifications that may be a subject, topic, domain, or discipline. For example, a group of experts 3335 may focus on a domain that is related to a category, while each member of the group is classified as a category expert 3340. There may be one or more types of category experts 3340 that are relevant to the group of experts 3335. For example, a personal trainer that focuses on the category of rehabilitation is considered a category expert 3340, whereas the personal trainer is also a member of the personal trainer group of experts 3335. In another example, a category expert 3340 such as a college math tutor is related to the group of experts 3335 who focus on college education, with a category of math, the group association is education and the tutor is the service provider.

A group of experts 3335 may be distinguished by industry which includes one or more industry experts 3315, by sector which includes one or more sector experts 3320, or by segment which includes one or more segment experts 3325. There may be other classifications not mentioned that is descriptive of a group of experts 3335 such as experts by domain, region, nation, niche, or others. For a multi-tenant usage 3310 to exist on a conference 3355, the service item 3315 may be assignable by at least one service provider. There may be one or more service providers servicing a service item 3315 within a conference 3355. A service provider may be a group of experts 3335, multi-AT “artificial-intelligence” agents 3345 or single professional 3350.

When a multi-AT agent 3345 is assigned to a service item, there may be a single professional 3350 who activates, deactivates, adds, removes, enables, disables, modifies, configures or uses the multi-AT agent 3345 within the conference 3355. A multi-AT agent 3345 may utilize chat bot 3360 that communicates to meeting participants on a conference 3355, whereas the chat bot 3360 may be enabled with features, components, modules and other programs that enhance the communication experience. For example, a multi-AT agent 3345 that utilizes a chat bot 3360 may answer questions, respond to comments, send documents (for example, a PDF is attached in a chat box), process uploaded documents, and others. The multi-AI agent 3345 may instruct the chat bot 3360 to gather details, provide support, or simply entertain the virtual conference 3355 attendees. When a multi-AI agent 3345 utilizes a survey bot 3365, the conference 3355 may provide the interface (for example, graphical user interface, audio-only interface, etc.) that enable surveys for one or more meeting attendees. The survey bot 3365 may present questions to meeting attendees before, during or after the conference 3355 session, record the results and either display the results publicly, to meeting attendees, or save the results privately. During a conference 3355 session a multi-AI agent 3345 may utilize a moderator bot 3370 to organize discussions based time-intervals (for example, let the meeting host know to change topics every 15 minutes), enables attendees to speak (for example, open then session for questions and answers after a specific time or topic has been discussed), restrict meeting attendees (for example, prioritizes the meeting host by muting other attendees when the meeting host is speaking) and others.

When a single professional 3350 is assigned to a service item 3315, other single professionals 3350 are enabled to attend the conference 3355. A single professional 3350 is enabled to invite other single professionals 3350 to attend a conference 3355 when all meeting service requestors who attend the meeting confirm and procure additional service items 3315. For example, a single professional 3350, such as a business coach, invites another single professional 3355, such as an attorney, to provide general legal information to a service requestor, and the service requestor agrees and procures the new service item 3315 that is added to the existing conference 3355 session. During the conference 3355, a single professional is enabled to invite a group of experts 3335 to join a meeting before and during the conference 3355. Each service requestor is enabled with the option to procure the serve item 3315 related to the invited group of experts 3335 but is not required to do so. For example, a single professional 3350, such as a dating coach, may invite a group of experts 3335, such as a health and wellness organization, to discuss ways to improve the health and wellness of a service requestor. The single professional 3350 may extend an invitation which may include a meeting date and time. The service requestor confirms and procures the new service item 3315 upon an approved and scheduled conference 3355.

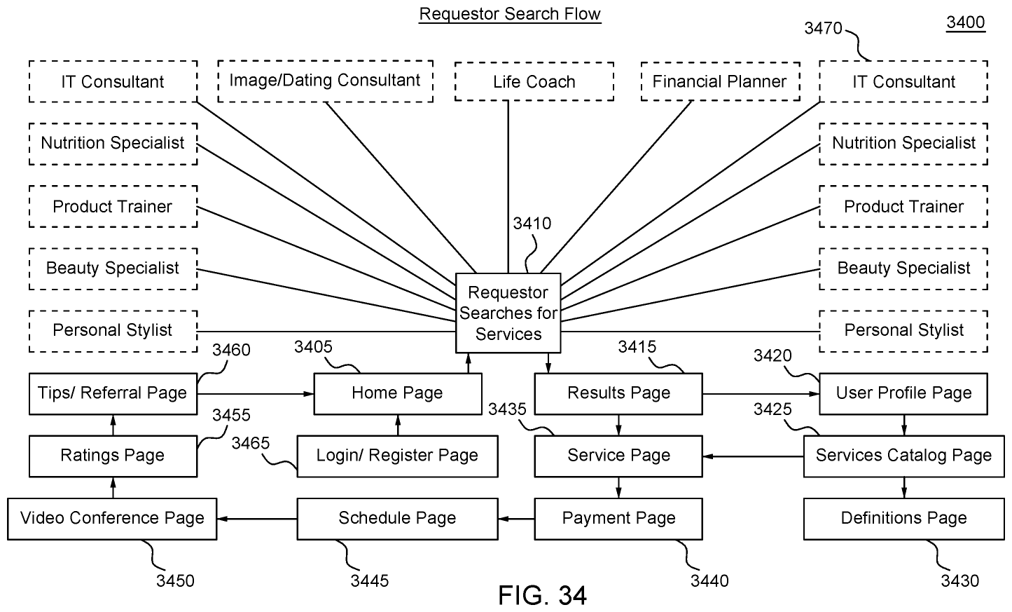

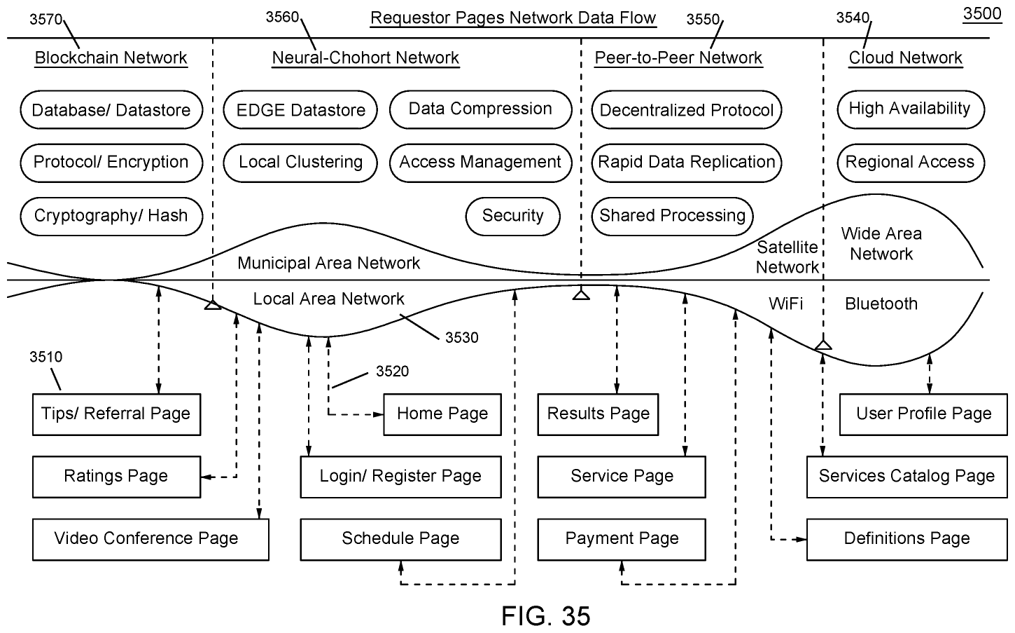

FIG. 34 is a block diagram that illustrates a requestor search flow 3400. Since a service requestor is enabled with self-service options during a service lifecycle (for example, from searching, procuring, scheduling, and meeting to rating, revising, tipping and referring), a service requestor may utilize the website homepage 3405 to benefit from a plurality of communication enabled modules. The plurality of communication enabled modules may include a payment module 3440, scheduler 3445 and video conference 3450 page. A service requestor is enabled to search, browse, procure, rate, review, share, tip and recommend services on the professional services marketplace. When a service requestor searches for services 3410, the service requestor may select a service item that is based on a specific category 3470 or any other service classification. Among the many categories 3470 that are presented to the service requestor, some of the common categories include IT Consultant, Image Consultant, Dating Consulting, Life Coach, Financial Planner, Teacher, Tutor, Tax Advisor, Fitness Instructor, Business Strategist, CPA, Accountant, Nutrition Specialist, Product Trainer, Beauty Specialist and Personal Stylist.

A service requestor is enabled to select service items from the home page 3405 by first, completing a login or registration from the login/register page 3405. The service requestor may select service items by searching for services 3410 on the home page 3405, then viewing service items from the search results page 3415. A service requestor may choose to learn more about the service provider by navigating to the service providers user profile page 3420. The service requestor may browse the service catalog page 3425 of the service requestor. From the service catalog page 3425, a service requestor may view service definitions (for example, a description of the service) on the definitions page 3430 or navigate to the service page 3435 by selecting a service item on the service catalog page 3425. A service requestor may navigate to the service page 3435 after selecting a service item from the search results page 3415.

Although FIG. 34 illustrates two paths where a service requestor is enabled to access a service page 3435 (for example, from the results page 3415 or from the service catalog page 3425), there may be other pages, components or modules that are used and other means of navigating to the service page 3435. Pages described in the illustrations on FIG. 34 and others are universally used to describe a place where a user of the marketplace may navigate. The term “page” may include graphical and non-graphical elements such as audio-only (for example, an IoT device that navigates using voice commands) and a user is enabled to operate any range of devices that is enabled to facilitate professional services. The term “navigate” or “browse” denotes an action by a user (for example, a person, machine, or others) that leads to the presentation of information (for example, text, graphic, audio, video, and others) relative to the page where the action was initiated, completed or performed.

A service requestor may be enabled to procure services on the payment page 3440. From a completed payment, a service requestor may continue to the schedule page 3445 in order to schedule a conference. Upon a scheduled date and time, the service requestor is enabled to navigate to the conference page 3450 and attend the conference. Upon completing the conference, the service requestor may provide ratings from the ratings page 3455, tips and referrals from the tips/referral page 3460. The completion of a conference, independent of whether ratings, tips or referrals are completed, enables the service requestor to navigate back to the home page 3405.

FIG. 35 is a block diagram that illustrates a requestor pages network data flow 3500. Components (for example, networked servers in a datacenter, distributed computing systems, website applications, mobile applications and others) may be utilized that enable member profiling, listing, searching, messaging, payment processing, scheduling, virtual meeting, rating and reviewing technologies for a plurality of professional service providers and knowledge experts to engage their services in real-time. Accessing pages 3510 on the marketplace requires a user to establish a connection 3520 to one or more internet networks 3530. A connection 3520 to an internet network 3530 enables a user (for example, a service provider, service requestor, visitor, and others) to utilize resources (for example, contextual information, images, videos, documents, and others) through a cloud network 3540, peer-to-peer network 3550, neural-cohort network 3560, blockchain network 3570 and others.

A connection 3520 to an internet network 3530 that accesses a blockchain network 3570 may be established for one or more purposes. A blockchain network 3570 is a technical infrastructure that provides ledger and smart contract services to applications. Primarily, smart contracts are used to generate transactions which are subsequently distributed to every peer node in the network where they are immutably recorded on their copy of the ledger. The users of applications may be end users using client applications or blockchain network administrators. A blockchain network 3570 may utilize a datastore or database over a protocol that uses cryptography and sophisticated encryptions such as a hash to store a digital ledger of data. A user of the marketplace may access pages 3510 that connect 3520 over an internet network 3530 to a blockchain network 3570 for a range of purposes. For example, a user may view a history of payments made through the payment page 3510 through a database that uses a blockchain network 3570. The history may include payment information, service details, one or more service provider details and other relevant data.

A connection 3520 to an internet network 3530 that accesses a neural-cohort network 3560 may be established for one or more purposes. A neural-cohort network 3560 is a bio-computing network that utilizes two or more brain computing interfaces to exchange information such as bio-digital media, bio-digital sensory, and bio-digital memory. The members of a neural-cohort network 3560 participate in a bio-digital experience through digital telemetry. A neural-cohort network 3560 typically utilizes an EDGE datastore and advanced data compression software to access and send data to and from the human brain. A user of the marketplace can access pages 3510 by connecting 3520 to an internet network 3530 through a brain machine interface which accesses a neural-cohort network 3560 to perform local clustering, access management, and other tasks. For example, a service requestor who is enabled with a brain machine interface (BMI) may securely connect 3520 to a service provider over an internet network 3530 and request information related to a service from the service page 3510. The service provider who may be BMI enabled may respond to the service request over a wide area network 3530 that securely connects 3520 to a neural-cohort network 3560.

A connection 3520 to an internet network 3530 that accesses a peer-to-peer network 3550 may be established for one or more purposes. A peer-to-peer Network 3550 or peer-to-peer computing or networking is a distributed application architecture that partitions tasks or workloads between peers. A peer-to-peer network 3550 typically utilizes a decentralized protocol to rapidly replicate data and perform other operations such as shared processing. A user of the marketplace may utilize a peer-to-peer network 3550 to share private documents and information to other users, host a virtual conference, and others. For example, a service requestor may share sensitive documents to a service provider on the video conference page 3510 by connecting 3520 to a local area network 3530 that routes data over a peer-to-peer network 3550. In another example, a meeting host can enable enhanced artificial intelligence (AI) shared processing of data during a conference by requesting meeting participants to enable sharing of computing resources over a peer-to-peer network 3550.

A connection 3520 to an internet network 3530 that accesses a cloud network 3540 may be established for one or more purposes. A cloud network 3540 is the on-demand availability of computer system resources, especially data storage and computing power, without direct active management by the user. A user may access pages 3510 in the marketplace by connecting 3520 to an internet network 3530 that requests resources from a cloud network 3540. For example, a service provider may connect 3520 to a video conference page 3510 over a satellite network 3530 in a remote region and provide professional services through the support of a cloud network 3540 that provides high availability and regional access in remote regions. The cloud network 3540 may serve pages 3510, digital assets (for example, content scripts, images, videos, etc.) and other resources by connecting 3520 to a Municipal Area Network 3530 or other networks.

There are several example cases where a user may utilize a specific internet network 3530 to access pages 3510 via the marketplace. For example, a user may access the login/register page 3510 by connecting 3520 to a local area network 3530 on a computer (for example, a desktop computer, a laptop or IoT device). There are cases where a user may manually or automatically change the connection 3520 to a network 3530. For example, a user may browse a search result page 3510 over a Wi-Fi network 3530 at a school, navigate to a service page 3510 and establish a connection 3520 to a municipal area network 3530 while commuting. There may be multiple internet networks 3530 used while accessing pages 3510 via the marketplace. For example, a user can speak commands into an IoT device which that connects 3520 to a Bluetooth network 3530 that connects 3520 to a Wi-Fi network 3530 at home. The IoT device may be enabled to browse pages 3510 on the marketplace.

There are cases where two or more networks may exchange data in the marketplace. For example, a cloud network 3540 may connect to a node in a peer-to-peer network 3550 to store analytics from a video conference page 3510. In another example, a neural-cohort network 3560 may connect to a blockchain network 3570 to validate a payment transaction between a service provider and a service requestor. Any number of digital networks (for example, blockchain network 3570, neural-cohort network 3560, peer-to-peer network 3550, cloud network 3540 and others) may connect to any number of other digital networks and internet network 3540 for exchanging data via the marketplace.

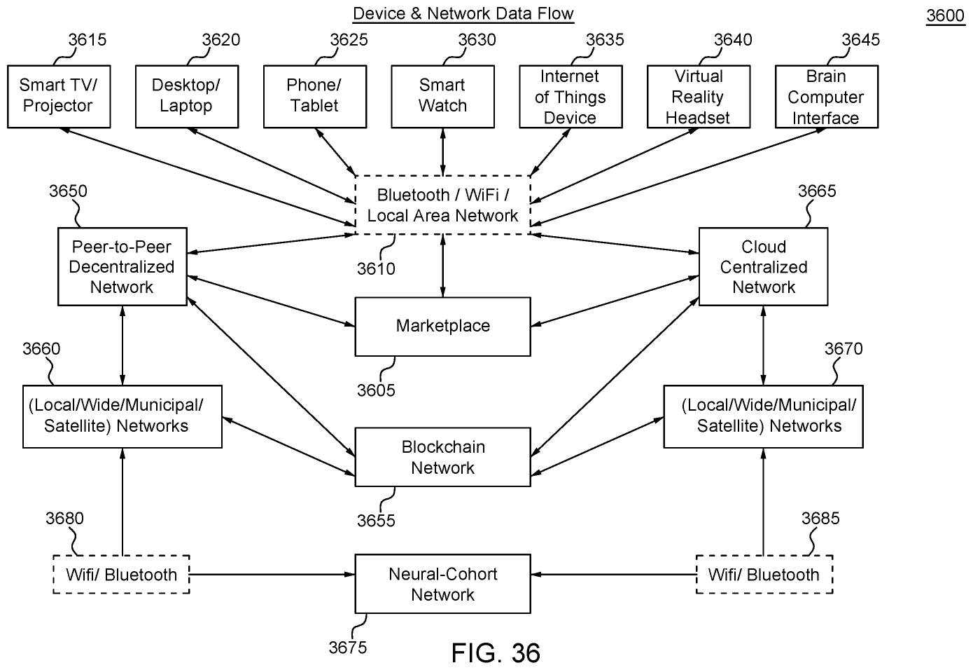

FIG. 36 is a block diagram that illustrates a device and network data flow 3600. The marketplace 3605 may be accessed and utilized through a range of device types that connect. The marketplace 3605 may connect to a range of internet networks 3610. For example, one user may attend a conference from a smart TV or projector 3615 that connects to a local area network 3610 while a different user may access the same conference from a brain computing interface 3645 that connects to a Wi-Fi network 3610. Devices such as a desktop or laptop 3620 are traditionally used to connect to a Wi-Fi or local area network 3610 while other devices such as a phone or tablet 3625 may connect to a Bluetooth or Wi-Fi network 3610 to access the marketplace 3605. A user may utilize a Bluetooth network 3610 to connect a smart watch 3630 to a phone or tablet 3625, then from the phone or tablet 3625 the user may connect to a Wi-Fi network 3610 that uses a router over a local area network 3610 to access the marketplace 3605. A phone or tablet 3625 may connect to a Wi-Fi network 3610 that connects an internet of things or IoT device 3635 such as a home assistant (for example, Amazon echo, Google Assistant, etc.) device to access the marketplace 3605. Any number of devices may connect to any other number of devices through Bluetooth, Wi-Fi, Local Area Network 3610 and other networks to access the marketplace 3605. For example, a virtual reality headset 3640 may connect to the professional services marketplace 3605 through a Wi-Fi network 3610 and connect to a desktop or laptop 3620 over a Bluetooth network 3610. The desktop or laptop 3620 connects to a local area network 3610 to access data on the marketplace 3605.

The marketplace 3605 may utilize a peer-to-peer decentralized network 3650 to send data (for example, sensitive resources, digital documents, etc.) between users. For example, a peer-to-peer decentralized network 3650 may connect to a Wi-Fi network 3610 that connects a desktop or laptop 3615 through a protocol that is designated for users of the professional service marketplace 3605. A peer-to-peer decentralized network 3650 may directly connect to the marketplace to exchange relevant information (for example, virtual meeting schedule, user profile information, etc.) or connect to a blockchain network 3655 to validate information in a zero-trust environment. When a peer-to-peer decentralized network 3650 connects to a blockchain network 3655, the blockchain network 3655 may make additional connections to a decentralized internet network 3660 (for example, a decentralized local area network, wide area network, municipal area network, satellite network, and others) to exchange data. The peer-to-peer decentralized network 3650 may connect to a decentralized internet network 3660 directly to exchange data.

The marketplace 3605 may utilize a blockchain network 3655 directly, by connecting to a peer-to-peer decentralized network 3650 that then connects to a blockchain network 3655, by connecting to a cloud centralized network 3665 that then connects to a blockchain network 3655 or by other means. When a cloud centralized network 3665 (for example, Amazon Web Services, Microsoft Azure, Google Cloud Platform, etc.) connects to the marketplace 3665, the cloud centralized network 3665 may connect to a centralized internet network 3670 that then connects to a blockchain network 3655 and exchanges data. Data exchange may triangulate between a blockchain network 3655, a cloud centralized network 3665 and a centralized internet network 3670. Data exchange may triangulate between a blockchain network 3655, a peer-to-peer decentralized network 3650 and a decentralized internet network 3660. A cloud centralized network 3665 may connect to a Wi-Fi network 3610 that enables devices of all types to receive data (for example, pages, software code, digital media, etc) of all types.

A neural-cohort network 3675 is a type of virtual network. A neural-cohort network 3675 may connect to a decentralized Wifi or Bluetooth network 3680 of which may connect to one or more decentralized internet networks 3660 that connects to a blockchain network 3655 or connects to a peer-to-peer decentralized network 3650. A neural-cohort network 3675 may connect to a centralized Wi-Fi or Bluetooth network 3685 which may access a centralized internet network 3670 that connects to a blockchain network 3655 or connects to a cloud centralized network 3665. FIG. 36 illustrates one of many types of devices, networks and connections and is not limited to examples presented in the illustration. There can be other arrangements of device connections, network connections and other connections that enable users of the professional services marketplace 3605 to access and utilize pages, components, modules and others.

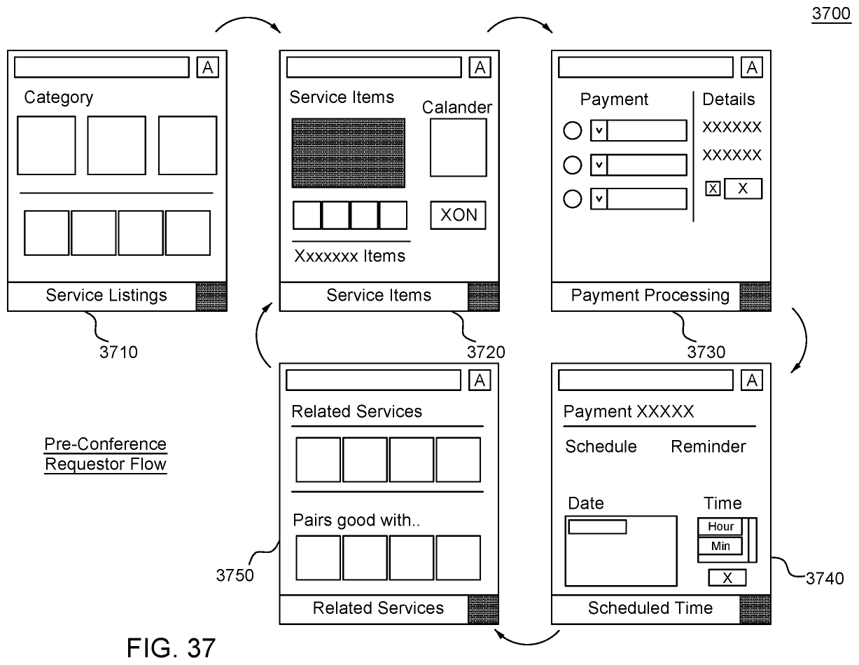

FIG. 37 is a block diagram that illustrates a pre-conference requestor flow 3700. A service requestor is enabled to navigate to the marketplace and browse service listings 3710 related to a service category, topic or search phrase. From the service listings 3710, the service requestor may view details related to a particular service item 3720 (for example, service item features, videos, calendar, price, tagline, description, etc.). From the service item 3720 page, the service requestor may continue to payment processing 3730 of the service item, contact the service provider, bookmark the service item (for example, by clicking a like, save, star or other icon buttons), share the service item with friends (for example, recommending to another user within the website, sharing to users from other websites or networks, sending an email, sending a text message), view related services 3750, or navigating to other pages on the marketplace.

From the payment processing 3730 page the service requestor may enter payment details or use saved payment details, add additional features to the checkout (for example, a service item may contain related service items provided by the same or other service providers), complete payment processing 3730 of the service item 3720, and continue to schedule time 3740 with the service provider. From the schedule time 3740 page, the service requestor may select an available date, time, set reminders, configure notification settings related to one or more service items, and continue to view related services 3750. From the related services 3750 page, a service requestor may browse service items based on groupings. Services items may be grouped by category, topic, tags, availability, newly added, most reviewed, most rated, editor's choice, recently searched, and others (for example, an AI software can determine what services pairs good with the previously procured service item). When browsing the related services 3750 page, a service requestor may view a service item 3720 and continue to payment processing 3730, scheduling time 3740.

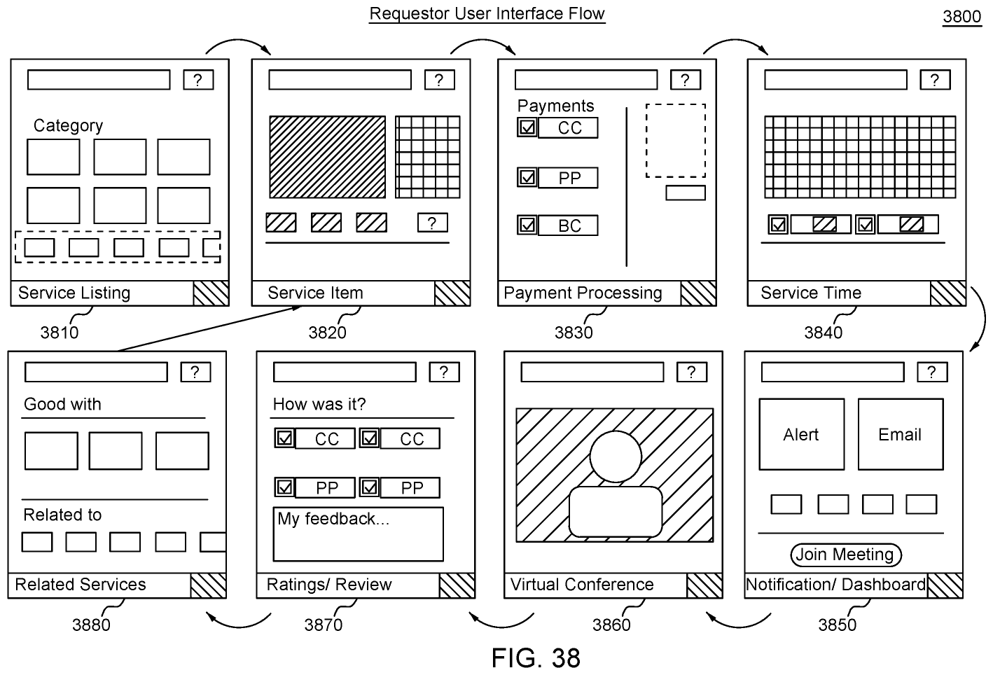

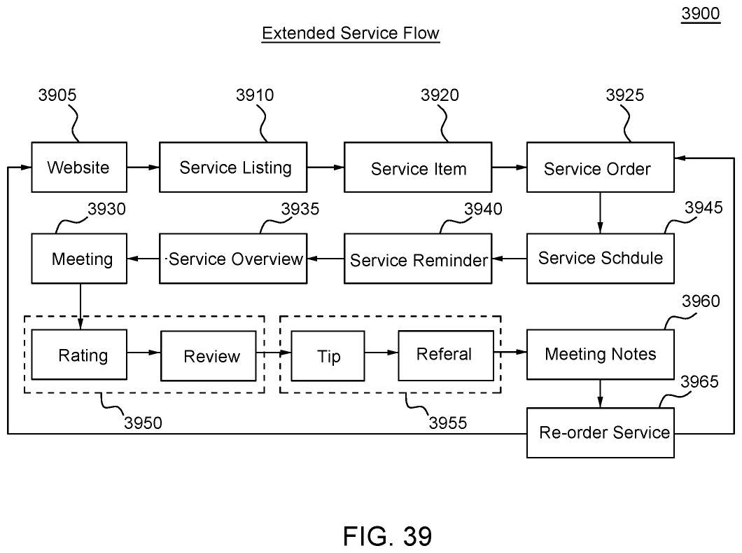

FIG. 38 is a block diagram that illustrates a requestor user interface flow 3800. In FIG. 37 an example of a pre-conference requestor flow is illustrated. In FIG. 38 a flow that includes a notification dashboard 3850, virtual conferencing 3860 page and a ratings/reviews 3870 page is illustrated. Similar to FIG. 37, a service requestor begins the flow by browsing a service listing 3810 page, selecting a service item 3820, continuing to payment processing 3830 and schedule time 3840 with the service provider that is related to the service item 3820. After scheduling time 3840, a service requestor may view notifications, alerts and service items from a notification dashboard 3850. The service requestor may navigate to a conference page (for example, by clicking a button, speaking a command, and others) page, attend the conference 3860 (for example, from one or more devices, applications, locations, etc.), invite others to join the conference 3860 (for example, both users who are in the marketplace and those who are not can receive an invitation to join an existing conference 3860 for free, at a discount, at a premium or at the default service item price), or exist the meeting at any time.

After the conference 3860 has ended or after a service requestor or service provider ends the conference session, a service requestor may provide optional ratings, reviews, tips, recommendations, referrals and feedback about their experience on to one or more service providers on the ratings/review page 3870. Ratings/review page includes a ratings module (for example, a user can select 1 to 5 stars per topic) that may include one or more topics (for example, ratings based on satisfaction, professionalism, experience, intelligence and others), a review module (for example, a set of questions) that may include one or more questions (for example, what have you learned? How was your experience? etc.), a tips module (for example, a box with a preset tip amount by percentage) with one or more tipping options, a recommendations module (for example, a collection of users to recommend the service item to within the professional services marketplace), a referral module (for example, a collection of users from outside of the marketplace to send the service item page to) and other modules. The service requestor may not interact with the ratings/review 3870 page and navigate to the related services 3880 page or any other page on the marketplace.

FIG. 39 is a block diagram that illustrates an extended service flow 3900. A service requestor may navigate to the marketplace website 3905, view a service listing 3910, select a service item 3920, procure a service order 3925, configure a service schedule 3945 and service reminder 3930, review a service schedule 3945 from a service overview 3935 page and join a conference meeting 3940 at the appropriate date and time. During or after a conference meeting 3940, the service requestor is enabled to provide a rating or review 3950, tip and referral 3955, and view meeting notes 3960.

A typical meeting note 3960 may include details about the service item(s) 3920, details about the service provider(s), a summary of the conference meeting 3940 (for example, total meeting time, total transcriptions, total comments, total documents, total interactions), meeting collections (for example, meeting transcriptions, comments, documents, recordings, etc.), meeting analytics (for example, meeting participant(s) location, device type, browser type, operating system, time in meeting, bounce rate, video enabled, audio enabled, and other metrics) and others. After viewing meeting notes 3960, a service requestor is enabled to re-order services 3965 from the same service provider and continue to the service order 3925 page or browse other pages. The service requestor is also enabled to browse the home page 3905 after reviewing meeting notes 3960.

According to one example, the requestor user interface flow 3800 (illustrated in FIG. 38) may perform the operations of FIG. 39. With reference to FIG. 39, an extended service flow 3900 includes optional ratings, reviews, tips and referrals that is provided by a service requestor and is received by one or more service providers. With reference to FIG. 39, the service provider receives a rating, review, tip, referral or recommendation by ending the conference session (for example, manually ending the meeting or allowing a timer to end the meeting).

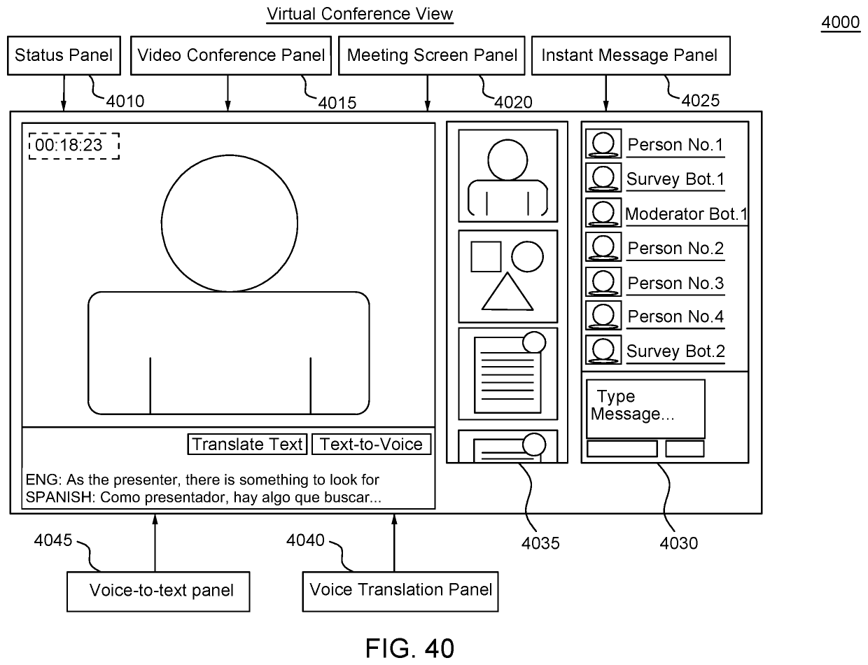

FIG. 40 is a block diagram that illustrates a conference view 4000. Meeting attendees may be enabled to utilize a conference application that supports components, modules and features that enhance the user experience. A conference view may include a status panel 4010 indicating an change in the meeting time, a conference panel 4015 that include a viewer (for example, a visual display of the service provider or other viewable screens), a meeting screen panel 4020 displaying the meeting participants, documents 4035, meeting agents (for example, AI bots, moderator bots, advertisement bots, and others), advertisements and other digital content, an instant message panel 4025 displaying a list of messages from meeting participants and a messaging box 3905.

A conference view may include a voice-to-text panel 4045 which enables a conference attendee to transcribe voice into text, translate text from one language to another, and others. A conference view may include a voice translation panel 4040 allowing text to be converted into audio (for example, an AI reads the text and speaks to a meeting attendee in the preferred language). The conference view may include other components, modules or features that are not illustrated in FIG. 40 (for example, third-party apps may be used within the conference view).

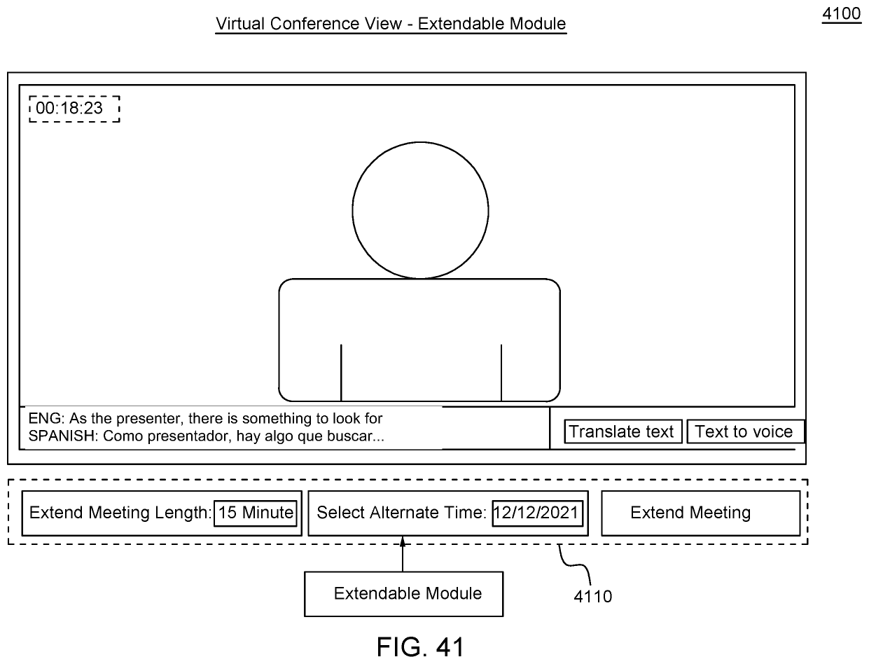

FIG. 41 is a block diagram that illustrates a conference view extendable module 4100. A conference may be extended past the procured and scheduled time through the use of an extending module 3910 that includes a meeting length, alternate time, and a call-to-action button for completing the request. Selecting an alternate time displays a list of times that are available per the service providers availability. Upon submitting the request, the service requestor is presented with a payment module to complete payment or automatically procures the service item with a preferred or default payment method.

According to one example, the conference view extended module 4100 (illustrated in FIG. 41) performs the operations of FIG. 40. With reference to FIG. 41, the service provider receives a request to extend 3910 the meeting time and meeting length (for example, a notification appears on the conference view, etc.). A service provider is enabled to accept, reject or counter (for example, provide a different meeting length, alternate time or price) the request.

FIGS. 37-38 illustrate examples of user interfaces that enable users to navigate various pages within the requestor user flow and attend a conference therein, according to some example examples, as explained in FIGS. 1-4, 7, 9, 10, 12-13, 15-16, 20-21, 28-29, 30, 33-34 and 39. FIGS. 40-41 illustrate examples of user interfaces that are displayed to a meeting attendee to enable the meeting attendee to attend a conference or audio-only meeting, according to some example examples.

FIGS. 1-7 are examples of schematic representations illustrating high-level architectures of the system and method for a marketplace including one or more user, application, module, device and network flow is presented.

FIG. 5 is a block diagram that illustrates one or more computing device. In one example, the computing device may correspond to device application 550, mobile application 540 or desktop application 560 that is capable of telephony, messaging, and data services. Examples of such applications include smartphones or mobile 510 phones, tablets or pad 520 devices for cellular carriers or laptop or personal computer 530. Computing devices that run applications can include one or more processors, a display device (for example, such as a touch-sensitive display device), memory resources, one or more communication sub-systems (including wireless communication sub-systems) (for example, BLUETOOTH®, Wi-Fi®, Infrared®, etc.), input mechanisms (for example, an input mechanism can include or be part of a touch-sensitive display device (for example, touchscreen, touchpad)), and one or more location detection mechanisms (for example, GPS component, motion sensors). In one example found in FIG. 15, at least one of the communication sub-system sends and receives cellular data over data channels and voice channels through an internet enabled network 1565 (for example, a wireless internet network such as a Wide Area Network, Municipal Area Network, Satellite Network, etc.), whereas the cellular data is sent and received by digital networks 1560 (for example, a cloud network, peer-to-peer network, blockchain network, neural-cohort network, etc.) that communicate to applications 1575 running on one or more devices. In another example found in FIG. 17, a cloud network 1710 and a peer-to-peer network 133 sends and receives data from and to one or more cloud applications 1730, mobile applications 131, IoT application 132, or desktop application 130.

The marketplace pages, components, modules and applications are configured, generated, transformed, encrypted, transported, displayed, and stored with software and/or other logic that perform one or more processes, steps, and other functions described with implementations of both cloud and distributed networks that contain nodes or machines, devices, applications, software and systems, such as described by FIGS. 24, 27, 28, 35, 36, and some examples. The marketplace pages, components, modules and applications are configured with instructions to connect (for example, a secure connection between client machine and server machine) data stored in memory resources on one or more computing devices 3615-3645 with network devices (for example, a cloud centralized network 3665 of nodes 2870 in a datacenter) to operate an online marketplace 3605 as described in FIGS. 28 and 36. For example, instructions for operating the marketplace website in order to display various user interfaces, such as described in FIGS. 37 and 38, can be stored in the memory resources of one or more computing devices 3615-3645. In one implementation, a user may operate the professional services marketplace mobile application 131 that displays a different user interface than a desktop application 130 as described in FIG. 17.

The data received on a computing device such as a mobile application 131 may cause user interface features to be presented on the display of the mobile application 131 by executing instructions that can are sent from a cloud network 1710 and/or cloud applications 1730 that are stored in the memory resources such as databases 1715 as described in FIG. 17. In some examples, applications such as an IoT application 132 described with respect to FIG. 17 or interface application 3240 described with respect to FIG. 32, may be provided by the processor found on an IoT device 3220 that is based on user input and/or selections received from the user. In some implementations, the user may interact with the touch-sensitive display on a personal computer 3205, mobile device 3210, and others to make selections on the different user interface features such as a browser video conference 3245 so that meeting-specific information (that is based on the service item in this case) can be provided with the user interface features prior, during and after a virtual conference session as described in FIG. 32. While FIG. 32 is illustrated mainly for mobile computing devices, one or more examples may be implemented on, but is not limited to, other types of devices, including fully-functional computers (such as laptop computers, desktop computers (for example, PCs)), server computers, client computers, tablet computers, netbooks, PDAs, wearable devices (for example, smart watches), smart home devices (for example, smart appliances), brain machine interfaces (for example, EEG headset, surgically embedded devices, and others) device, other smart devices, and so forth.

It is contemplated for examples described herein to extend the individual elements and concepts described herein, independently of other concepts, ideas, or systems, as well as for examples to include combinations of elements recited anywhere in this application. Although examples are described in detail herein with reference to the accompanying drawings, it is to be understood that the invention is not limited to those precise examples. As such, many modifications and variations will be apparent to practitioners skilled in the art. Accordingly, it is intended that the scope of the invention be defined by the following claims and their equivalents. Furthermore, it is contemplated that a particular feature described either individually or as part of an example can be combined with other individually described features, or parts of other examples, even if the other features and examples make no mention of the particular feature. Thus, the absence of describing combinations should not preclude the inventor from claiming rights to such combinations.

While preferred examples have been shown and described, modifications thereof can be made by one skilled in the art without departing from the scope or teaching herein. The examples described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied. Accordingly, it is intended that the following claims be interpreted to embrace all such variations and modifications.

While various exemplary examples of the disclosed system and method have been described above, it should be understood that they have been presented for purposes of example only, not limitations. It is not exhaustive and does not limit the disclosure to the precise form disclosed. Modifications and variations are possible in light of the above examples or may be acquired from practicing of the disclosure, without departing from the breadth or scope as a person skilled in the art will recognize. cm What is claimed is:

1. A system for providing a professional services marketplace, the system comprising:
at least one service catalog, the at least one service catalog configured to enable actions related to the professional services for a plurality of user interfaces configured to perform actions on services;
a payment processor configured to facilitate financial transactions associated with the professional services;
an event scheduler to facilitate the scheduling of a virtual meeting associated with the professional services; and
a virtual meeting software to enable virtual meetings for the plurality of user interfaces configured to facilitate virtual meetings associated with the professional services.

2. The system of claim 1, the system configured to provide real-time on-demand service delivery.

3. The system of claim 1 wherein the system is configured on a hybrid centralized, distributed and peer-to-peer network architecture.

4. The system of claim 3 wherein the hybrid centralized, distributed and peer-to-peer network architecture facilitates services.

5. The system of claim 1 wherein the system is configured on a multi-tenant event-oriented service model.

6. The system of claim 1 wherein the system is configured on a social network oriented electronic commerce platform.

7. The system of claim 6 wherein the social network oriented electronic commerce platform provides components that enable member profiling, listing, searching, messaging, payment processing, scheduling, virtual meeting, rating and reviewing technologies for a plurality of professional service providers and knowledge experts to engage their services in real-time.

8. The system of claim 1 wherein the system is configured on a flexible procurement and payment service model.

9. The system of claim 8 wherein the flexible procurement and payment service model comprises a service model paradigm where service requestors pay for services in advance of the service being performed.

10. The system of claim 8 wherein the flexible procurement and payment service model comprises components where payments to a service provider is contingent on fulfillment of a service to a service requestor.

11. The system of claim 8 wherein the flexible procurement and payment service model comprises components to facilitate financial transactions between service provider and service requestor through the use of a payment system.

12. The system of claim 8 wherein the flexible procurement and payment service model comprises components enabling a hybrid transactional model where services may be purchased directly or through a bidding system.

13. The system of claim 8 wherein the flexible procurement and payment service model comprises the use of a bidding system that supports multi-faceted bidding options where a service requestor is enabled to bid or negotiate price and service availability directly with a service provider if a service provider determines that the service may be available for bids.

14. The system of claim 8 wherein the flexible procurement and payment service model comprises components for bidding that is not based on a frequency or duration of time remaining since services are bound to service availability.

15. The system of claim 8 wherein the flexible procurement and payment service model comprises components that bind financial transactions to service deliverability between a service provider and a service requestor.

16. The system of claim 1 further comprising at least one or more processors, to provide a professional services marketplace operating at least one of the at least one service catalog, the payment processor, the event scheduler, the virtual meeting software.

17. The system of claim 1 wherein the plurality of user interfaces comprise one or more service providers, one or more service requestors and one or more service items.

18. The system of claim 1 wherein the financial transactions comprises modules and components including a plurality of payment methods that include at least details related to, billing, service, transaction, service provider and service requestor.

19. The system of claim 1 wherein the scheduling of a virtual meeting comprises a meeting date or meeting time is configured on a computer-readable medium, the virtual meeting being associated with at least one service item.

20. The system of claim 1 wherein the plurality of user interfaces comprise a virtual meeting software or application, one or more meeting hosts, one or more meeting attendees and wherein a meeting host or attendee are human or non-human entities.
